(19) United States
(12) Patent Application Publication
(10) Pub. No.: US 2009/0122768 A1
(43) Pub. Date: May 14, 2009

(54) Communication Device, Communication Method, Communication Program, and Storage Medium Thereof

(76) Inventors: Ken Nakashima, Nara (JP); Seiji Imanishi, Nara (JP)

Correspondence Address: BIRCH STEWART KOLASCH & BIRCH, PO BOX 747, FALLS CHURCH, VA, 22040-0747, US

(21) Appl. No.: 11/988,310

(22) PCT Filed: Jun. 28, 2006
(86) PCT No.: PCT/JP2006/312877

§ 371 Date: Jan. 4, 2008

(30) Foreign Application Priority Data
Jul. 8, 2005 (JP) 2005-200773

(51) Int. Cl. H04W 84/02

(52) U.S. Cl. 370/338

(57) ABSTRACT

In the present invention, when a CP is extended longer than that of a preset schedule, a CP having been set in a subsequent schedule cycle in the preset schedule is omitted until the delay is recovered, that is, until the preset schedule and an actual schedule are synchronized with each other. In case where the CP indicative of a period for executing a communication method in which a QAP does not manage spectrum allocation is extended longer than a period the QAP has set in the preset schedule, subsequent spectrum allocation in a QAP delays from the schedule, so that a power save efficiency of a QSTA drops. The foregoing technique suppresses the drop of the power save efficiency.

### TECHNICAL FIELD

The present invention relates to (i) a communication device used as an access point for managing spectrums of a network and (ii) a method for carrying out a communication between the access point and stations.

### BACKGROUND ART

Generally, in a network utilizing a communication path in a time-sharing manner as in a radio communication, communications can be carried out at the same time only between a single transmitting station and a single receiving station or a plurality of receiving stations, and the stations alternately carry out communications. Thus, in case where a network is made up of a plurality of stations, stations other than the transmitting station and the receiving stations currently carrying out communications can supply power only to bare essential parts so as to shift into a power save mode in which power consumption of the entire station is suppressed.

For example, Patent Document 1 (Japanese Unexamined Patent Publication Tokukai 2001-223634 (Publication date: Aug. 17, 2001)) discloses a technique in which: a station (radio terminal station) transmits a sleep request and a sleep request frame number to an access point (radio base station) and the station shifts into a sleep mode (power save mode) in accordance with an allowance signal sent back from the access point and including an allowance sleep frame number and synchronization frame number.

That is, in Patent Document 1, the access point informs the station of a transmission cycle of broadcast frames to be transmitted at the same timing, and the station shifts into a sleep mode during a period in which no broadcast frame is transmitted, and the station is released from the sleep mode at a timing when the broadcast frame is transmitted.

Further, according to Patent Document 1, when the access point changes the broadcast frame cycle, the access point transmits only the changed broadcast frame cycle, and each station calculates a changed sleep frame number in accordance with the sleep request frame number and the broadcast frame cycle so as to update the sleep frame number.

Further, Patent Document 2 (Japanese Unexamined Patent Publication Tokukai 2005-39632 (Publication date: Feb. 10, 2005)) discloses a technique in which: an access point (master) periodically transmits a beacon signal including identification information of a station (slave) and a communication time slot allocated to the slave, and the access point transmits, to the slave having requested for connection, a response signal including the identification information of the slave and information indicative of a time taken to transmit the beacon signal, and the slave having received the response signal lowers its power consumption level until the beacon signal is transmitted.

However, according to Patent Document 1 and Patent Document 2, each of all the stations has to receive a signal including spectrum allocation information transmitted from the access point (e.g., the broadcast frame or the beacon signal). That is, each station has to be released from the power save mode at every cycle, at which a signal including the spectrum allocation information is transmitted, so as to receive the transmitted signal.

While, with respect to IEEE 802.11 standard (ANSI/IEEE Std. 802.11, 1999 Edition) widely known as a standard of a MAC (Medium Access Control) layer in LAN (Local Area Network), formulation of IEEE 802.11e standard is currently promoted as an additional specification for realizing QoS (Quality of Service). Non Patent Document 1 (IEEE P802.11e/D13.0. January 2005) is a draft standard published by IEEE 802.11 Commission. In this draft, a method referred to as S-APSD (Scheduled automatic power-save delivery) is defined as a method for managing the power save mode.

In the S-APSD, a schedule for allocating a spectrum to each station is set and is informed to the station. Thus, each station has only to manage the power save mode in accordance with the schedule, so that, unlike Patent Document 1 and Patent Document 2, all the stations do not have to be released from the power save mode at every cycle at which there is transmitted the signal including the spectrum allocation information simultaneously transmitted to all the stations. Thus, according to the S-APSD, each station can more efficiently save its power.

Herein, an example of a network carrying out communications in accordance with a definition of the aforementioned draft is explained as follows.

### (Arrangement of the Network)

In IEEE 802.11e standard, a single QAP (access point) and a plurality of non-AP QSTAs (stations: hereinafter, referred to as “QSTA”) constitute a single network. FIG. 15 is an explanatory drawing illustrating an example of a network to which IEEE 802.11e standard is applied. In this example, a single QAP (access point) 801 and two QSTAs (stations) 802 and 803 constitute a network. Note that, there are two QSTAs in this figure, but the number of QSTAs is not limited to two and more QSTAs can exist.

FIG. 16 is a block diagram illustrating a schematic arrangement of the QAP 801 and the QSTAs 802 and 803. As illustrated in FIG. 16, the QAP 801 includes an application 911, a protocol control section 912, and a radio section 914.

The application 911 is means for executing an application program stored in storage means (not shown). The protocol control section 912 controls communication protocol in a network and includes a spectrum management section 913. The spectrum management section 913 determines a schedule for allocating a spectrum to each QSTA. The radio section 914 is means for carrying out communications with each QSTA and converts a received electric wave signal into a frame which can be comprehensible for the protocol control section 912 so as to output the frame to the protocol control section 912, and converts a frame transmitted from the protocol control section 912 into an electric wave signal so as to transmit the electric wave signal to the QSTA via a radio medium.

Each of the QSTAs 802 and 803 includes an application 921, a protocol control section 922, a power save management section 923, and a radio section 924. Functions of the application 921 and the radio section 924 are substantially the same as functions of the application 911 and the radio section 914 respectively. The protocol control section 922 controls operations of the QSTA 802 or 803 in accordance with a frame and the like received via the radio section 924. Further, the protocol control section 922 includes the power save management section 923. The power save management section 923 controls switching between the power save mode and an awake mode in each of the QSTAa 802 and 803.

### (Frame Sequence of S-APSD)

Next, the following describes (i) transmission of data from the QAP 801 to the QSTA 802 or 803 (down link transmission), (ii) transmission of data from the QSTA to the QAP (up link), and (iii) transmission of data from the QSTA to the QSTA (direct link), in using the S-APSD in the network.

FIG. 17 is an explanatory drawing illustrating an example of a frame sequence communicated in the network. Note that, either the QSTA 802 or the QSTA 803 of FIG. 15 corresponds to a QSTA of FIG. 17.

### (As to TXOP)

Upon determining to start transmission of data, the application 921 of the QSTA instructs the protocol control section 922 to start transmission of data. At this time, the application 921 informs the protocol control section 922 of TSPEC concerning the data transmission. The TSPEC is an information group indicative of specifications of a data group to be transmitted and includes information or the like which is indicative of how many times the data is to be transmitted and how long the data is. A series of the data group defined by the TSPEC is referred to as a stream. For example, a file and the like of a single moving image or sound correspond to the stream. The TSPEC includes information indicative of whether or not to use the S-APSD or not in transmitting the stream.

In response to the TSPEC, the power save management section 923 in the protocol control section 922 finds it necessary to use the S-APSD in transmitting data. Further, in response to the instruction to start transmission of data, the protocol control section 922 generates an ADDTS request frame 1001 and transmits the ADDTS request frame 1001 to the radio section 924. The radio section 924 converts the frame into an electric wave signal and transmits the electric wave signal to the QAP 801 via the radio medium. Note that, the frame includes the TSPEC. As a result, the QSTA can inform the QAP 801 that the S-APSD is required to be used.

In response to the electric wave signal, the radio section 914 of the QAP 801 converts the electric wave signal into a frame which is comprehensible for the protocol control section 912 and transmits the frame to the protocol control section 912. The spectrum management section 913 in the protocol control section 912 determines a schedule for allocating a spectrum to each QSTA in accordance with the TSPEC. Further, the protocol control section 912 generates an ADDTS response frame 1002 as a response to the ADDTS request frame 1001 and transmits the ADDTS response 1002 to the radio section 914. The frame includes (i) information indicating that the TSPEC is accepted by the spectrum management section 913 and the spectrum allocation with respect to the stream is acknowledged and (ii) values respectively referred to as an SST (Service Start Time) and an SI (Service Interval) as parameters for the S-APSD. The radio section 914 converts the frame into an electric wave signal and transmits the electric wave signal to the radio medium.

The SST indicates a start time of the SP, and the SI indicates a recurrence interval of the SP. The SP is a period in which one or more frames are transmitted from the QAP 801 to a QSTA and one or more polled TXOPs are given to the QSTA.

Thereafter, at a timing corresponding to the SST in which a frame is transmitted to the QSTA, the protocol control section 912 of the QAP 801 transmits the frame to the QSTA. That is, in case where there are data frames which should be transmitted to the QSTA, the data frames (data frames 1003 and 1004 in FIG. 17) are transmitted. Further, the protocol control section 912 transmits a QoS CF-Poll frame 1005 to the QSTA.

The QoS CF-Poll frame is a frame for informing that a transmission right is given to a QSTA to which the frame is addressed. A period in which a transmission right is given to a certain QSTA by the QoS CF-Poll frame is referred to as a polled TXOP (transmission opportunity). The QoS CF-Poll frame includes a value referred to as a TXOP limit field, and the value is indicative of a length of the polled TXOP period given to the QSTA. A transmission timing of the QoS CF-Poll frame and a size of the TXOP limit can be freely changed by the QAP 801, and the QAP 801 can adjust a spectrum allocated to each QSTA by changing the transmission timing and the size of the TXOP limit.

In response to the QoS CF-Poll frame, the QSTA transmits data frames (data frames 1006 and 1007 in FIG. 17) during the polled TXOP period.

Note that, in case where a non-AP QSTA finishes transmitting the stream and it is not necessary to give the transmission right, a DELTS request frame is transmitted from the non-AP QSTA on the basis of the same procedure as in the ADDTS request frame, and a DELTS response frame is transmitted as a response thereto (these frames are not shown).

Thereafter, in accordance with the spectrum allocation schedule determined in the foregoing manner, the spectrum management section 913 of the QAP 801 periodically transmits the data frames and the QoS CF-Poll frame. That is, when the time shifts from the SST to the SI, data frames 1008, 1009, and a QoS CF-Poll frame 1010 are transmitted to the QSTA, and subsequently the data frames and the QoS Poll frame are transmitted at a cycle of the SI.

### (As SP (Service Period))

When the protocol control section 922 of the QSTA receives the ADDTS response frame 1002, the power save management section 923 determines its power save schedule in accordance with the SST and the SI that are included in the ADDTS response frame 1002.

The QAP 801 starts down link data transmission at the SST, so that the QSTA may be in a power save mode until a time indicated by the SST comes. In IEEE 802.11, there is provided a timer referred to as “TST timer” which is in synchronization with all the QSTAs and the QAP each of which belongs to the network, so that the QSTAs and the QAP can be synchronized with each other in the SST. The TSF timer is managed by the protocol management sections 912 and 922, and the spectrum management section 913 and the power save management section 923 can refer to the TFS timer.

The power save management section 923 of the QSTA controls the entire QSTA so that the QSTA shifts into a power save mode in response to the ADDTS response frame 1002. The power save mode is a mode in which power is supplied to bare essential parts so as to reduce entire power consumption of the QSTA. Depending on how to package the QSTA, a part to which power is supplied varies, but for example it may be so arranged that power is supplied only to the power save management section 923.

The power save management section 923 of the QSTA monitors the TSF timer and controls the entire QSTA so that the QSTA shifts from the power save mode into the awake mode when a time indicated as the SST comes. The awake mode is a mode in which power is supplied to all parts (or at least parts which allows reception and transmission) of the QSTA and hence reception and transmission of a frame or the like are allowed. Note that, depending on how to package the QSTA, a certain time period may be required in shifting from the power save mode into the awake mode. In such case, the power save management section 923 has to start shifting into the awake mode earlier in consideration for this time lag.

Further, the QSTA is in the power save mode during a period from reception of the ADDTS response frame 1002 to the SST, but it may be so arranged that the QSTA does not shift into the power save mode and prepares for reception and transmission of a frame during this period for example.

While, the protocol control section 912 of the QAP 801 starts transmission of a frame at the time when a time corresponding to the SST indicated by the TSF timer comes. Note that, it is assumed that the application 911 beforehand requests the protocol control section 912 to transmit data from the QAP 801 to the QSTA. In this assumption, not transmission of the stream data but transmission of sporadic data used in controlling a network or used for a similar purpose is requested.

Each of the data frames and the QoS CF-Poll frame includes an EOSP (end of service period) field, and the field includes information indicative of whether or not the QAP brings the SP to an end with transmission of the frame. In case where EOSP=1, this indicates the end of the SP, and the protocol control section 922 having received this frame determines that the QAP 801 does not transmit a frame any more. Further, in case where EOSP=0, this indicates continuation of the SP, and the protocol control section 922 having received this frame determines that the QAP 801 continues to transmit a frame.

In the example illustrated in FIG. 17, the protocol control section 912 of the QAP 801 transmits data, whose transmission is requested by the application 911, as data frames 1003 and 1004 whose EOSP is 0, to the QSTA.

When transmission of the data is completed as requested by the application 911, the protocol control section 912 transmits a QoS CF-Poll frame 1005 whose EOSP is 1 to the QSTA.

At this time, the QSTA is in an awake mode, so that it is possible to receive the QoS CF-Poll frame 1005. As described above, the QoS CF-Poll frame includes the TXOP limit, so that the protocol control section 922 of the QSTA can find a period in which a transmission right is given thereto. Herein, data whose transmission has been requested as stream data is transmitted as data frames 1006 and 1007 from the application 921 beforehand. The transmission of the stream data may be carried out as up link transmission to the QAP 801 or may be carried out as direct transmission to another QSTA. Further, in FIG. 17, the two data frames 1006 and 1007 are transmitted, but any number of data frames having any length can be sequentially transmitted in accordance with the length of the TXOP limit (as long as the length and the number respectively do not exceed an upper limit length and upper limit number which are defined in the protocol). When a time period indicated by the TXOP limit passes, the protocol control section 922 finishes transmission of the data. Further, the power save management section 923 detects completion of the transmission and controls the QSTA so as to shift into the power save mode.

Thereafter, the power save management section 923 of the QSTA continues to monitor the TSF timer, and controls the QSTA so as to shift into the awake mode again when the time shifts from the SST to the SI.

While, also the protocol control section 912 of the QAP 801 monitors the TFS timer likewise and starts transmission of the data frame again when the time shifts from the SST informed to the QSTA by the ADDTS response frame 1002 into the SI. Herein, as in the foregoing operation, data whose transmission has been requested by the application 911 beforehand is transmitted as data frames 1008 and 1009 whose EOSP is 0, and then a QoS CF-Poll frame 1010 whose EOSP is 1 is transmitted.

At this time, the QSTA is in the awake mode, so that it is possible to receive the data frames 1008 and 1009 and the QoS CF-Poll frame 1005. Further, the protocol control section 922 of the QSTA transmits data, whose transmission has been requested as stream data by the application 921 beforehand, as data frames 1011 and 1012, within the time period indicated by the TXOP limit included in the QoS CF-Poll frame 1010.

Thereafter, although not shown, the same procedure is repeated at every SI interval. Note that, as to a process in finishing the data transmission, its explanation is omitted.

### (As to CP (Contention Period))

The CP (Contention Period) is a period in which the QAP 801 does not manage the transmission right. During the period, an access format referred to as DCF (distributed coordination function) is adopted so that the protocol control section 922 of the QSTA determines each of timings at which frames are transmitted. In the DCF format, the protocol control section 922 of the QSTA monitors whether or not a frame is transmitted to the radio medium via the radio section 906. Further, in case where it is detected that any frame has not been transmitted from any station for a predetermined period (period referred to as “DIFS”), timekeeping of a down timer referred to as a backoff timer is started. The backoff timer is a down timer whose timekeeping is started from a random value within a predetermined range in each QSTA. If the radio medium is idle (any frame has not been transmitted from any station) at the time when the backoff timer indicates 0, the QSTA can start data transmission. That is, a station whose waiting time having been randomly determined is short can obtain the data transmission right.

The QSTA having obtained the data transmission right can transmit a single frame. When the data transmission is finished, the QSTA returns to a phase for monitoring whether or not the frame is transmitted to the radio medium, and the same operation is repeated.

Further, in IEEE 802.11e, an access format referred to as EDCAF (enhanced distributed channel access function), an advanced version of the DCF format, is adopted. This format is configured by adding (i) a structure for adjusting priority of transmission depending on a type of data to be transmitted by changing a size of the backoff timer depending on a type of data to be transmitted and (ii) a structure for allowing the QSTA having obtained the data transmission right to sequentially transmit a plurality of frames. It does not matter whether the DCF or EDCAF is adopted.

### (Necessity of CP)

As described above, the QoS CF-Poll frame is periodically transmitted, and the spectrum allocation based on the QoS CF-Poll frame is carried out basically so as to divide relatively long (or endless) data as in streaming transmission (reproduction while receiving data) of a moving image or sound etc. and so as to periodically transmit the divided data. While, as to a command for network management or a command (command or the like to fast forward a moving image) issued from the application 921 or a similar command, such a command is not periodically transmitted but is sporadically transmitted in response to a request. Thus, this is not suitable for the spectrum allocation based on the QoS CF-Poll frame. In order to transmit such sporadic data, the CP is used.

Note that, an extent to which the CP is prepared is determined by the spectrum management section 913 of the QAP 801 in view of a spectrum allocation request from each QSTA. For example, it is possible to carry out the following adjustment. In case where an amount of data sporadically transmitted is small, the CP is decreased and the polled TXOP is increased. Adversely, in case where the amount of data sporadically transmitted is large, the CP is increased and the TXOP is decreased.

However, if only polled TXOPs are sequentially provided without providing any CP, it is impossible to transmit a network management command or the like. For example, also a command in allowing the QSTA to newly participate in the network is transmitted in the CP, so that the QSTA cannot participate in the network in case where any CP is not provided. Thus, it is necessary to provide CPs at certain intervals.

### (Schedule Cycle and Power Save)

In a conventional and general packaging method, the spectrum management section 913 of the QAP 801 determines a schedule cycle serving as a unit for spectrum allocation (hereinafter, referred to merely as “schedule cycle”), and further determines a ratio at which the polled TXOPs should be given to each QSTA in the cycle, and repeats the schedule cycle (unit period). In the long view, a ratio of a spectrum given to each QSTA is determined. Further, at the time when the QAP 801 transmits the QoS CF-Poll frame to the QSTA so as to give the polled TXOP, the QSTA has to be in an awake mode.

The relation thereof is described as follows with reference to FIG. 18. Note that, the following description gives an example where the QAP 801 (hereinafter, referred to merely as “QAP” for simplification) gives transmission rights to three QSTAs (QSTA1, QSTA2, and QSTA3). Further, in FIG. 18, it is assumed that sequence of the ADDTS request and the ADDTS response has been completed. That is, the QPA has been notified of information such as a transmission rate of transmission data of each QSTA by the ADDTS request frame, and a schedule has been determined in accordance with the information. Herein, a data transmission rate is highest in the QSTA1 and a data transmission rate is lowest in the QSTA3. Further, the ADDTS request frames are transmitted from the QSTA1, QSTA2, and QSTA3 in this order.

Further, in FIG. 18, each of squares above a temporal axis of each of the QAP and the QSTA indicates a period in which a frame is transmitted from the QAP or the QSTA, and each of squares above a temporal axis of the QAP indicates a period in which a frame is transmitted from the QAP. A square P1 indicates a period in which a QoS CF-Poll frame is transmitted from the QAP to the QSTA1. A square P2 indicates a period in which a QoS CF-Poll frame is transmitted from the QAP to the QSTA2. A square P3 indicates a period in which a QoS CF-Poll frame is transmitted from the QAP to the QSTA3. Further, each of squares named “data” indicates that one or more data frames are transmitted from the QSTA as up link or direct link. Further, each of shaded squares below temporal axes of the QSTA1 to the QSTA3 indicates a period in which a corresponding QSTA is in an awake mode.

The top raw named “Schedule” indicates a schedule for giving a transmission right which schedule has been set by the QAP, and each of squares respectively named QSTA1, QSTA2, and QSTA3 indicates a period in which a transmission right is given to a corresponding QSTA. That is, this period includes a period for transmitting the QoS CF-Poll frame to the QSTA and the polled TXOP given to the QSTA. Actually, the period for transmitting the QoS CF-Poll frame is much shorter than the length of the polled TXOP, so that the period in which the transmission right is given is substantially the same as the polled TXOP. For convenience in illustration of FIG. 18, the period for transmitting the QoS CF-Poll frame is relatively long. A square named “CP” indicates a period prepared for the contention period.

First, in response to the ADDTS request frame, the QAP determines the schedule cycle. This schedule cycle may have any value. Next, in accordance with information of the received ADDTS request frame, the QAP determines a spectrum allocation schedule indicative of how many times the polled TXOP is to be given and how long the polled TXOP should be. The example illustrated in FIG. 8 illustrates a case where it is determined that: a polled TXOP corresponding to about 30% of a schedule cycle should be given to the QSTA1 at each schedule cycle, a polled TXOP corresponding to about 30% of a schedule cycle should be given to the QSTA2 at every two schedule cycles, and a polled TXOP corresponding to about 30% of a schedule cycle should be given to the QSTA3 at every three schedule cycles.

Further, in accordance with the spectrum allocation schedule, the QAP determines an SST and an SI. Note that, in giving the polled TXOP, the QSTA has to receive the QoS CF-Poll. Thus, when the polled TXOP is given, i.e., when receiving the QoS CF-Poll, each QSTA has to be in an awake mode. With respect to the QSTA1, the polled TXOP is given at each schedule cycle, so that the SI is made as long as the schedule cycle (SI1). Further, at this time, any ADDTS request is not received from other station, and another polled TXOP has not been scheduled to be given, so that the polled TXOP for the QSTA1 is positioned at the beginning point of the schedule cycle, and the SST is a time corresponding to the beginning point of the schedule cycle (SST1).

With respect to the QSTA2, the polled TXOP is given at every two schedule cycles, so that the SI is made twice as long as the schedule cycle (S12). Further, the polled TXOP for the QSTA1 has been scheduled to be given, so that the polled TXOP for the QSTA2 is scheduled to be given after the polled TXOP for the QSTA1. Thus, the SST of the QSTA2 begins at a time calculated by adding, to the beginning time of the schedule cycle, a period for transmitting the QoS CF-Poll frame to the QSTA1 and the length of the polled TXOP (SST2).

With respect to the QSTA3, the polled TXOP is given at every three schedule cycle, so that the SI is made three times as long as the schedule cycle (SI3). Further, the polled TXOP for the QSTA1 and the polled TXOP for the QSTA2 have been scheduled to be given, so that the polled TXOP for the QSTA3 is scheduled to be given after the polled TXOP for the QSTA2. Thus, the SST of the QSTA3 begins at a time calculated by adding the period for transmitting the QoS CF-Poll frame to the QSTA1, the length of the polled TXOP, the period for transmitting the QoS CF-Poll frame to the QSTA2, and the length of the polled TXOP, to the beginning time of the schedule cycle (SST3).

The QAP transmits an ADDTS response frame as a response to the ADDTS request and informs the QSTA of the SST and the SI that have been determined above.

Note that, in FIG. 18, lengths of the polled TXOPs for the respective QSTAs in the schedule cycle are the same for convenience in illustration, but they may be different from one another.

### (Entire Operations of the Network in Case of Using S-APSD)

With reference to FIG. 19, the following describes the entire operations of the network in case of using S-APSD. A manner of illustration in FIG. 19 is substantially the same as a manner of illustration in FIG. 18. However, an axis “Another QSTA” indicates a QSTA other than the QSTA1 and the QSTA2. Thus, each of squares above a temporal axis of “Another QSTA” indicates a period in which a frame is transmitted from the QSTA other than the QSTA1 and the QSTA2.

A top raw named “Schedule” indicates a schedule in which the QAP gives a transmission right, and each of squares respectively named “QSTA1” and “QSTA2” in this raw indicates a period in which a transmission right is scheduled to be given to the QSTA. Each of squares named “CP” indicates a period in which the contention period is scheduled to be provided.

FIG. 19 illustrates an example where polled TXOPs each corresponding to about 40% of the spectrum (periods each corresponding to about 40% of the schedule cycle) are respectively given to the QSTA1 and QSTA2 and about 20%, i.e., the rest of schedule cycle is used for the CP. That is, the polled TXOP whose length corresponds to about 40% of the schedule cycle is given to the QSTA1, and then the polled TXOP having the same length is given to the QSTA2. Further, about 20%, i.e., the rest of the schedule cycle is allocated to the CP. Such schedule cycle is repeated in the long view. Note that, it is assumed that the schedule cycle is about 8 ms.

The flow of the frame transmission in FIG. 19 is described as follows. In FIG. 19, it is assumed that sequence of the ADDTS request and the ADDTS response has been completed. By means of the ADDTS response frame, the QAP informs the QSTA1 of an SST1, at which the QoS CF-Poll is to be transmitted to the QSTA1 for the first time, as the SST, and the QAP informs the QSTA1 of an SI, having the same length as the schedule cycle, as the SI. Likewise, the QAP informs the QSTA2 of the SST2 as the SST and of the SI, having the same length as the QSTA1, as the SI.

When the SST1 comes, the QAP transmits a QoS CF-Poll frame 1201 to the QSTA1. In this frame, a TXOP limit based on a predetermined schedule is specified, and the QAP has no schedule for transmitting another frame, so that EOSP=1 is specified. Note that, for simplification of illustration, down link data is not transmitted herein, but it may be so arranged that down link data is transmitted before transmitting the QoS CF-Poll frame 1201.

The QSTA1 has been informed of the SST1 by the ADDTS response beforehand, so that the QSTA1 is in the awake mode at this time. In response to the QoS CF-Poll frame 1201, the QSTA1 transmits a data frame 1202. As described above, one or more data frames are transmitted here. When the TXOP limit having been informed by the QoS CF-Poll frame 1201 passes, the QSTA1 finishes the data transmission. Further, the QoS CF-Poll frame 120 specifies EOSP=1, so that the QTAS1 determines that no more data will be transmitted to the QSTA1, and hence the QSTA1 shifts into the power save mode.

When the specified TXOP limit passes after having transmitted the QoS CF-Poll frame 1201, the QAP transmits a QoS CF-Poll frame 1203 to the QSTA2. This is the same time as the time having been informed to the QSTA2 as the SST2. In this frame, the TXOP limit based on a predetermined schedule is specified, and the QPA has no schedule for transmitting another frame, so that EOSP=1 is specified. Note that, for simplification in illustration, down link data is not transmitted herein, but it may be so arranged that down link data is transmitted before transmitting the QoS CF-Poll frame 1203.

The QSTA2 has been informed of the SST2 by the ADDTS response beforehand, so that the QSTA2 is in the awake mode at this time. In response to the QoS-Poll frame 1203, the QSTA2 transmits the data frame 1204. As described above, one or more data frames are transmitted here. When the TXOP limit informed by the QoS CF-Toll frame 1203 passes, the QSTA2 finishes the data transmission. Further, in the QoS CF-Poll frame 1203, EOS=1 is specified, so that the QSTA2 determines that no more data will be transmitted to the QSTA2 itself. As a result, the QSTA2 shifts into the power save mode.

It has been determined that the CP comes thereafter, the QAP does not transmit any data. Further, the QSTA1 and the QSTA2 do not transmit any data in the CP and other QSTA transmits a data frame 1205 in the DCF format. In the CP, each QSTA can transmit one or more data frames as necessary (the QSTA does not have to transmit any data frame if it is not necessary to transmit any data frame).

When a time to end the CP comes, the QAP transmits the QoS CF-Poll frame 1206 to the QSTA1 again. This operation is carried out when the SI passes after transmitting the QoS CF-Poll frame 1201 to the QSTA1 and when the SI passes from the SST1. At this time, the QSTA1 is in the awake mode. In response to the QoS CF-Poll frame 1206, the QSTA1 transmits a data frame 1207 and shifts into the power save mode. This flow is the same as in the case where the QoS CF-Poll frame 1021 is received.

When the specified TXOP limit passes after transmitting the QoS CF-Poll frame 1206, the QAP transmits the QoS CF-Poll frame 1208 to the QSTA2. This operation is carried out when the SI passes after transmitting the QoS CF-Poll frame 1203 to the QSTA2 and when the SI passes from the SST2. At this time, the QSTA2 is in the awake mode. In response to the QoS CF-poll frame 1208, the QSTA2 transmits the data frame 1209 and shifts into the power save mode. This flow is the same as in the case where the QoS CF-Poll frame 1203 is received.

It has been determined that the CP comes thereafter, so that the QAP does not transmit any data. Further, the QSTA1 and the QSTA2 do not transmit any data, and other QSTA can transmit a data frame 1210 in the DCF format. As described above, each QSTA can transmit one or more data frames as necessary.

The aforementioned procedure is repeated, so that each QSTA shifts into the awake mode only at a timing at which a polled TXOP is given to the QSTA, so that the power is efficiently saved.

Note that, the polled TXOP is given to a single QSTA only once in the schedule period, but the polled TXOP may be given plural times. For example, the polled TXOP may be scheduled to be given to the QSTA1 again after giving the polled TXOP to the QSTA2. However, in such case, the QSTA1 may be in the awake mode until a period in which the polled TXOP is not given to the QSTA1 (a period in which the polled TXOP is given to the QSTA2), so that the power is less efficiently saved in this case.

However, according to the conventional technique, in case where the CP is extended longer than a period having been set in an original schedule, the subsequent schedule deviates from the original schedule, so that this raises such problem that the power of the QSTA is less efficiently saved.

The CP is extended longer than the original schedule in the following three cases for example.

### (First Case)

The first case is such that a CP provided in the last of the schedule is extended. With reference to FIG. 20, the first case will be detailed as follows. Note that, how to illustrate the diagram and abbreviated names are the same as in FIG. 18 and FIG. 19 referred to in describing the background of the invention. Further, in FIG. 20, it is assumed that sequence of the ADDTS request and the ADDTS response has been completed.

In the example illustrated in FIG. 20, the QAP gives about 40% of a spectrum, as a transmission right giving period, to each of the QATS1 and the QSTA2, and about 20%, i.e., the rest of the spectrum is used as the CP. Such a schedule cycle is repeated as a preset schedule.

Further, the QAP informs each QSTA of an SST and an SI based on the preset schedule by means of an ADDTS response frame. That is, the QAP informs the QSTA1 of, as Service Start Time, an SST1 which is a scheduled time to transmit a QoS CF-Poll to the QSTA1 first, and informs the QSTA1 of, as Service Interval, an SI. Likewise, the QAP informs the QSTA2 of an SST2 as Service Start Time and informs the QSTA2 of an SI as Service Interval as in the QSTA1. Note that, for simplification of illustrations, Service Intervals of the QSTA1 and the QSTA2 are identical to each other here.

The flow in which a polled TXOP is given to each of the QSTA1 and the QSTA2 is the same as in the example described in the background of the invention.

After finishing giving the polled TXOP to the QSTA1, it is determined that the CP comes, so that the QAP does not transmit any data. Further, the QSTA1 and the QSTA2 do not transmit any data frame in the CP, but other QSTA transmits data in the DCF format.

After the end of the CP, the QAP transmits a CF-Poll frame so as to give a polled TXOP, but the CP may be extended longer than a period having been scheduled in the preset schedule by the QAP.

As described above, in the CP, each of all the QSTAs monitors whether a frame is transmitted to the radio medium or not, and a QSTA having detected that any frame has not been transmitted from any station for a period referred to as “DIFS” starts timekeeping of a downtimer referred to as “backoff timer”. When the backoff timer indicates 0, the QSTA can start transmission of a frame. This is the DCF format, and it is possible to transmit a frame in accordance with the DCF format. While, the QAP is an access point which manages the network entirely, so that the QAP can more preferentially transmit a frame than the QSTA which carries out transmission in the DCF format. Specifically, the QAP monitors whether a frame is transmitted to the radio medium or not, and it is possible to start transmission of frame upon detecting that any frame has not been transmitted from any station for a period referred to as “PIFS” shorter than the DIFS. That is, the QSTA transmits a CoS CF-Poll, prior to transmission of a frame in the DCF format, so as to start the polled TXOP, thereby bringing the CP to an end. As a result, it is possible to manage spectrum allocation in the entire network on the basis of the schedule which has been determined by the QSTA itself.

However, just before the scheduled time for the QAP to bring the CP to an end, the QAP cannot transmit a QoS CF-Poll frame until the QSTA having obtained a transmission right in the DCF format finishes transmission of a long frame having just transmitted. As a result, the QoS CF-Poll frame is transmitted at a time later than the scheduled time. In other words, the CP is extended in the spectrum allocation schedule in the QAP.

That is, in FIG. 20, the CP is provided after the QSTA2 finishes transmission of a data frame 1304, and other QSTA starts transmission of a data frame 1305 in the CP. Further, the transmission of the data frame 1305 causes the radio medium to be occupied for a period longer than the CP having been scheduled by the QAP. That is, the CP is extended longer than the scheduled period by a time period EX1.

Thereafter, in order to give a polled TXOP as scheduled from the first of the schedule cycle again, the QAP transmits a QoS CF-Poll frame. While, the QSTA receives no instruction from the QAP, so that the QSTA determines a timing to shift into the awake mode in accordance with the SST and the SI which have been informed.

The QSTA1 shifts into the power save mode after transmitting the data frame 1302, and then the QSTA1 shifts into the awake mode when the SI passes from the SST1. In this time, the QAP should have transmitted a QoS CF-Poll frame to the QSTA1, but the CP is actually extended, so that the QoS CF-Poll frame is not transmitted, and the QoS CF-Poll frame 1306 is transmitted when the EX1 passes after the QSTA1 has shifted into the awake mode.

Likewise, the QSTA2 shifts into the power save mode after transmitting the data frame 1304, and then the QSTA2 shifts into the awake mode when the SI passes from the SST2. In this time, the QoS CF-Poll frame is not transmitted, and the QoS CF-Poll frame 1308 is transmitted when the EX1 passes after the QSTA2 has shifted into the awake mode.

That is, each of the QSTA1 and the QSTA2 shifts into the awake mode also in an unnecessary period.

The delay of the schedule is not corrected also thereafter, so that each of the QSTA1 and the QSTA2 shifts in the awake mode at each EX1 period.

Further, in the example illustrated in FIG. 20, also in the CP provided after the QSTA2 has transmitted a data frame 1314, other QSTA transmits a data frame 1315, so that the CP is extended by an EX2 period.

As a result, the actual schedule deviates from the preset schedule by a period equal to a total of the EX1 and EX2 periods, so that the QSTA1 and the QSTA2 shift into the awake mode also during an unnecessary period equal to a total of the EX1 and EX2 periods.

Further, in the example illustrated in FIG. 20, the QSTA1 receives a QoS CF-Poll frame 1316 when the period equal to a total of the EX1 and EX2 periods (unnecessary awake periods) passes, and the QSTA1 transmits a data frame 1317. In this case, a subsequent SP has already started at the time when the transmission of the data frame 1317 is completed, so that an ESOP field of the thus received QoS CF-Poll frame 1316 is invalid. As a result, the QSTA1 cannot shift into the power save mode. The same state occurs also thereafter, so that the QSTA1 and the QSTA2 cannot shift into the power save mode at all.

### (Second Case)

In the second case, a CP occurs when a polled TXOP is returned earlier than scheduled, so that the CP is extended.

With reference to FIG. 21, the second case will be detailed as follows. Note that, how to illustrate the diagram and abbreviated names are the same as in FIG. 18 and FIG. 19 referred to in describing the background of the invention. Further, in FIG. 20, it is assumed that sequence of the ADDTS request and the ADDTS response has been completed.

In the example illustrated in FIG. 21, the QAP gives about 30% of a spectrum, as a transmission right giving period, to each of the QATS1 and the QSTA2, and about 40%, i.e., the rest of the spectrum is used as the CP. Such a schedule cycle is repeated as a preset schedule. That is, a polled TXOP whose length is about 30% of the scheduled cycle is given to the QSTA1, and a polled TXOP having the same length is given to the QSTA2. Further, a rest of the period is allocated as the CP.

Further, the QAP informs each QSTA of an SST and an SI based on the preset schedule by means of an ADDTS response frame. That is, the QAP informs the QSTA1 of, as Service Start Time, an SST1 which is a scheduled time to transmit a QoS CF-Poll to the QSTA1 first, and informs the QSTA1 of, as Service Interval, an SI. Likewise, the QAP informs the QSTA2 of an SST2 as Service Start Time and informs the QSTA2 of an SI as Service Interval as in the QSTA1. Note that, for simplification of illustrations, Service Intervals of the QSTA1 and the QSTA2 are identical to each other here.

In FIG. 21, a procedure after transmitting a QoS CF-Poll frame 1405 is a characteristic in this case, so that only this procedure is described below.

The QoS CF-Poll frame 1405 includes a TXOP limit, so that the QSTA1 can find the length of the polled TXOP given to the QSTA1. Further, the QSTA1 starts transmission of a data frame 1406 after receiving the QoS CF-Poll frame 1405, but there may be no data, which should be transmitted, before completely using the given polled TXOP period. In this case, the QSTA1 transmits a predetermined frame to the QSA, so that the transmission right is returned to the QAP, thereby bringing the polled TXOP to an end. Note that, as the frame which can be transmitted so as to return the transmission right, plural kinds of the frame are defined in the specifications of IEEE 802.11e, but the frame used to return the transmission right is generically referred to as “TXOP return frame” in the present specification.

In FIG. 21, the QSTA1 transmits the TXOP return frame while transmitting the data frame 1406 so as to bring the polled TXOP to an end in the middle of transmission of the data frame 1406. The QAP having received the returned polled TXOP would transmit the QoS CF-Poll frame to the QSTA2 in the scheduled order. However, in the preset schedule, this time is not a scheduled time to transmit the QoS CF-Poll frame to the QSTA2, so that the QSTA2 is in the power save mode. Thus, even when the QAP transmits a QoS CF-Poll frame, the QoS CF-Poll frame is not received by the QSTA2, so that it is impossible to start the polled TXOP of the QSTA2. Thus, the QAP provides the CP here.

As described in the first case, the CP may be extended. In FIG. 21, the CP is extended over the scheduled time to give the polled TXOP to the QSTA2. As a result, the schedule for the QAP to allocate a spectrum deviates by an increment of the length (EX in FIG. 21) of the CP extended over the scheduled time to give the polled TXOP to the QSTA2.

After the end of the CP, the QAP restarts the transmission of the CF-Poll frame in an order specified by the preset schedule so as to give the TXOP. While, the QSTA receives no instruction from the QAP, so that the QSTA determines a timing for shifting into the awake mode in accordance with the SST and the SI which have already been informed.

Thus, as in the first case, the QSTA1 and the QSTA2 shift into the awake mode also during an unnecessary period equal to each EX in each SI. Note that, if the CP is extended again, the schedule is cumulatively delayed as in the first case.

### (Third Case)

In the third case, when transmitting streams different from each other in the SI to each QSTA, a CP occurs between polled TXOPs of each QSTA, and a CP thereof is extended.

With reference to FIG. 22, the third case will be detailed as follows. Note that, how to illustrate the diagram and abbreviated names are the same as in FIG. 18 and FIG. 19 referred to in describing the background of the invention. Further, in FIG. 22, it is assumed that sequence of the ADDTS request and the ADDTS response has been completed.

In the example illustrated in FIG. 22, on the basis of an ADDTS request frame, the QAP gives the QSTA1, at each schedule cycle, a polled TXOP whose period is about 20% of the schedule cycle, and gives the QSTA2, at every two schedule cycles, a polled TXOP whose period is about 20% of the schedule cycle, and gives the QSTA3, at every three schedule cycles, a polled TXOP whose period is about 20% of the schedule cycle, and the rest of the period is used as the CP. Such a schedule cycle is repeated as a preset schedule.

Note that, Service Interval of the QSTA1 has the same length as the schedule cycle (SI1), and the polled TXOP given to the QSTA1 is positioned at the beginning point of the scheduled cycle, and its Service Start Time begins at a time corresponding to the beginning point of the schedule cycle (SST1). Further, Service Interval of the QSTA2 is twice as long as the schedule cycle (SI2), and the polled TXOP given to the QSTA2 is positioned after the polled TXOP given to the QSTA1, and Service Start Time begins at a time calculated by adding, to the beginning time of the schedule cycle, (i) a length of the polled TXOP given to the QSTA1 and (ii) a period of Down link transmission from the QAP to the QSTA1 (including a period to transmit a QoS CF-Poll frame) (SST2). As to the QSTA3, its Service interval is three times as long as the schedule cycle (SI3), and the polled TXOP given to the QSTA3 is positioned after the polled TXOP given to the QSTA2, and Service Start Time begins at a time calculated by adding, to the beginning point of the schedule cycle, (i) lengths of the polled TXOPs respectively given to the QSTA1 and the QSTA2 and (ii) periods of Down link transmission from the QAP to the QSTA1 and the QSTA2 (including a period to transmit a QoS CF-Poll frame) (SST3).

In case where the preset schedule having such spectrum allocation, there occurs a QSTA which requires no addition of any polled TXOP depending on the schedule cycle. In this case, a CP is provided in an unoccupied time.

For example, in a schedule cycle 2, a polled TXOP between the QSTA2 and the QSTA3 is not required, so that all the unoccupied time is the CP after the end of the polled TXOP given to the QSTA1. Further, in a schedule cycle 3, a polled TXOP in the QSTA3 is not required, so that all the unoccupied time is the CP after the ends of the polled TXOPs respectively given to the QSTA1 and the QSTA2.

A problem occurs in a case such as a schedule cycle 4. In a schedule cycle 1, after giving the polled TXOPs to the QSTA1 and the QSTA2 respectively, a polled TXOP is given to the QSTA3. Due to such schedule, a corresponding SST3 is informed. Further, a polled TXOP is further given to the QSTA3 at the subsequently positioned third schedule cycle, so that a length three time as long as the schedule cycle is informed as the S13. In a schedule cycle 4, it is necessary to provide polled TXOPs to the QSTA1 and the QSTA3 respectively, but the QSTA3 is not in the awake mode just after the end of the polled TXOP for the QSTA1, so that it is impossible to transmit the QoS CF-Poll to the QSTA3. Thus, the QAP provides a CP between the polled TXOP for the QSTA1 and the polled TXOP for the QSTA3. In FIG. 22, at the schedule cycle 4, the CP is provided after the QSTA1 receives a QoS CF-Poll frame 1513 and transmits a data frame 1514. However, just before the end of the CP, a long frame is transmitted from other QSTA, so that the CP is extended by a time period indicated by EX. Thus, the QSTA3 expects transmission of a QoS CF-Poll frame and shifts into the awake mode when the SI3 passes from the SST3, but the QoS CF-Poll frame 815 is actually transmitted when the time period indicated by EX passes after shifting into the awake mode.

Thereafter, the QSTA3 shifts into the awake mode also during each period indicated by EX in each SI3, so that the power is less efficiently saved.

Furthermore, also the QoS CF-Poll frame 1517 for the QSTA1 and the QoS CF-Poll frame 1519 for the QSTA2 delay, so that the power in all the QSTA1 to QSTA3 is less efficiently saved. Note that, if the CP is extended again, the schedule cumulatively delays as in the first case and the second case.

Note that, not only in the case where the CP is extended but also in case where a noise occurs in a radio zone, the schedule can delay. Accordingly, the schedule delays.

### DISCLOSURE OF INVENTION

The present invention was made in view of the foregoing problems, and an object of the present invention is to prevent or suppress drop of the power save efficiency which is caused by a delay of a schedule in which the access point gives a transmission right to a station.

In order to solve the foregoing problems, a communication device of the present invention serves as an access point provided on a network adopting (a) a first communication method for managing a period in which the access point gives a transmission right to the access point itself or gives transmission rights to stations respectively and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided, said communication device informing the station of the SST and the SI in accordance with the schedule, said communication device being characterized by comprising: delay detection means for detecting that a start time to give the transmission right to the access point itself or the station delays from the schedule; and timing control means for controlling the period for executing the second communication method so that the period for executing the second communication method is shortened or omitted when the delay detection means detects the delay.

According to the arrangement, when the start time to give the transmission right to the station delays from the schedule, a control is carried out so that the period for executing the second communication method is shortened or omitted. As a result, the start time to give the transmission right to the station can be synchronized with or can be made nearer to the schedule. Thus, for example, in case of carrying out the power save (decreasing the power consumption) in accordance with the SST and the SI informed from the access point to the station, the start time to give the transmission right to the station can be synchronized with or can be made nearer to the schedule of the power save carried out in the station. Thus, also in case where the period for executing the second communication method is extended longer than the period having been set in the schedule, it is possible to suppress the drop of the power save efficiency in the station.

Further, in order to solve the foregoing problems, a communication device of the present invention serves as an access point provided on a network adopting (a) a first communication method for managing a period in which the access point gives a transmission right to the access point itself or gives transmission rights to stations respectively and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided, said communication device informing the station of the SST and the SI in accordance with the schedule, said communication device being characterized by comprising delay detection means for detecting that a start time to give the transmission right to the access point itself or the station delays from the schedule, wherein the schedule setting means resets the schedule when the delay detection means detects the delay, and the schedule setting means informs an SST and an SI, which are based on the schedule having been reset, to a station which delays from the schedule in the start time to give the transmission right.

According to the arrangement, when the start time to give the transmission right to the station delays from the schedule, a subsequent schedule is reset. Further, the SSI and the SI are informed to the station, which delays from the schedule in the start time to give the transmission right, in accordance with the schedule having been reset. As a result, the start time to give the transmission right which start time is recognized by the station can be synchronized with the actual start time to give the transmission right to the station. Thus, for example, in case of carrying out the power save in accordance with the SSI and the SI informed from the access point to the station, the actual start time to give the transmission right to the station can be synchronized with the power save schedule of the station. Therefore, also in case where the period for executing the second communication method is extended longer than the period having been set in the schedule, it is possible to suppress the drop of the power save efficiency in the station.

Further, in order to solve the foregoing problems, a communication device of the present invention serves as an access point provided on a network adopting (a) a first communication method for managing a period in which the access point gives a transmission right to the access point itself or gives transmission rights to stations respectively and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided, said communication device informing the station of the SST and the SI in accordance with the schedule, said communication device being characterized in that: the schedule setting means specifies schedule cycles each of which has a certain length, and sets the schedule so as to periodically repeat a group of the schedule cycles which are provided in a sequential manner, and the schedule setting means informs all stations, to which the transmission rights are to be given respectively during each of the schedule cycle, of a period from a start time of the schedule cycle to a time when transmission of a first transmission right giving signal in the schedule cycle is completed, and in case where the transmission right is returned from any one of the stations earlier than a finish time of the SP in the schedule, the schedule setting means controls a start time to give the transmission right, which start time comes after detecting that the transmission right in the schedule cycle is returned, so as to make the start time earlier than scheduled in the schedule.

According to the arrangement, each station recognizes that the transmission right giving signal is transmitted to the station during a period from the start time of each schedule cycle to a time when transmission of the first transmission right giving signal in the schedule cycle is completed. Thus, for example, in case of carrying out the power save in accordance with the SST and the SI informed from the access point to the station, each station is released from the power save mode and shifts into the awake mode at the start time of the schedule cycle for giving the transmission right or slightly later. Thus, for example, also in case where a station to which the transmission right has been given returns the transmission right to the access point earlier than scheduled, other station is in the awake mode at the time when the transmission right is returned. Thus, in case where the transmission right is returned earlier than scheduled, a signal for giving the transmission right can be transmitted, earlier than the scheduled time, to a station to which the transmission right is to be transmitted at the time when it is detected that the transmission right is returned or at the subsequent time, thereby allowing the station to receive the signal earlier than scheduled.

As a result, in case where the transmission right is returned earlier than scheduled, it is possible to avoid such condition that the second communication method has to be executed during a period until the transmission right is given to a next station. Thus, the period for executing the second communication method is not set at an unscheduled time, so that the period having been set in the original schedule is not extended, thereby preventing such condition that the timing for giving the transmission right in or after detecting that the transmission right is returned delays from the schedule. That is, it is possible to prevent the drop of the power save efficiency which is caused by extension of the period for executing the second communication method.

Further, in order to solve the foregoing problems, a communication device of the present invention serves as an access point provided on a network adopting (a) a first communication method for managing a period in which the access point gives a transmission right to the access point itself or gives transmission rights to stations respectively and (b) a second communication method for allowing each of the stations to acquire each of the transmission rights, said network allows the station to begin to execute the second communication method in case where it is detected that a signal has not been transmitted from the access point or other stations for a period equal to or longer than a predetermined period, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided, said communication device informing the station of the SST and the SI in accordance with the schedule, said communication device being characterized by comprising means for forbidding all the stations from executing the second communication method during a period from a time when the transmission right is returned from any one of the stations to a scheduled time to subsequently give a transmission right, said any one of the stations returning the transmission right earlier than a finish time of the SP in the schedule.

For example, in case where the power save is carried out in accordance with the SST and the SI informed from the access point to the station and a station to which the transmission right has been given returns the transmission right earlier than scheduled, a next station to which the transmission right is to be subsequently given may be in the power save mode at this time. In this case, even if the access point tries to give the transmission right to the next station to which the transmission right is to be subsequently given, the next station cannot receive any signal from the access point. Under such condition, it is general that the access point does not transmit any signal to the network until a scheduled time to give the transmission right to the next station comes. Further, if any signal has not been transmitted to the network for a period equal to or longer than a predetermined period, the period for executing the second communication method is provided at an unscheduled time.

However, according to the foregoing arrangement, in case where a station to which the transmission right has been given returns the transmission right earlier than scheduled, the means for forbidding the use of the second communication method prevents the second communication method from being executed after the transmission right is returned to the access point and until a time when the transmission right is given to the next station in the schedule.

As a result, in case where the transmission right is returned earlier than scheduled, it is possible to avoid such condition that the second communication method is executed by the scheduled time to subsequently give the transmission right to the next station. Thus, the period for executing the second communication method is not provided at an unscheduled time, so that the period having been set in the original schedule is not extended, thereby preventing such condition that the timing for giving the transmission right in or after detecting that the transmission right is returned delays from the schedule. That is, it is possible to prevent the drop of the power save efficiency which is caused by extension of the period for executing the second communication method.

Further, in order to solve the foregoing problems, a communication method of the present invention is applied to a communication device serving as an access point provided on a network adopting (a) a first communication method for managing a period in which the access point gives a transmission right to the access point itself or gives transmission rights to stations respectively and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided, said communication device informing the station of the SST and the SI in accordance with the schedule, said communication method comprising the steps of: (i) detecting that a start time to give the transmission right to the access point itself or the station delays from the schedule; and (ii) controlling the period for executing the second communication method so that the period for executing the second communication method is shortened or omitted when the delay detection means detects the delay.

According to the foregoing method, when the start time to give the transmission right to the station delays from the schedule, a control is carried out so that the period for executing the second communication method is shortened or omitted. As a result, the start time to give the transmission right to the station can be synchronized with or can be made nearer to the schedule. Thus, for example, in case of carrying out the power save in accordance with the SST and the SI informed from the access point to the station, the start time to give the transmission right to the station can be synchronized with or can be made nearer to the schedule of the power save carried out in the station. Thus, also in case where the period for executing the second communication method is extended longer than the period having been set in the schedule, it is possible to suppress the drop of the power save efficiency in the station.

Further, in order to solve the foregoing problems, a communication method of the present invention is applied to a communication device serving as an access point provided on a network adopting (a) a first communication method for managing a period in which the access point gives a transmission right to the access point itself or gives transmission rights to stations respectively and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided, said communication device informing the station of the SST and the SI in accordance with the schedule, said communication method comprising the step (i) of detecting that a start time to give the transmission right to the access point itself or the station delays from the schedule, wherein the schedule is reset when the delay is detected in the step (i), and an SST and an SI, which are based on the schedule having been reset, are informed to a station which delays from the schedule in the start time to give the transmission right.

According to the foregoing method, when the start time to give the transmission right to the station delays from the schedule, a subsequent schedule is reset. Further, the SSI and the SI are informed to the station, which delays from the schedule in the start time to give the transmission right, in accordance with the schedule having been reset. As a result, the start time to give the transmission right which start time is recognized by the station can be synchronized with the actual start time to give the transmission right to the station. Thus, for example, in case of carrying out the power save in accordance with the SSI and the SI informed from the access point to the station, the actual start time to give the transmission right to the station can be synchronized with the power save schedule of the station. Therefore, also in case where the period for executing the second communication method is extended longer than the period having been set in the schedule, it is possible to suppress the drop of the power save efficiency in the station.

Further, in order to solve the foregoing problems, a communication method of the present invention is applied to a communication device serving as an access point provided on a network adopting (a) a first communication method for managing a period in which the access point gives a transmission right to the access point itself or gives transmission rights to stations respectively and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided, said communication device informing the station of the SST and the SI in accordance with the schedule, said communication method comprising the steps of: specifying schedule cycles each of which has a certain length and setting the schedule so as to periodically repeat a group of the schedule cycles which are provided in a sequential manner; informing all stations, to which transmission rights are to be given respectively during each of the schedule cycle, of a period from a start time of the schedule cycle to a time when transmission of a first transmission right giving signal in the schedule cycle is completed; in case where the transmission right is returned from any one of the stations earlier than a finish time of the SP in the schedule, controlling a start time to give the transmission right, which start time comes after detecting that the transmission right in the schedule cycle is returned, so as to make the start time earlier than scheduled in the schedule.

According to the foregoing method, in case where the transmission right is returned earlier than scheduled, it is possible to avoid such condition that the second communication method has to be executed during a period until the transmission right is given to a next station. Thus, the period for executing the second communication method is not set at an unscheduled time, so that the period having been set in the original schedule is not extended, thereby preventing such condition that the timing for giving the transmission right in or after detecting that the transmission right is returned delays from the schedule. That is, it is possible to prevent the drop of the power save efficiency which is caused by extension of the period for executing the second communication method.

Further, in order to solve the foregoing problems, a communication method of the present invention is applied to a communication device serving as an access point provided on a network adopting (a) a first communication method for managing a period in which the access point gives a transmission right to the access point itself or gives transmission rights to stations respectively and (b) a second communication method for allowing each of the stations to acquire each of the transmission rights, said network allows the station to begin to execute the second communication method in case where it is detected that a signal has not been transmitted from the access point or other stations for a period equal to or longer than a predetermined period, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided, said communication device informing the station of the SST and the SI in accordance with the schedule, said communication method comprising the step of forbidding all the stations from executing the second communication method during a period from a time when the transmission right is returned from any one of the stations to a scheduled time to subsequently give a transmission right, said any one of the stations returning the transmission right earlier than a finish time of the SP in the schedule.

According to the foregoing method, in case where the transmission right is returned earlier than scheduled, it is possible to avoid such condition that the second communication method is executed by the scheduled time to subsequently give the transmission right to the next station. Thus, the period for executing the second communication method is not provided at an unscheduled time, so that the period having been set in the original schedule is not extended, thereby preventing such condition that the timing for giving the transmission right in or after detecting that the transmission right is returned delays from the schedule. That is, it is possible to prevent the drop of the power save efficiency which is caused by extension of the period for executing the second communication method.

### BRIEF DESCRIPTION OF DRAWINGS

FIG. 1 is an example of a timing chart in a network managed by a QAP (access point) according to an embodiment of the present invention.

FIG. 2 is a block diagram illustrating a schematic arrangement of the QAP according to an embodiment of the present invention.

FIG. 3 is a flowchart illustrating a flow of processes carried out by the QAP according to an embodiment of the present invention.

FIG. 4 is another example of a timing chart in a network managed by a QAP (access point) according to an embodiment of the present invention.

FIG. 5 is a flowchart illustrating a flow of processes carried out by a QAP according to another embodiment of the present invention.

FIG. 6 is an example of a timing chart in a network managed by a QAP according to another embodiment of the present invention.

FIG. 7 is a flowchart illustrating a flow of processes carried out by a QAP according to further another embodiment of the present invention.

FIG. 8 is an example of a timing chart in a network managed by a QAP according to further another embodiment of the present invention.

FIG. 9 is an example of a timing chart in a network managed by a QAP according to still further another embodiment of the present invention.

FIG. 10 is an example of a timing chart in a network managed by a QAP according to further another embodiment of the present invention.

FIG. 11 is an example of a timing chart in a network managed by a QAP according to still further another embodiment of the present invention.

FIG. 12 is an example of a timing chart in a network managed by a QAP according to further another embodiment of the present invention.

FIG. 13 is an example of a timing chart in a network managed by a QAP according to still further another embodiment of the present invention.

FIG. 14 is an example of a timing chart in a network managed by a QAP according to further another embodiment of the present invention.

FIG. 15 is an explanatory drawing illustrating an example of an arrangement of a conventional network.

FIG. 16 is a block diagram illustrating an arrangement of an access point and stations which are used in the conventional network.

FIG. 17 is an explanatory drawing illustrating an example of frame sequence communicated in the conventional network.

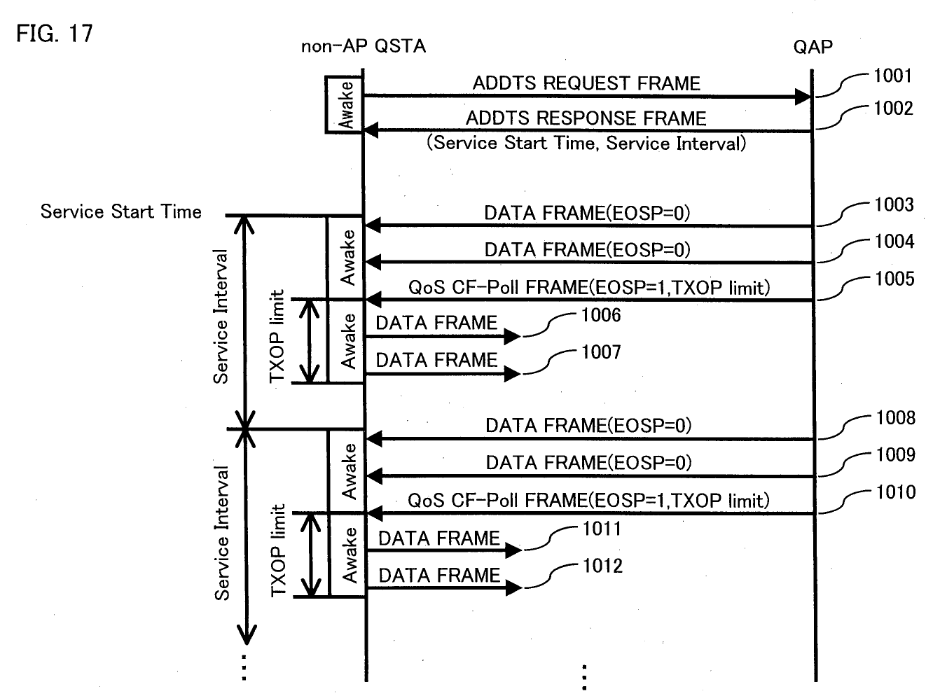

FIG. 18 is an example of a timing chart in the conventional network.

FIG. 19 is an example of a timing chart in the conventional network.

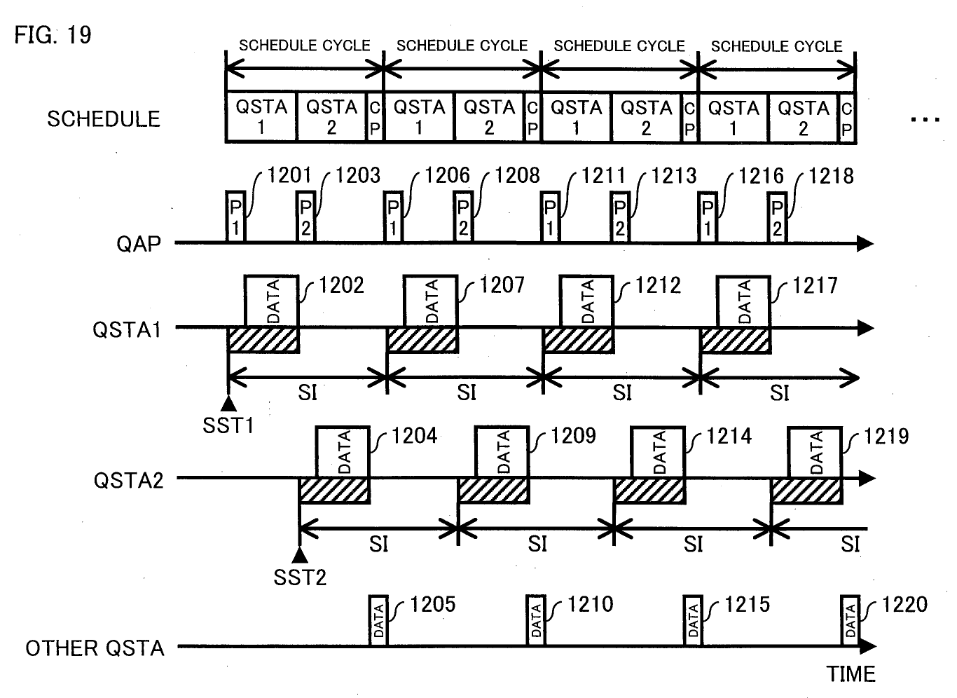

FIG. 20 is an example of a timing chart in the conventional network.

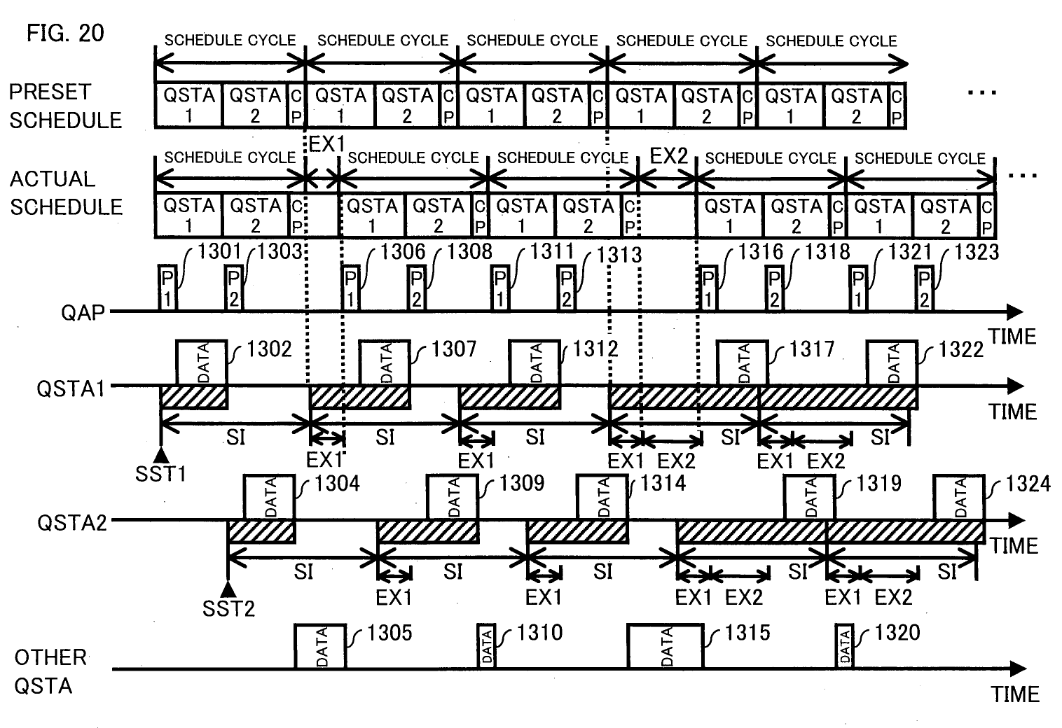

FIG. 21 is an example of a timing chart in the conventional network.

FIG. 22 is an example of a timing chart in the conventional network.

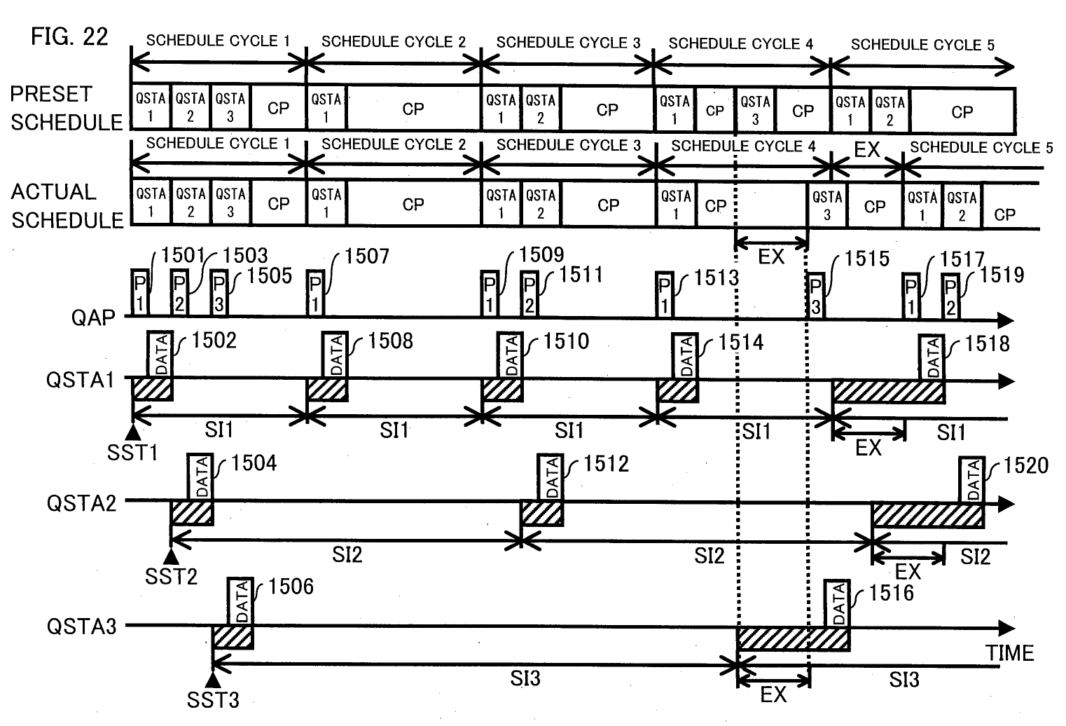

### BEST MODE FOR CARRYING OUT THE INVENTION

### Embodiment 1

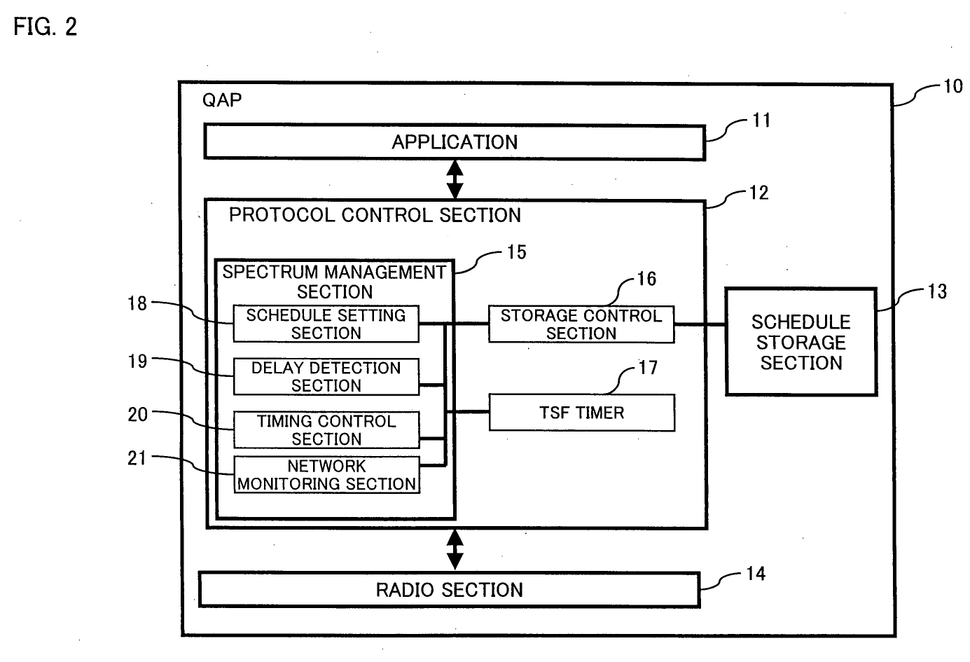

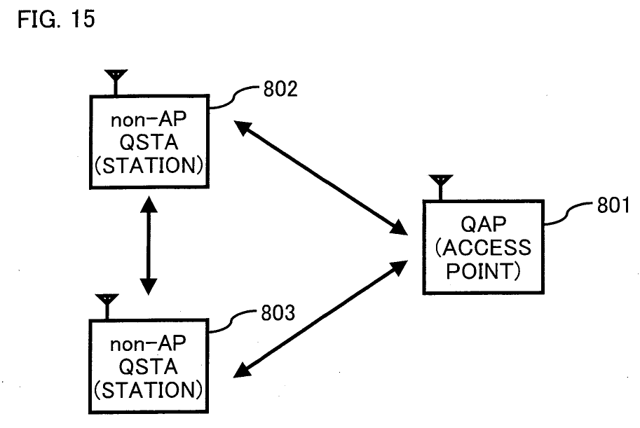

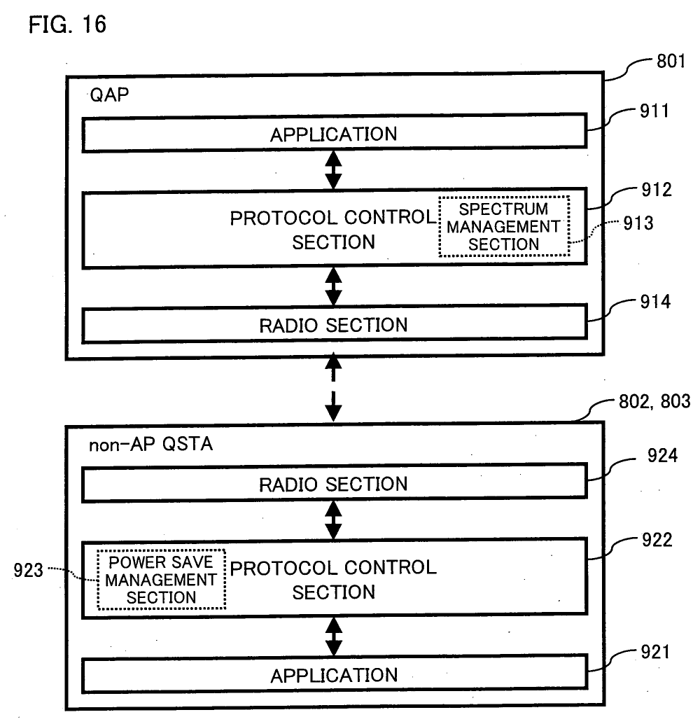

An embodiment of the present invention is described as follows. FIG. 2 is a block diagram illustrating a schematic arrangement of a QAP (access point) 10 according to the present embodiment. The QAP is used in a network which allows communications on the basis of IEEE 802.11e standard. For example, the QAP 10 is used, instead of a QAP 801, in a network illustrated in FIG. 15. Note that, a QSTA (station: non-AP QSTA) arranged in the same manner as in the QSTA illustrated in FIG. 16 can be used.

In case where a spectrum allocation schedule delays from a preset schedule, the QAP 10 according to the present embodiment controls a timing of subsequent frame transmission so as to make up for lost time, thereby carrying out correction so that a schedule of power save in the QSTA and a timing of actual frame transmission are synchronized with each other.

As illustrated in FIG. 2, the QAP 10 includes an application section 11, a protocol control section 12, a schedule storage section 13, and a radio section 14.

The application section 11 reads out an application program stored in storage means (not shown) and executes the application program.

The protocol control section 12 controls communication protocol in a network managed by the QAP 10, and includes a spectrum management section 15, a storage control section 16, a TSF timer 17, and the like.

The spectrum management section 15 includes a schedule setting section 18, a timing control section 20, a network monitoring section 21, a delay detection section 19, and the like.

The schedule setting section 18 sets a schedule for allocating spectrums to QSTAs respectively (schedule for carrying out down link transmission to the QSTAs and for giving transmission rights to the QSTAs respectively) in accordance with information such as a transmission rate of transmission data informed by the QSTAs with the information included in an ADDTS request frame. Note that, the schedule is set with it related to a time indicated by the TSF timer 17. A time indicated by the TSF timer 17 allows all the QSTAs and the QAP which belong to the network to be synchronized with one another.

Further, the schedule set by the schedule setting section 18 is stored into the schedule storage section 13 by the storage control section 16. The schedule storage section 13 allows the preset schedule set by the schedule setting section 18 to be stored therein, and the storage control section 16 controls storage of the schedule into the schedule storage section 13 and controls reading out the stored schedule from the schedule storage section 13.

The timing control section 20 controls a timing, at which a data frame and/or a QoS CF-Poll frame (transmission right giving frame) to each QSTA, in accordance with the schedule set by the schedule setting section 18. However, in a CP (Contention period), the timing control section 20 does not start transmission of any frame until a period passes during which any frame has not been transmitted from any station (the period is referred to as PIFS).

The network monitoring section 21 monitors whether or not any frame is transmitted from any QSTA (whether or not any frame is transmitted to the network (radio medium)). Further, the period for which any frame has not been transmitted from any station is measured, and whether or not the measured time has been continued for the period referred to as PIFS is determined, and the determination result is informed to the timing control section 20. Further, in the CP, when any frame has not been transmitted from any station for the PIFS period, this is informed to the delay detection section 19.

The delay detection section 19 detects whether or not the actual schedule delays from the preset schedule. As described above, the QAP 10 causes the network monitoring section 21 to sense the medium also in the CP (causes the network monitoring section 21 to monitor whether or not any frame is transmitted to the medium). Further, in the CP, when any frame has not been transmitted from any station for the PIFS period, this is informed to the delay detection section 19. As a result, the delay detection section 19 detects a time to bring the CP to an end. Further, the storage control section 16 is caused to read out the preset schedule from the schedule storage section 13, and the detected time to bring the CP to an end is compared with the scheduled time to bring the CP to an end, thereby determining whether or not the CP is extended, that is, whether or not the schedule delays.

Further, in case where the CP is extended, the delay detection section 19 calculates a time EX indicative of an extended time of the CP with respect to the scheduled time to bring the CP to an end in the preset schedule.

The radio section 914 is means for allowing communications between the QSTAs, and converts a received electric wave signal into a frame comprehensible for the protocol control section 12 so as to transmit the frame to the protocol control section 12, and converts a frame signal transmitted from the protocol control section 12 into an electric wave signal so as to transmit the electric wave signal to the QSTA via the radio medium.

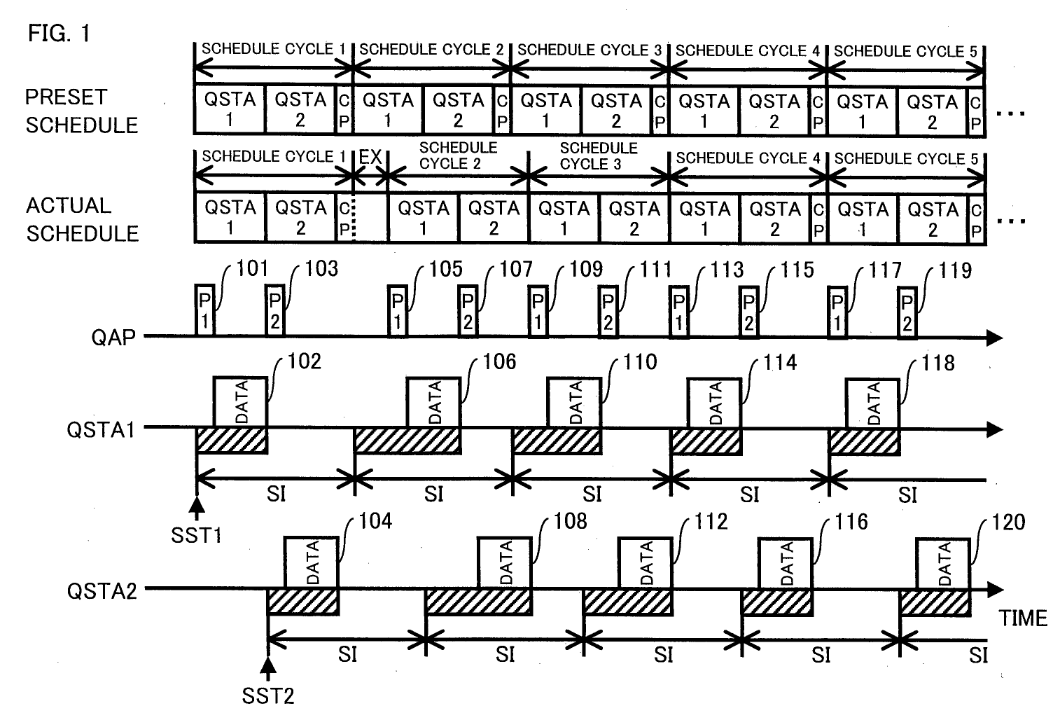

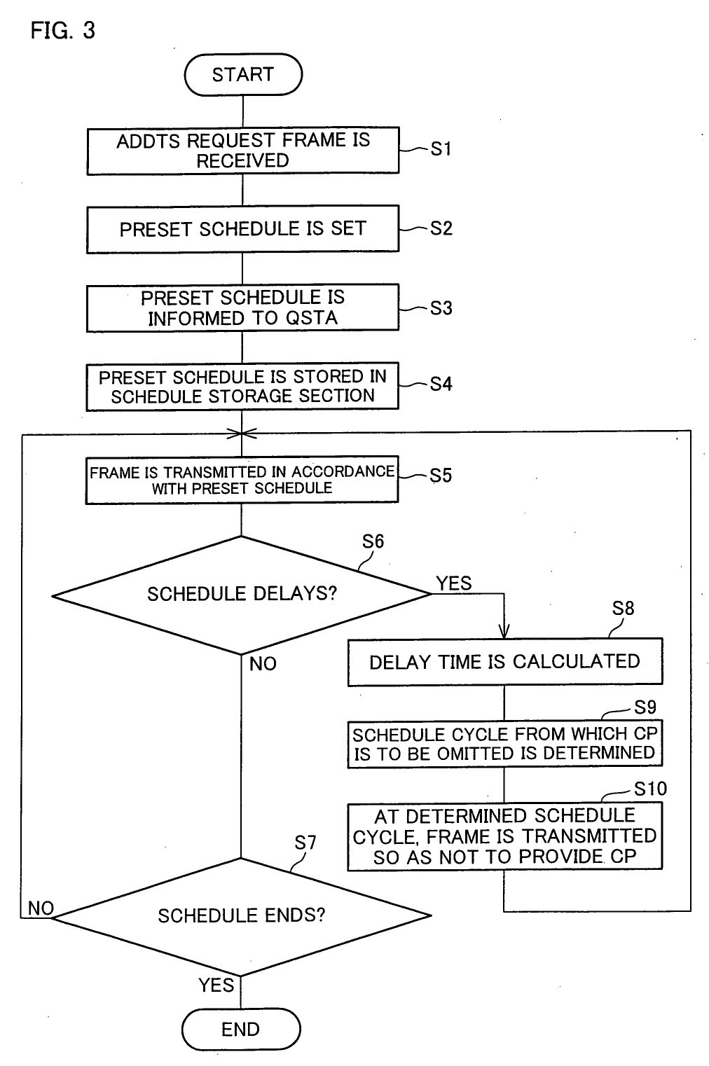

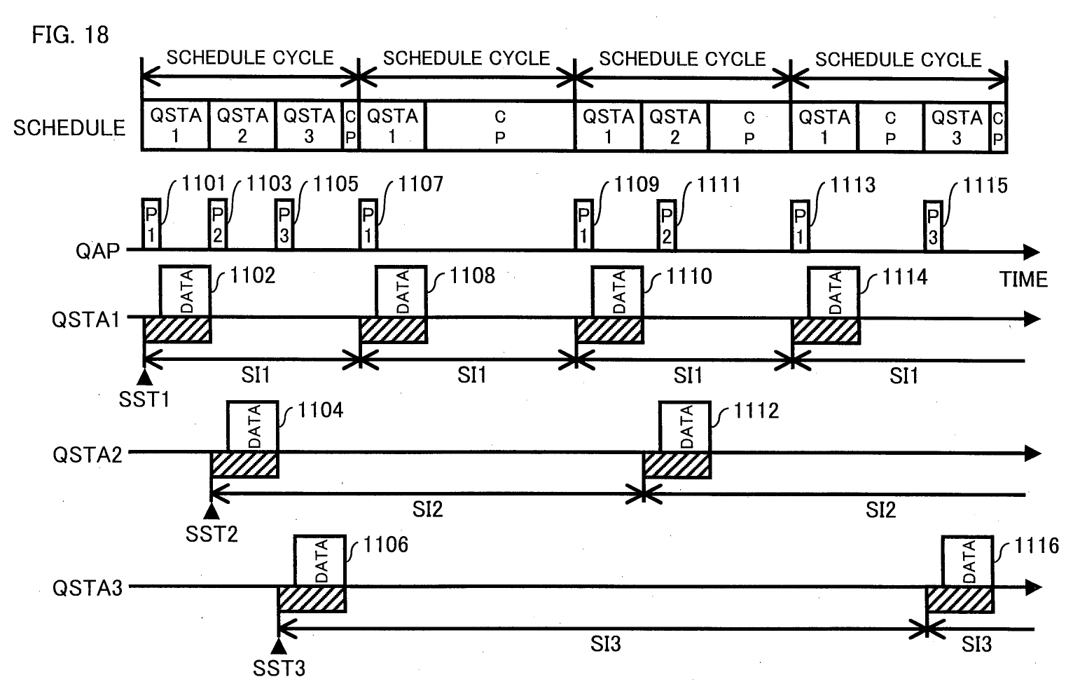

Next, how the QAP 10 operates will be described as follows. FIG. 3 is a flowchart illustrating a flow of operations of the QAP 10. FIG. 1 is an example of a timing chart in the network managed by the QAP 10. Note that, how to illustrate the diagram and abbreviated names are the same as in FIG. 18 and the like.

As illustrated in FIG. 3, in response to an ADDTS request frame from the QSTA (SI), the QAP 10 determines whether or not to acknowledge spectrum allocation in accordance with a TSPEC or the like included in the frame (the spectrum allocation is acknowledged in FIG. 3). Note that, the TSPEC is an information group indicative of specifications of a data group to be transmitted and includes information or the like which is indicative of how many times the data is to be transmitted and how long the data is.

Next, the schedule setting section 18 (spectrum management section 15) sets the schedule (preset schedule) for allocating spectrums to the QSTAs respectively in accordance with the TSPEC (S2).

In an example of the preset schedule illustrated in the top of FIG. 1, poled TXOPs, i.e., periods each of which is about 40% of each schedule cycle are respectively given to the QSTA1 and the QSTA2 in each schedule cycle.

Note that, in this example, an SI (Service Interval) of the QSTA1 is as long as the schedule cycle (SI), and the polled TXOP of the QDTA1 is positioned at the beginning point of the schedule cycle, and an SST (Service Start Time) of the QSTA1 begins at the beginning point of the schedule cycle (SST1).

Further, an SI (Service Interval) of the QSTA2 is as long as the schedule cycle (SI), and the polled TXOP of the QDTA2 is positioned at a point subsequent to the polled TXOP of the QSTA1 in the schedule cycle, and an SST (Service Start Time) of the QSTA2 begins at a time calculated by adding, to the beginning of the schedule cycle, a length of a period (P1) for transmitting the QoS CF-Poll frame to the QSTA1 and a length of the polled TXOP (SST2).

Further, a CP is provided after data frame transmission of the QSTA2 in each schedule cycle.

In case where the CP is not extended, a period to give a transmission right to each QSTA is managed in accordance with the preset schedule.

After setting the present schedule in S2, the schedule setting section 18 informs the QSTA of the present schedule, having been set, as the ADDTS response frame (S3). Specifically, each QSTA is informed of a corresponding SST and a corresponding SI. Note that, in FIG. 1, illustration is partially omitted on the assumption that transmission and reception of the ADDTS request frame and the ADDTS response frame have been completed.

Further, the storage control section 16 stores the preset schedule, having been set by the schedule setting section 18, into the schedule storage section 13 (S4).

Thereafter, the timing control section 20 transmits a frame (QoS CF-Poll frame) to each QSTA in accordance with the present schedule having been set by the schedule setting section 18 (S5).

Further, the delay detection section 19 compares the preset schedule with the actual schedule so as to determine whether any delay occurs or not (S6).

Further, in case where it is determined that no delay occurs in S6, the timing control section 20 determines whether the present schedule has been executed or not (S7). Further, in case where the preset schedule has not been executed, the process of S5 is subsequently carried out, and frame transmission based on the preset schedule is continued. Further, in case where it is determined that the preset schedule has been executed, the QAP 10 brings the process to an end.

While, in case where it is determined that a delay occurs in S6, the delay detection section 19 calculates a delay time (S8) and informs the calculated delay time to the timing control section 20.

The timing control section 20 determines a schedule cycle, from which the CP is to be omitted so as to recover the delay, in accordance with a delay time having been calculated by the delay detection section 19 and each schedule cycle of the preset schedule (S9). That is, in accordance with (i) the length of EX indicative of the extension of the CP and (ii) the length of the originally scheduled CP of the preset schedule, the timing control section 20 calculates the number of times the CP should be omitted so that the actual schedule for the QAP 10 to allocate spectrums is synchronized with the preset schedule. In this manner, the timing control section 20 determines the schedule cycle from which the CP is omitted so as to recover the delay.

Further, in the schedule cycle determined in S9, the timing control section 20 transmits a frame so that the CP is not provided (the scheduled CP is omitted) (S10). Further, after the end of the schedule cycle determined in S9, the process of S5 is carried out again. In this manner, it is detected that the actual frame transmission timing delays from the schedule, and then frame transmission is carried out, with a reduced schedule cycle from which the CP is omitted, until the actual frame transmission timing returns to the frame transmission timing of the preset schedule.

In the example illustrated in FIG. 1, the CP of the schedule cycle 1 is extended by the EX time period. Accordingly, a timing at which the QoS CF-Poll frame (P1) 105 is transmitted to the QSTA1 delays by the EX time period. The delay detection section 19 detects the delay through the process of S6 and calculates the delay time in S7. Then, the timing control section 20 determines to omit CPs from schedule cycles 2 and 3 respectively so as to recover the delay.

Thus, the timing control section 20 omits the CP from the schedule cycle 2 of the preset schedule and transmits a QoS CF-Poll (P1) 109 after the end of the polled TXOP of the QSTA2 at the schedule cycle 2 so that a polled TXOP to be given at the subsequent schedule cycle 3 is immediately started. Further, also in the subsequent schedule cycle 3, the CP is omitted in the same manner. As a result, the delay is recovered in an actual schedule cycle 4, so that the actual schedule cycle and the preset schedule cycle are identical to each other.

As described above, the QAP 10 according to the present embodiment determines whether or not the actual schedule delays from the preset schedule. In case where the delay occurs, the QAP 10 omits the CP from the preset schedule cycle until the delay is recovered.

Thus, it is possible to synchronize the actual schedule with the preset schedule. That is, it is possible to synthesize the actual schedule with a power save schedule having been set by the QSTA in accordance with the preset schedule (in accordance with the SST and the SI received with it included in the ADDTS response frame). Thus, it is possible to suppress the drop of the power save efficiency which is caused by extension of the CP.

That is, according to the conventional technique, also in case where the CP is extended, a polled TXOP and a CP are provided, on the basis of a regular schedule (preset schedule), in each subsequent schedule as a single schedule cycle. However, according to the present embodiment, as illustrated as the actual schedule in FIG. 1, the polled TXOP is provided as scheduled but the CP is not provided in each of (i) the schedule cycle 2 in which the CP is extended and (ii) subsequent schedule cycles until the delay is recovered. It can be said that a schedule cycle after extension of the CP is reduced compared with a schedule cycle of the preset schedule.

For example, in the example illustrated in FIG. 1, a QoS CF-Poll frame (P2) 107 is transmitted so as to give the polled TXOP to the QSTA2, and the QAP 10 does not carry out any transmission so that the radio medium is idle for a period equal to or longer than the DIFS period after the end of the polled TXOP so as to provide the CP in the conventional technique. Thus, according to the conventional technique, the delay of the schedule in the schedule period 2 and the subsequent periods is not recovered.

However, according to the present embodiment, in order that a polled TXOP to be given at the subsequent schedule cycle 3 is started just after the end of the polled TXOP of the QSTA2 in the schedule cycle 2, a QoS CF-Poll frame (P1) 109 is transmitted. That is, the CP is not provided in the schedule cycle 2. Note that, the QAP 10 can start the frame transmission after waiting for a shorter time period than a QSTA which carries out the frame transmission in accordance with the DCF format as described above.

Also in the schedule cycle 3, the cycle shifts into the schedule cycle 4 without providing the CP, and a QoS CF-Poll frame (P1) 113 is transmitted. In the example illustrated in FIG. 1, the length of the EX period is twice as long as the CP provided in each schedule cycle in the preset schedule, so that the delay can be recovered by omitting the CP twice. Thus, the delay is recovered at the time when the schedule cycle 3 comes to an end. Therefore, in the schedule cycle 4 and subsequent cycles, the QAP 10 provides the CP as usual (as scheduled in the preset schedule).

In each of the QSTA1 and the QSTA2, such a process allows for reduction of a time period in which the QSTA is unnecessarily in the awake mode, and finally it is possible to save the power with the same efficiency as in a state in which the CP occurs.

Note that, in the present embodiment, the timing control section 20 omits the CP from each schedule cycle (provides no CP) until the delay of the schedule is recovered, but the present invention is not limited to this arrangement.

For example, it may be so arranged that each of the CPs provided until the delay is recovered is made shorter than the CP of the preset schedule. In this case, the QAP 10 (timing control section 20) does not transmit any frame so that frame transmission can be started to the QSTA based on the DCF format after the end of the last polled TXOP in the schedule cycle so as to temporarily start the CP. Further, if a time to start the next schedule cycle comes at the time when the frame transmission comes to an end, the QoS CF-Poll frame is transmitted. If the time to start the schedule cycle has not come yet, the QAP 10 waits for the QSTA to start the frame transmission without carrying out any transmission.

As a result, in case where the length of the CP of the preset schedule is longer than the length of the EX period for example, it is possible to recover the delay without omitting all the CPs. However, in this case (in case where the CP is not omitted), the CP may be further extended, so that it may be impossible to recover the delay depending on cases.

Further, it may be so arranged that a schedule cycle from which the CP is omitted and a schedule cycle in which the CP is made shorter are combined and the thus obtained combination is set. As a result, also in case where the extension EX is not equal to a number obtained by multiplying, with an integer, the length of the CP provided in each schedule cycle of the preset schedule for example, it is possible to synchronize the actual schedule with the preset schedule by adjusting how much the CP is reduced.

Further, it may be so arranged that: also during a period in which the delay occurs, schedule cycles each of which has a CP as long as the CP provided in the preset schedule are provided at a predetermined frequency. For example, it may be so arranged that: a schedule cycle from which the CP is omitted and a schedule cycle in which the CP is provided are alternately provided during a period in which the delay occurs. Further, it may be so arranged that: a schedule cycle in which the CP is provided is inserted into every plural timing cycles so that a period in which the CP is not provided is not continued over a predetermined period.

Further, in the present embodiment, the delay detection section 19 determines whether or not the CP is extended longer than scheduled, and calculates an extended time period in case where the CP is extended, and the timing control section 20 sets a schedule cycle, from which the CP is omitted, in accordance with the extended time period. However, the present invention is not limited to this arrangement. It may be so arranged that: as to each transmission frame from the QAP 10, an actual transmission timing and a transmission timing of the preset schedule are compared so as to determine whether any delay occurs or not, and a subsequent CP is omitted in case where it is determined that a delay occurs. Alternatively, it may be so arranged that: as to a predetermined transmission frame (e.g., a first transmission frame) in each schedule cycle, whether any delay from the preset schedule occurs or not is determined, and a subsequent CP is not provided in case where the delay occurs.

Further, instead of omitting the CP, it is possible to adopt a method in which a Polled TXOP is reduced or omitted until the delay of the schedule is recovered. As the Polled TXOP which should be omitted, it is preferable to select a Polled TXOP used to transmit less important data or used to transmit data less required to be processed at real time. Whether the data is less important or not or whether the data is less required to be processed at real time or not can be determined as follows: The QSTA informs the QAP of how its data is important or whether its data is required to be processed at real time or not by means of any packet, and the QAP carries out the determination in accordance with information indicative of how the data is important or whether the data is required to be processed at real time or not. Further, it may be so arranged that the QAP analyses content of the packet so as to carry out the determination. A header part of the packet generally includes a protocol to which the packet belongs and information concerning types of data included in the packet, so that it is possible to carry out the determination in accordance with the protocol and the information.

Further, in the example illustrated in FIG. 1, for simplification of illustrations, the SI of the QSTA1 and the SI of the QSTA2 are set to be the same, but the present invention is not limited to this. It may be so arranged that the QSTAs are different from each other in the length of the SI. Further, in the example illustrated in FIG. 1, spectrums respectively allocated to the QSTA1 and the QSTA2 are identical to each other in an amount thereof, but the present invention is not limited to this arrangement. It may be so arranged that the QSTAs are different from each other in the amount of the allocated spectrum. Further, in the example illustrated in FIG. 1, spectrums are allocated to two QSTAs, but the present invention is not limited to this arrangement as long as the number of QSTA(s) is one or more.

### (As to EOSP Field of QoS CF-Poll)

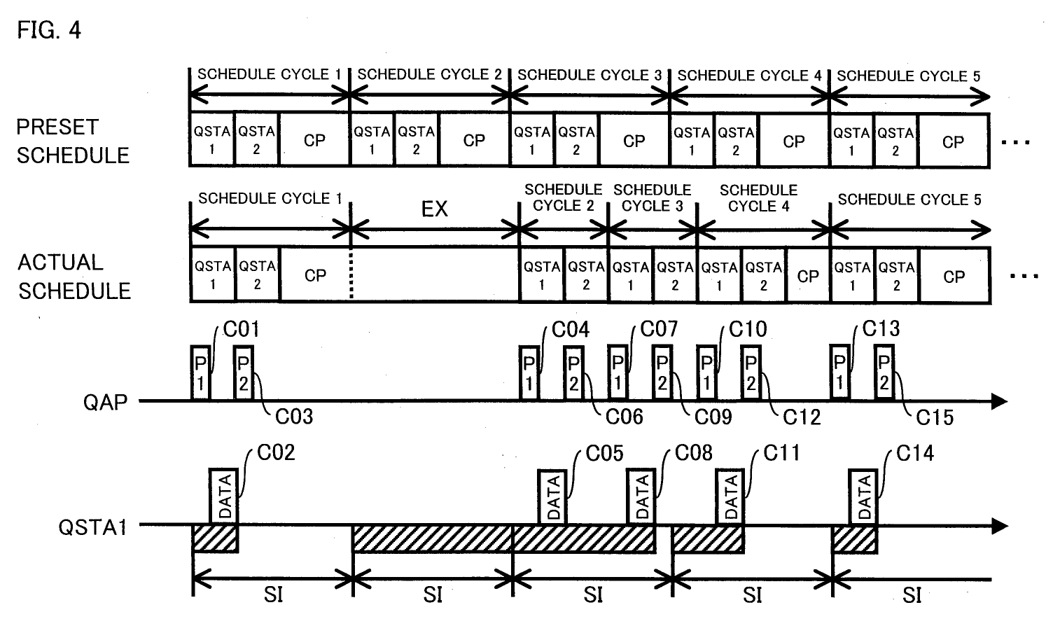

Note that, in the present embodiment, when the last CP is omitted from the schedule cycle and the polled TXOP is given to a single QSTA twice or more times in a single schedule cycle, it is necessary to be care of a value of an EOSP field. With reference to FIG. 4, descriptions thereof are given as follows. How to illustrate the diagram and abbreviated names are the same as in FIG. 1. Further, in FIG. 4, only operations of the QSTA1 are focused on and descriptions on operations of the QSTA2 and other QSTA are omitted.

In FIG. 4, a preset schedule for the spectrum allocation set by the QAP 10 (schedule setting section 18) is such that polled TXOPs each of which is about 20% of the schedule cycle are respectively given to the QSTA1 and the QSTA2 at every schedule cycle.

Further, the SI of the QSTA1 is as long as the schedule cycle, and the STS of the QSTA1 is set so that the polled TXOP of the QDTA1 is positioned at the beginning of the schedule cycle. The SI of the QSTA2 is as long as the schedule cycle, and the SST of the QSTA2 is set so that the polled TXOP for the QSTA2 is positioned behind the polled TXOP for the QSTA1 (this state is not shown).

In the CP of the schedule cycle 1, the CP is extended by a period indicated by EX. The QSTA1 is in the awake mode when the SI period passes after receiving a QoS CF-Poll frame C01, but the schedule cycle 2 is entirely occupied by the CP, so that the QSTA1 cannot receive any QoS CF-Poll and the QSTA1 remains in the awake mode from the beginning point of the schedule cycle 2 to the beginning point of the schedule cycle 3.

The QAP 10 (timing control section 20) transmits a QoS CF-Poll frame C04 to the QSTA1 at the time when extension of the CP comes to an end. At this time, the QSTA1 is in the awake mode, so that the QSTA1 receives the QoS CF-Poll frame C04 and transmits a data frame C05. Thereafter, the QAP 10 (timing control section 20) transmits a Qos CF-Poll frame C06 to the QSTA2 and then transmits a QoS CF-Poll frame C07. This transmission is carried out within the same SP (Service Period) as in the QoS CF-Poll frame C04. In case where the EOSP field is set to 1 in the QoS CF-Poll frame C04, the QSTA1 determines that any frame is not transmitted from the QAP 10 until the beginning point of the subsequent SP, so that the QSTA1 shifts into the power save mode. As a result, the QSTA1 cannot receive the QoS CF-Poll frame C07, so that the QAP 10 has to wait for transmission of a subsequent QoS CF-Poll frame until the QSTA1 shifts into the awake mode again. That is, sequential transmission of QoS CF-Poll frames prevents recovery from the delay caused by the extension of the CP.

In the present embodiment, in case where the QAP 10 (timing control section 20) is about to transmit the QoS CF-Poll frame C04 to a QSTA and is to transmit the QoS CF-Poll frame again in the same SP of the foregoing QSTA at the same time, the QAP 10 transmits the frame after setting the EOSP field to 0, and if there is no schedule to transmit the QoS CF-Poll frame in the same SP, the EOSP field is set to 1. That is, the QAP 10 (timing control section 20) determines whether or not to transmit the QoS CF-Poll frame to the same QSTA in the same SP plural times, and if the QAP 10 determines not to transmit the frame plural times, the EOS field is set to 1, and if the QAP 10 determines to transmit the frame plural times, the EOSP field is set to 1 with respect only to the lastly transmitted QoS CF-Poll frame (the EOSP field is set to 0 with respect to other QoS CF-Poll frames). Thus, in the example illustrated in FIG. 4, the EOSP field in the QoS CF-Poll frame C04 is set to 0, and the EOSP field in the QoS CF-Poll frame C07 is set to 0.

In response to the QoS CF-Poll frame C04, the QSTA1 transmits a data frame C05, but the EOSP field in the QoS CF-Poll frame C04 is set to 0, so that the QSTA1 does not shift into the power save mode. Further, the QSTA1 receives the QoS CF-Poll frame C07 in the same SP and transmits the data frame C08. According to the above-mentioned determination process, the EOSP field in the QoS CF-Poll frame C07 is set to 1, so that the QSTA1 shifts into the power save mode after transmitting the data frame C08.

Also thereafter, the delay in the spectrum allocation schedule is not recovered, so that the QAP 10 omits the CP and transmits the QoS CF-Poll frame C10, and the QSTA1 having received the QoS CF-Poll frame C10 transmits a data frame C11. According to the above-mentioned determination process, the EOSP field in the QoS CF-Poll frame C10 is set to 1, so that the QSTA1 shifts into the power save mode after transmitting the data frame C08.

Thereafter, the delay in the spectrum allocation schedule after the schedule cycle 5 is recovered, so that the spectrum allocation is carried out as scheduled.

In this manner, in the present embodiment, it is possible to sequentially transmit two or more QoS CF-Poll frames in a single SP, so that it is possible to more quickly recover the delay in the spectrum allocation schedule which is caused by the extension of the CP.

Note that, in case where QoS CF-Poll frames are sequentially transmitted for simplification of processes so as to recover the delay of the CP, it may be so arranged that the ESOP field is always kept to 0 in transmitting the frames.

### Embodiment 2

Another embodiment of the present invention is described as follows. Note that, for convenience in descriptions, the same reference signs are given to members having the same arrangements and functions as those of the QAP 10 according to Embodiment 1, and descriptions thereof are omitted.

An arrangement of a QAP 10 according to the present embodiment is substantially the same as in Embodiment 1. Further, as in Embodiment 0.1, the QAP 10 according to the present embodiment is used in a network which allows communications on the basis of IEEE 802.11e standard. However, when a schedule setting section 18 is to set a preset schedule, a schedule cycle in which any spectrum is not allocated to each QSTA is periodically provided. This is a difference from Embodiment 1. In the QAP 10 according to the present embodiment, when the schedule delays, the schedule cycle in which any spectrum is not allocated to each QSTA is reduced in its length or is omitted, thereby recovering the delay.

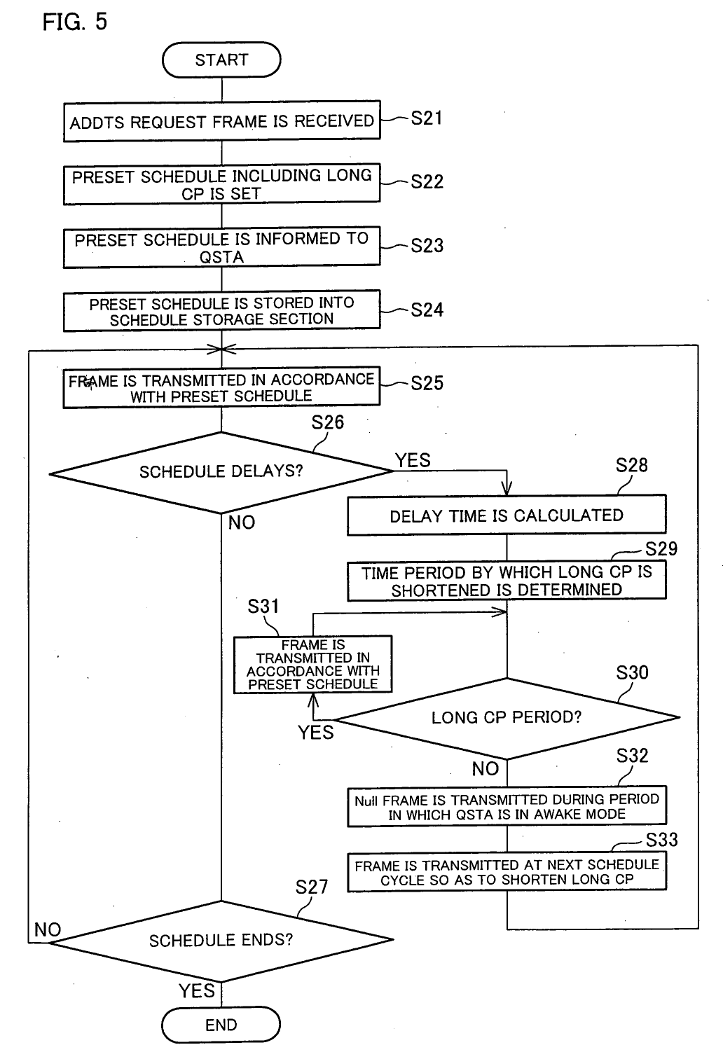

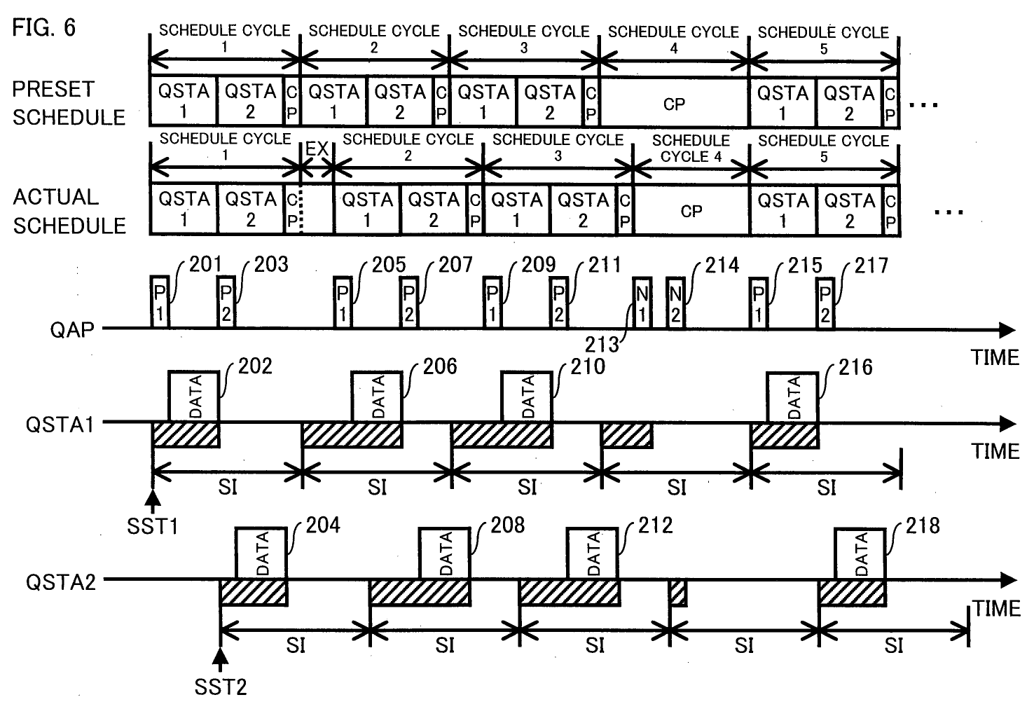

FIG. 5 is a flowchart illustrating a flow of processes carried out by the QAP 10. FIG. 6 is an example of a timing chart in the network managed by the QAP 10. Note that, how to illustrate the diagram and abbreviated names are substantially the same as in FIG. 1. In FIG. 6, each of a square named N1 (reference sign: 213) and a square named N2 (reference sign: 214) which are above a temporal axis of the QAP indicates a QoS Null frame. N1 indicates a QoS Null frame addressed to a QSTA1, and N2 indicates a QoS CF-Poll frame addressed to a QSTA2. The QoS CF-Null frame will be detailed later.

As illustrated in FIG. 5, in response to an ADDTS request frame from a QSTA (S21), the QAP 10 determines whether or not to acknowledge spectrum allocation in accordance with a TSPEC or the like included in the frame (in FIG. 5, the spectrum allocation is acknowledged). Note that, the TSPEC is an information group indicative of specifications of a data group to be transmitted and includes information or the like which is indicative of how many times the data is to be transmitted and how long the data is.

Next, the schedule setting section 18 (spectrum management section 15) sets a schedule (preset schedule) to allocate spectrums to QSTAs respectively in accordance with the TSPEC (S22). At this time, the schedule setting section 18 periodically provides a schedule cycle in which any spectrum is not allocated to each QSTA (the schedule cycle is referred to as “long CP”: adjustment period). That is, the schedule setting section 18 sets the preset schedule including the long CP.

In an example of the preset schedule indicated at a top raw of FIG. 6, polled TXOPs each of which is about 40% of a schedule cycle are respectively given to the QSTA1 and the QSTA2 in each schedule cycle. Further, in a schedule cycle 4, there is provided the long CP in which any spectrum is not allocated to each QSTA. Thus, the example illustrated in FIG. 6 shows that: in an actual schedule, the QAP 10 does not transmit any QoS CF-Poll frame to the QSTA1 during a period from a time to finish allocating a spectrum to the QSTA2 in the schedule cycle 3 (after the QSTA2 transmits a data frame 212) to a beginning point of the schedule cycle 5. In this schedule cycle 4 (long CP), each QSTA can transmit data on the basis of the DCF format.

Note that, in this example, an SI (Service Interval) of the QSTA1 is as long as the schedule cycle (SI), and a polled TXOP for the QSTA1 is positioned at a beginning point of the schedule cycle, and an SST (Service Start Time) of the QSTA1 is a time corresponding to the beginning point of the schedule cycle (SST1).

Further, an SI of the QSTA2 is as long as the schedule cycle (SI), and a polled TXOP for the QSTA2 is positioned after the polled TXOP for the QSTA1, and an SST of the QSTA2 begins at a time calculated by adding, to the beginning point of the schedule cycle, a length of a period (P1) for transmitting the QoS CF-Poll frame to the QSTA1 and the length of the polled TXOP (SST2).

Further, a CP is provided after transmitting a data frame of the QSTA2 in each schedule cycle.

In case where the CP occurs, a transmission right giving period of each QSTA is managed in accordance with the preset schedule.

After setting the preset schedule in S22, the schedule setting section 18 informs the preset schedule, having been set, to the QSTA as an ADDTS response frame (S23). Specifically, each QSTA is informed of a corresponding SST and a corresponding SI. Note that, in FIG. 6, illustrations are partially omitted on the assumption that transmission and reception of the ADDST request frame and the ADDTS response frame have been completed.

Further, a storage control section 16 stores the preset schedule, having been set by the schedule setting section 18, into a schedule storage section 13 (S24).

Thereafter, a timing control section 20 transmits a frame (QoS CF-Poll frame) to each QSTA in accordance with the preset schedule having been set by the schedule setting section 18 (S25).

Further, a delay detection section 19 compares the preset schedule with an actual schedule so as to determine whether any delay occurs or not (S26).

Further, in case where it is determined that no delay occurs in S26, the timing control section 20 determines whether the preset schedule has been entirely executed or not (S27). Further, in case where the preset schedule has not been executed, the process of S25 is subsequently carried out so as to continue the frame transmission in accordance with the preset schedule. Further, in case where it is determined that the preset schedule has been executed, the QAP 10 finishes the process.

While, in case where it is determined that a delay occurs in S6, the delay detection section 19 calculates a delay time (S28), and informs the calculated delay time to the timing control section 20.

The timing control section 20 determines a time, in which the long CP is shortened so as to recover the delay, in accordance with the delay time having been calculated by the delay detection section 19 (S29). That is, the timing control section 20 determines the length of the schedule cycle, having been set in the long CP of the actual schedule, so as to shorten the long CP of the preset schedule by an EX time period whose length is equal to the length of the extended CP.

Further, the timing control section 20 determines whether the current schedule is identical to a schedule cycle having set in the long CP or not (S30). Further, in case where it is determined that the current schedule is not identical to the schedule cycle having set in the long CP, the timing control section 20 continues the spectrum allocation based on the preset schedule (S31). That is, the timing control section 20 continues to allocate a spectrum to each QSTA at the schedule cycle based on the preset schedule until the schedule cycle having been set in the long CP starts.

Thus, in the example illustrated in FIG. 6, the QAP 10 continues the spectrum allocation in the schedule cycles 2 and 3, each of which includes a polled TXOP for the QSTA1, a polled TXOP for the QSTA2, and a CP, in accordance with the preset schedule also after extension of the CP.

In more detail, in the schedule cycle 2, a QoS CF-Poll (P1) 205 is transmitted to the QSTA1 after the extended CP comes to an end. The QSTA1 is in the awake mode at the time when the SI passes from the SST1 and transmits a data frame 206 upon receiving the QoS CF-Poll (P1) 205. Further, the QAP 10 transmits a QoS CF-Poll (P2) 207 to the QSTA2. The QSTA2 is in the awake mode when the SI passes from the SST2 and transmits a data frame 208 upon receiving the QoS CF-Poll (P2) 207. Further, the QAP 10 does not transmit any frame thereafter so as to provide the CP and transmits a QoS CF-Poll (P1) 209 when a scheduled time to bring the CP to an end comes. Note that, for simplification, descriptions are given on the assumption that the CP is not extended.

Also in the schedule cycle 3, a polled TXOP for the QSTA1 and a polled TXOP for the QSTA2 are provided. That is, even if a delay occurs in the schedule, the frame transmission is continued in the schedule cycles 2 and 3 with the schedule delayed.

While, in case where it is determined that the schedule is identical to the schedule cycle having set in the long CP in S30, the timing control section 20 transmits a QoS CF-Null frame to the QSTA being in the awake mode (S32). A format of the QoS CF-Null frame is the same as that of a data frame but includes no data. The QoS CF-Null frame has the same format as that of the data frame, so that the QoS CF-Null frame includes an EOSP field. This is used for the QAP 10 to inform the QSTA of the EOSP field. Thus, the QSTA having received the QoS CF-Null frame can shift into the power save mode.

In more detail, the QAP 10 can determine whether each QSTA is currently in the awake mode or not in accordance with (i) information of the SST and the SI informed to each QSTA as the ADDTS response frame and (ii) information of a timing at which the QAP 10 transmits to each QSTA a frame with EOSP being set to 1.

For example, in the example illustrated in FIG. 6, the QAP 10 can find that the QSTA1 is in the awake mode at the time when the schedule cycle 3 of the actual schedule comes to an end. Further, a QoS CF-Poll frame is scheduled to be transmitted to the QSTA1 in the schedule cycle 5, so that the QAP 10 can find also that the QSTA1 may be in the power save mode till then. That is, it is possible to find that the QSTA1 is unnecessarily in the awake mode.

However, unless the QAP 10 transmits the EOSP field (EOSP=1), the QSTA1 cannot shift into the power save mode. Thus, the QAP 10 transmits a QoS CF-Null frame to the QSTA1 with EOSP being set to 1. The QSTA1 having received the QoS CF-Null frame can immediately shift into the power save mode. Further, the long CP is shortened as will be described later, so that the delay at the beginning point of the schedule cycle 5 is recovered, and the preset schedule and the actual schedule are synchronized with each other. As a result, the QSTA1 can shift into the awake mode at a time for the QAP to subsequently transmit the QoS CF-Poll frame (P1) 215 (this time is calculated in accordance with the SST1 and the SI).

Note that, in the example illustrated in FIG. 6, the QAP 10 (timing control section 20) transmits a QoS Null frame 213 to the QSTA1 at the beginning point of the schedule cycle 4 (at the beginning point of the long CP). That is, in the present embodiment, the QAP 10 is set so as to transmit a frame as scheduled in the preset schedule except for the schedule cycle having set in the CP even if the CP is extended, so that the delay is not recovered at the beginning point of the long CP and the QoS Null frame can be transmitted to the QSTA1 only at the time when the previous schedule cycle 3 comes to an end. Thus, the QSTA1 receives the QoS Null frame some time after shifting into the awake mode. In contrast, the QAP 10 transmits the QoS Null frame to the QSTA2 immediately after the time for the QSTA2 to shift into the awake mode. Thus, the QSTA2 is unnecessarily in the awake mode for a period shorter than that in the QSTA1. In this manner, earlier transmission of the QoS Null frame allows the power to be saved more efficiently. However, the QoS Null frame has to be transmitted after the QSTA shifts into the awake mode.

Thereafter, the QAP 10 (timing control section 20) transmits a QoS CF-Poll (P1) 215 to the QSTA1 when the beginning point of the schedule cycle 5 of the preset schedule comes (S32). That is, when the beginning point of the schedule cycle 5 of the preset schedule comes, the QAP 10 transmits the QoS CF-Poll (P1) 215 to the QSTA1 and shorten the schedule cycle 4 having been set in the long CP, so as to synchronize the actual schedule with the preset schedule. As described above, the QAP 10 can start the frame transmission with a shorter waiting time than that in the QSTA transmitting a frame on the basis of the DCF format.

Further, after synchronizing the preset schedule by carrying out the process of S32, the process of S25 is carried out again.

As a result, in the schedule cycle 5 and subsequent cycles, the QoS CF-Poll frame can be transmitted as scheduled in the preset schedule, and each of the QSTA1 and the QSTA2 determines a power save schedule corresponding to the preset schedule, so that the spectrum allocation schedule in the QAP 10 and the power save schedule in the QSTA are synchronized with each other again. As a result, the QSTA can save the power with the same efficiency as that before occurrence of the CP.

As described above, when setting the preset schedule, the QAP 10 according to the present embodiment periodically provides a schedule cycle (long CP) in which any spectrum is not allocated to each QSTA. Further, the QAP 10 determines whether the actual schedule delays from the preset schedule or not, and if the actual schedule delays, the QAP 10 shortens the long CP, thereby recovering the delay.

As a result, the actual schedule and the preset schedule can be synchronized with each other. That is, the actual schedule can be synchronized with the power save schedule which has been set by the QSTA in accordance with the preset schedule (in accordance with the SST and the SI that have been received as the ADDTS response frame). Thus, it is possible to suppress the drop of the power save efficiency which is caused by extension of the CP.

Note that, data transmitted in the polled TXOP is stream data which is registered from the QSTA by the ADDTS request frame, and the data is generally data of a moving image or the like which is required to be processed at real time. Thus, if the polled TXOP is reduced to be shorter than scheduled, there occurs a trouble such as disorder or the like of the moving image on the receiving side. While, basically data transmitted in the CP is sporadically transmitted, and a frequency of the transmission is not so high. Thus, if the long CP is reduced, this has little influence on the transmission.

Further, the QAP 10 according to the present embodiment transmits a QoS Null frame, whose EOSP is 1 to a QSTA having shifted in the awake mode in the long CP, so as to shift into the power save mode. As a result, it is possible to more appropriately prevent the drop of the power save efficiency.

Note that, in the present embodiment, the QoS Null frame is transmitted so that each QSTA shifts into the power save mode in the long CP, but the present invention is not limited to this. Any frame may be transmitted as long as the frame indicates that a transmission right is not given to each QSTA (any spectrum is not allocated to each QSTA). Specifically, any frame may be used as long as the frame includes the EOSP field. For example, a data frame or a QoS CF-Poll frame which is addressed to the QSTA may be transmitted. In case of transmitting the QoS CF-Poll frame, the polled TXOP period may be zero. Further, each QSTA is shifted into the power save mode during the long CP, so that it is possible to improve the power save efficiency. However, it is not necessary to shift each QSTA into the power save mode during the long CP. In this case, the frame including the EOSP field does not have to be transmitted from the QAP 10 to the QSTA during the long CP. Further, only some of the QSTAs may be shifted into the power save mode during the long CP.

### (As to a Length of the Long CP and how Many Times the Long CP Occurs)

In the example illustrated in FIG. 6, a schedule cycle having been set in the long CP of the preset schedule is as long as other schedule cycle, but the present invention is not limited to this. However, in case where the schedule cycle including the long CP is not equal to a number obtained by multiplying, with an integer, the schedule cycle, it is impossible to synchronize the schedule cycle with the SI having been informed to the QSTA in the preset schedule. Thus, the length of the long CP has to be a length calculated by integrating an integer other than 0 with other schedule cycle. As long as such a condition is satisfied, the long CP has any length. Note that, the long CP may have the same length every time it appears or may be suitably changed every time the QAP 10 sets the preset schedule.

FIG. 6 illustrates only one schedule cycle including the long CP, but this schedule cycle is scheduled so as to appear periodically. That is, the schedule cycle including the long CP is provided once in every plural schedule cycles. The schedule cycle including the long CP may have any length. Further, the long CP does not have to be periodically generated, and the long CP may be provided when the QAP 10 determines it necessary to provide the long CP. However, it is possible to more easily carry out adjustment with respect to the polled TXOP given to the QSTA by periodically generating the long CP.

If a single long CP is made longer or the long CP is generated more frequently, it is easier to recover the delay in case where there is increased the number of times the CP is extended, but there is decreased a time in which the polled TXOP is provided, so that a spectrum is compressed. How long the long CP is to be and how many time the long CP is to be provided are suitably determined by the QAP 10 in accordance with (i) the number of streams or a data rate thereof which are defined in the ADDTS, (ii) the number of QSTAs or a data rate thereof, (iii) or the like.

In the schedule cycle including the long CP, the polled TXOP cannot be provided, so that the number of spectrums which can be allocated decreases. However, the decrement of the spectrums can be adjusted by making the polled TXOP of other schedule cycle longer or by carrying out a similar operation.

Further, for simplification of illustration, FIG. 6 illustrates the state in which the CP is extended only in the schedule cycle 1. In case where the CP is subsequently extended before occurrence of the long CP, the long CP is further shortened so that the cumulatively extended time is recovered, thereby recovering the delay. Note that, in case where a single long CP fails to recover the delay due to repetitive extension of the CP or a similar trouble, that is, in case where the cumulatively extended time exceeds the long CP, it may be so arranged that a plurality of long CPs recover the delay.

Further, it is possible to adopt a combination of (i) the arrangement of Embodiment 1, i.e., the arrangement in which the CP of each schedule cycle is omitted or shortened if the schedule delays and (ii) the arrangement of the present embodiment, i.e., the arrangement in which the length of the long CP is adjusted so as to recover the delay.

Further, the long CP may be extended just before the end of the long CP. In this case, it is possible to adopt the combination of Embodiment 1 and Embodiment 2 so as to recover the delay, or it is possible to adopt a method in which a plurality of long CPs are shortened so as to recover the delay.

Further, in the present embodiment, the QSTA1 and the QSTA2 are the same in the SI for simplification, but the present invention is not limited to this, and the QSTAs may be different from each other in the SI. Further, the QSTA1 and the QSTA2 are the same in an amount of the allocated spectrum, but an amount of the spectrum allocated to the QSTA1 and an amount of the spectrum allocated to the QSTA2 may be different from each other. Further, in the present embodiment, spectrums are allocated to two QSTAs respectively, but the present invention is not limited to this, and one or more QSTAs may be used.

### Embodiment 3

Another embodiment of the present invention is described as follows. Note that, for convenience in descriptions, the same reference signs are given to members having the same arrangements and functions as those of the QAP 10 according to Embodiments 1 and 2, and descriptions thereof are omitted.

An arrangement of a QAP 10 according to the present embodiment is substantially the same as in Embodiments 1 and 2. Further, as in Embodiments 1 and 2, the QAP 10 according to the present embodiment is used in a network which allows communications on the basis of IEEE 802.11e standard. However, when an actual schedule deviates from a preset schedule, a schedule setting section 18 updates the preset schedule so as to correspond to the actual schedule and transmits a frame for informing the updated schedule to each QSTA. This is a difference from Embodiments 1 and 2. Thus, each QSTA readjusts the power save schedule so as to correspond to a spectrum allocation schedule having been updated by the QAP 10, thereby correcting the deviation therebetween. As a result, the power can be efficiently saved.

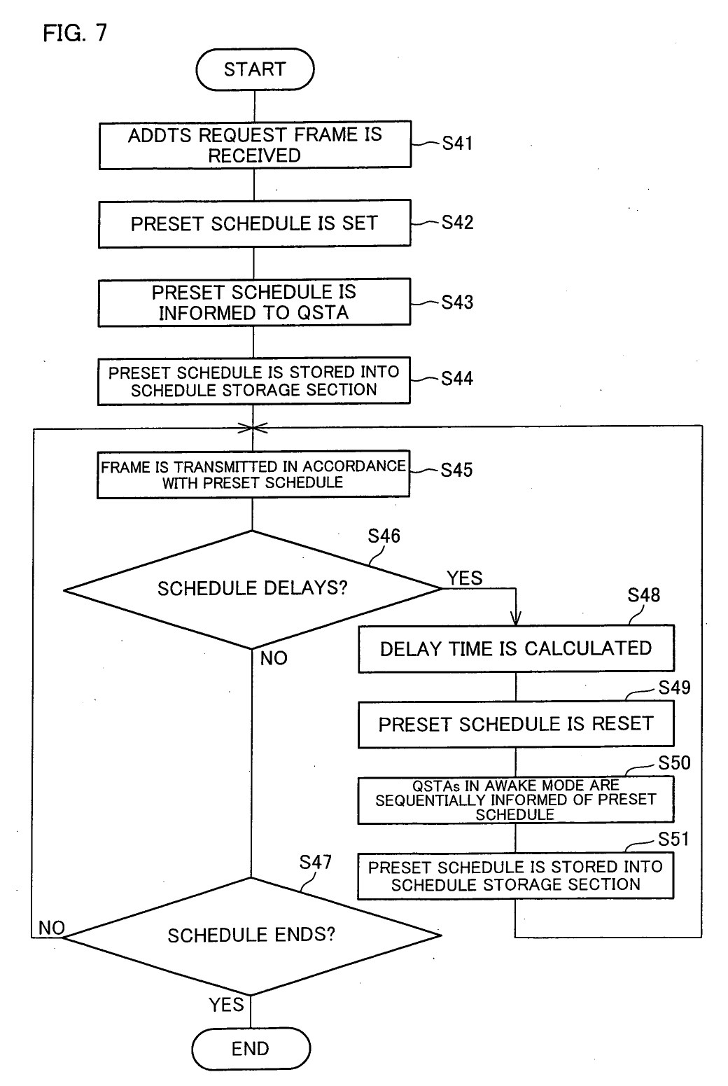

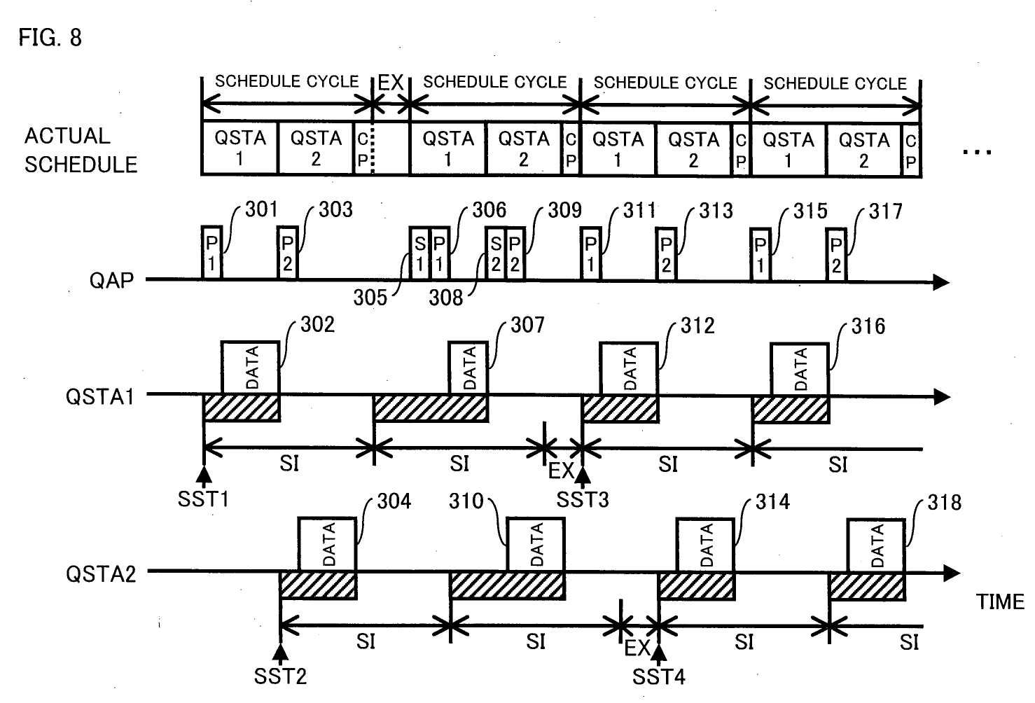

FIG. 7 is a flowchart illustrating a flow of processes carried out by the QAP 10 according to the present embodiment. FIG. 8 is an example of a timing chart in the network managed by the QAP 10. Note that, how to illustrate the diagram and abbreviated names are substantially the same as in FIG. 1 and FIG. 6. In FIG. 8, each of a square named S1 (reference sign: 305) and a square named S2 (reference sign: 308) which are above a temporal axis of the QAP indicates a Schedule frame. S1 indicates a Schedule frame addressed to a QSTA1, and S2 indicates a Schedule frame addressed to a QSTA2. The Schedule frame will be detailed later.

As illustrated in FIG. 7, in response to an ADDTS request frame from a QSTA (S41), the QAP 10 determines whether or not to acknowledge spectrum allocation in accordance with a TSPEC or the like included in the frame (in FIG. 7, the spectrum allocation is acknowledged). Note that, the TSPEC is an information group indicative of specifications of a data group to be transmitted and includes information or the like which is indicative of how many times the data is to be transmitted and how long the data is.

Next, the schedule setting section 18 (spectrum management section 15) sets a schedule (preset schedule) to allocate spectrums to QSTA respectively in accordance with the TSPEC (S42).

In an example of the preset schedule indicated at a top raw of FIG. 8, polled TXOPs each of which is about 40% of a schedule cycle are respectively given to the QSTA1 and the QSTA2 in each schedule cycle.

Note that, in this example, an SI (Service Interval) of the QSTA1 is as long as the schedule cycle (SI), and a polled TXOP for the QSTA1 is positioned at a beginning point of the schedule cycle, and an SST (Service Start Time) of the QSTA1 is a time corresponding to the beginning point of the schedule cycle (SST1).

Further, an SI of the QSTA2 is as long as the schedule cycle (SI), and a polled TXOP for the QSTA2 is positioned after the polled TXOP for the QSTA1, and an SST of the QSTA2 begins at a time calculated by adding, to the beginning point of the schedule cycle, a length of a period (P1) for transmitting the QoS CF-Poll frame to the QSTA1 and the length of the polled TXOP (SST2).

Further, a CP is provided after transmitting a data frame of the QSTA2 in each schedule cycle.

In case where the CP is not extended, a transmission right giving period of each QSTA is managed in accordance with the preset schedule.

After setting the preset schedule in S42, the schedule setting section 18 informs the preset schedule, having been set, to the QSTA as an ADDTS response frame (S43). Specifically, each QSTA is informed of a corresponding SST and a corresponding SI. Note that, in FIG. 8, illustrations are partially omitted on the assumption that transmission and reception of the ADDST request frame and the ADDTS response frame have been completed.

Further, a storage control section 16 stores the preset schedule, having been set by the schedule setting section 18, into a schedule storage section 13 (S44).

Thereafter, a timing control section 20 transmits a frame (QoS CF-Poll frame) to each QSTA in accordance with the preset schedule having been set by the schedule setting section 18 (S45).

Further, a delay detection section 19 compares the preset schedule with an actual schedule so as to determine whether any delay occurs or not (S46).

Further, in case where it is determined that no delay occurs in S46, the timing control section 20 determines whether the preset schedule has been entirely executed or not (S47). Further, in case where the preset schedule has not been executed, the process of S45 is subsequently carried out so as to continue the frame transmission in accordance with the preset schedule. Further, in case where it is determined that the preset schedule has been executed, the QAP 10 finishes the process.

While, in case where it is determined that a delay occurs in S46, the delay detection section 19 calculates a delay time (S48), and informs the calculated delay time to the schedule setting section 18. Note that, the QAP 10 senses the medium also in the CP, so that it is possible to detect a time to bring the CP to an end. Thus, the EX time period indicative of how long the PC is extended from the scheduled time to bring the CP to an end can be calculated.

The schedule setting section 18 resets (updates) the preset schedule in accordance with the delay time calculated by the delay detection section 19 and the preset schedule stored in the schedule storage section 13 (S49).

Further, the timing control section 20 sequentially informs the QSTAs, each of which is in the awake mode, of the preset schedule having been reset in S49 (S50). Specifically, the timing control section 20 determines whether each QSTA is currently in the awake mode or not in accordance with information (the preset schedule stored in the schedule storage section 13) of the SST and the SI informed to each QSTA as the ADDTS response frame and information of a timing at which the QSTA 10 transmitted a frame whose EOSP is 1. Further, in order to inform the QSTA which is in the awake mode of the updated preset schedule, the QAP 10 transmits a Schedule frame. Note that, as described above, the QAP 10 can start the frame transmission with a shorter waiting time than the QSTA which transmits a frame on the basis of the DCF format. According to the conventional technique, the QoS CF-Poll is transmitted here, but in the present embodiment, the Schedule frame is transmitted before transmitting the QoS CF-Poll frame.

The Schedule frame is a frame used for the QAP 10 to inform the QSTA of the SST and the SI. The QAP 10 can transmit the frame at any timing, and the QSTA having received this frame updates the SST and the SI as informed with the ADDTS response frame. Note that, this frame has no EOSP field, so that the QSTA does not shift into the power save mode even when the QSTA receives this frame.

In FIG. 8, after the extended CP comes to an end, the QAP 10 transmits a Schedule frame 305 to the QSTA1. In this frame, a scheduled time (SST3) for the QAP 10 to transmit a QoS CF-Poll frame (309) of a subsequent schedule cycle to the QSTA1 is specified as the SST, and the same SI as it was is specified as the SI, and then the frame is transmitted. The SST3 can be calculated by adding the SI and the EX to a scheduled time to end the CP (=a scheduled time to transmit the QoS CF-Poll frame to the QSTA1).

At this time, the QSTA1 is in the awake mode, so that the QSTA1 receives the Schedule frame and resets the SST thereof. That is, the QSTA1 changes a time, in which the QSTA1 itself has to be subsequently in the awake mode, to the SST3.

Further, the QAP 10 transmits the QoS CF-Poll frame 306 to the QSTA1. In this frame, the EOSP field is set to 1 as in the conventional technique. The Schedule frame 305 has no EOSP field, so that the QSTA1 does not shift into the power save mode even when the QSTA1 receives this frame. Thus, upon receiving the QoS CF-Poll frame 306, the QSTA1 recognizes that the frame transmission of the QAP has ended.

Thereafter, the QSTA1 shifts into the power save mode after transmitting a data frame 307. Note that, as in the above-mentioned embodiments, a plurality of data frames 307 may be transmitted here.

When the SST is updated to the SST3, the QSTA1 shifts into the awake mode. Further, also after transmitting the QoS CF-Poll frame 306, the QAP 10 gives a polled TXOP to the QDTA2 as originally scheduled so as to provide the CP, and then the QAP 10 transmits the QoS CF-Poll frame 309 to the QSTA1 again.

According to the conventional technique, the SST is not corrected on the basis of the Schedule frame, so that a delay occurs in a period from a time when the QSTA1 becomes in the awake mode to a time when the QoS CF-Poll frame is transmitted. Unlike this arrangement, in the present embodiment, the SST in the QSTA1 is updated, so that no delay occurs in a period from a time when the QSTA1 becomes in the awake mode to a time when the QoS CF-Poll frame is transmitted. Thus, the QSTA1 has to be in the awake mode only for a minimum time period, so that the power can be saved more efficiently than the conventional technique.

Note that, in case where the CP is continuously extended, the Schedule frame is transmitted every time the CP is extended, thereby recovering the deviation. Alternatively, it may be so arranged that the Schedule frame is transmitted at the time when the deviation is accumulated to some extent, thereby integrally recovering the accumulated deviation.

Likewise, the QAP transmits the Schedule frame 308 also to the QSTA2 before transmitting the QoS CF-Poll frame 309. In this frame, a scheduled time (SST4) for the QAP 10 to transmit a QoS CF-Poll frame 311 of a subsequent schedule cycle to the QSTA2 is specified as the SST, and the same SI as it was is specified as the SI.

The QSTA2 having received this frame updates a time, in which the QSTA2 has to be subsequently in the awake mode, to the SST4. Further, the QSTA2 shifts into the power save mode after transmitting a data frame 310, and when the SST is updated to the SST4, the QSTA2 shifts into the awake mode. Thus, when the SST is updated to the SST4, the QSTA2 can immediately receive the QoS CF-Poll frame 313, so that the QSTA2 does not unnecessarily shift into the awake mode. As a result, the power can be saved more efficiently.

Note that, in FIG. 8, for convenience in illustration, the transmission time period of the data frame 307 in the QSTA1 seems to be shortened, but the transmission time period is hardly shortened in actual since the length of the Schedule frame 305 is much shorter than the transmission time period of the data frame 307. Further, it may be so arranged that a time period taken to transmit the Schedule frame 305 is calculated in advance and the calculated time period is added in calculating the SST3. This is applicable also to a relation between the data frame 309 and the Schedule frame 308 in the QSTA2.

Further, the schedule setting section 18 causes the storage control section 16 to store the preset schedule, having reset in S49, into the schedule storage section 13 (S51). Further, the process of S45 and subsequent processes are carried out in accordance with the updated preset schedule.

As described above, when the actual schedule delays from the preset schedule, the QAP 10 according to the present embodiment resets the preset schedule in accordance with the delay time, and informs the reset schedule (SST, SI) to each QSTA. As a result, each QSTA can set the power save schedule in accordance with the preset schedule having been reset in consideration for the delay time. Thus, also in case where extension of the CP causes the actual schedule to delay, it is possible to suppress the drop of the power save efficiency in the QSTA.

Further, in the above description, it was explained that the extension of the CP causes the spectrum allocation schedule in the QAP 10 to deviate from the power save schedule in the QSTA. However, also in case where other factor causes the deviation, it is possible to correct the power save schedule of the QSTA by using the Schedule frame.

An example thereof is a case where a QSTA transmitting a QoS CF-Poll frame in accordance with the schedule brings transmission of a stream to an end. At this time, upon receiving a DELTS request frame from the QSTA, the QAP 10 deletes the stream from the schedule.

In such case, it is necessary to change a position of the polled TXOP in the schedule cycle, so that the spectrum allocation schedule and the power save schedule may deviate from each other. Also in such case, by transmitting the preset schedule having reset by the schedule setting section 18 to the QSTA as the Schedule frame, it is possible to synchronize the power save schedule in the QSTA with the actual schedule (spectrum allocation schedule).

Further, in the present embodiment, the QSTA1 and the QSTA2 are the same in the SI for simplification, but the present invention is not limited to this, and the QSTAs may be different from each other in the SI. Further, the QSTA1 and the QSTA2 are the same in an amount of the allocated spectrum, but an amount of the spectrum allocated to the QSTA1 and an amount of the spectrum allocated to the QSTA2 may be different from each other. Further, in the present embodiment, spectrums are allocated to two QSTAs respectively, but the present invention is not limited to this, and one or more QSTAs may be used.

### Embodiment 4

Still another embodiment of the present invention is described as follows. Note that, for convenience in descriptions, the same reference signs are given to members having the same arrangements and functions as those of the QAP 10 according to Embodiments 1 to 3, and descriptions thereof are omitted.

An arrangement of a QAP 10 according to the present embodiment is substantially the same as in Embodiments 1 to 3. Further, as in Embodiments 1 to 3, the QAP 10 according to the present embodiment is used in a network which allows communications on the basis of IEEE 802.11e standard. However, in setting the preset schedule, the schedule setting section 18 sets an SST and an SI of each QSTA so that the QSTA shifts into the awake mode at the beginning point (start point) of each schedule cycle. As a result, in the present embodiment, in case where a polled TXOP given to a certain QSTA is returned earlier than scheduled, a polled TXOP can be sequentially given to another QSTA, so that a CP does not occur between two polled TXOPs in the same schedule cycle.

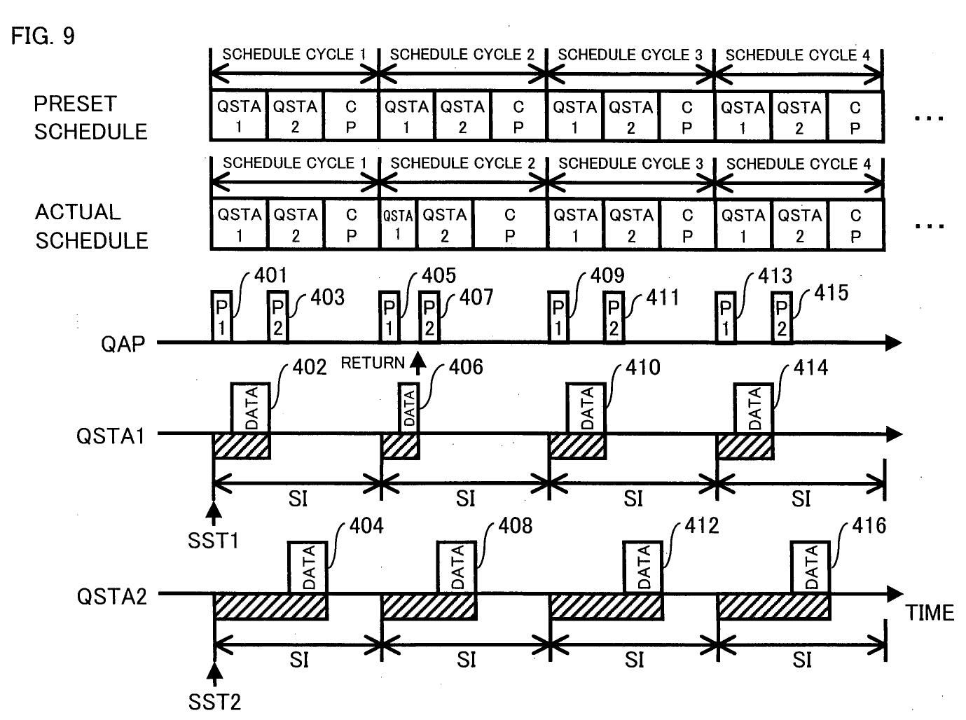

FIG. 9 is an example of a timing chart in the network managed by the QAP 10. How to illustrate the diagram and abbreviated names are substantially the same as in FIG. 1. Note that, descriptions on operations of other QSTAs are omitted.

In an example illustrated in FIG. 9, a spectrum allocation schedule in the QAP 10 is such that polled TXOPs each of which is about 30% of each schedule cycle are respectively given to the QSTA1 and the QSTA2 at every schedule cycle.

Further, an SI (Service Interval) of the QSTA1 is as long as the schedule cycle (SI), and a polled TXOP for the QSTA1 is positioned at a beginning point of the schedule cycle, and an SST (Service Start Time) of the QSTA1 is a time corresponding to the beginning point of the schedule cycle (SST1).

Further, an SI of the QSTA2 is as long as the schedule cycle (SI), and a polled TXOP for the QSTA2 is positioned after the polled TXOP for the QSTA1, so that the SST conventionally begins at a time calculated by adding, to the beginning point of the schedule cycle, a length of a period for transmitting a QoS CF-Poll frame to the QSTA1 and the length of the polled TXOP. While, the present embodiment is characterized in that the SST of the QSTA2 is a time corresponding to the beginning point of the schedule cycle (SST2).

In the schedule cycle 1, a polled TXOP is given as scheduled, and operations are carried out as in the conventional technique. However, the SST of the QSTA2 is set so as to correspond to the beginning point of the schedule cycle, so that the QSTA2 shifts into the awake mode immediately after the schedule cycle begins. Thereafter, in response to a QoS CF-Poll frame 403, the QSTA2 transmits the data frame 404 and shifts into the power save mode as in the above-described embodiments.

In the schedule cycle 2, first, a QoS CF-Poll frame 405 is transmitted to the QSTA1. In response to the QoS CF-Poll frame 405, the QSTA1 starts transmission of a data frame 406. In the QSTA1, if there is no data which should be transmitted during the polled TXOP, the QSTA1 transmits a TXOP return frame so as to return the given polled TXOP as described above. At this time, the QSTA2 has not shifted into the awake mode yet in the conventional technique, the QAP 10 cannot transmit any QoS CF-Poll frame to the QSTA2, so that the CP is provided. However, in the present embodiment, the SST of each QSTA is set so as to correspond to the beginning point of the schedule cycle, so that the QSTA2 is in the awake mode at this time. Hence, the QAP 10 immediately transmits the QoS CF-Poll frame 407. Thus, no CP is provided between the polled TXOP for the QSTA1 and the polled TXOP for the QSTA2.

Thereafter, the QSTA2 transmits a data frame 408 until a TXOP limit specified in the QoS CF-Poll frame 407 passes, so that the QSTA2 shifts into the power save mode.

In order to shift to the CP, the QAP 10 does not transmit any data and allocates all the remaining time period of the schedule cycle 2 as the CP. As a result, the CP is longer than scheduled in the preset schedule.

When a scheduled time to start the schedule cycle 3 comes, that is, when a scheduled time to transmit a QoS CF-Poll frame 409 to the QSTA1 comes, the QAP 10 transmits the QoS CF-Poll frame 409 and then carries out spectrum allocation in accordance with the preset schedule. In FIG. 9, the QSTA1 does not return the TXOP at an early period or does not carry out similar operation thereafter, so that a spectrum is allocated as scheduled in the preset schedule.

As described above, the QAP 10 (schedule setting section 18) according to the present embodiment sets the preset schedule (SST and SI of each QSTA) so that each QSTA shifts into the awake mode at the beginning of each schedule cycle.

As a result, it is possible to prevent the power save efficiency of the QSTA from dropping also in case where a polled TXOP previously positioned in the schedule cycle comes to an end earlier than scheduled. In such case, according to the conventional technique, the CP is provided between the polled TXOP and a next polled TXOP, and the CP is extended, so that transmission of a subsequent QoS CF-Poll delays, which results in lower power save efficiency.

### (4-1) Example of Allocation of Polled TXOPs

(4-1-1) Case of Giving Priority to the Power Save Efficiency in the Entire Network

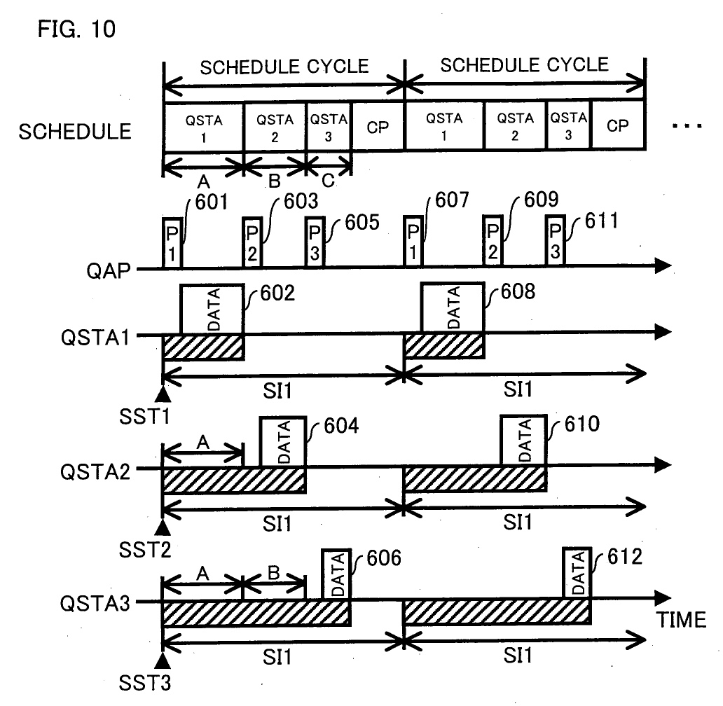

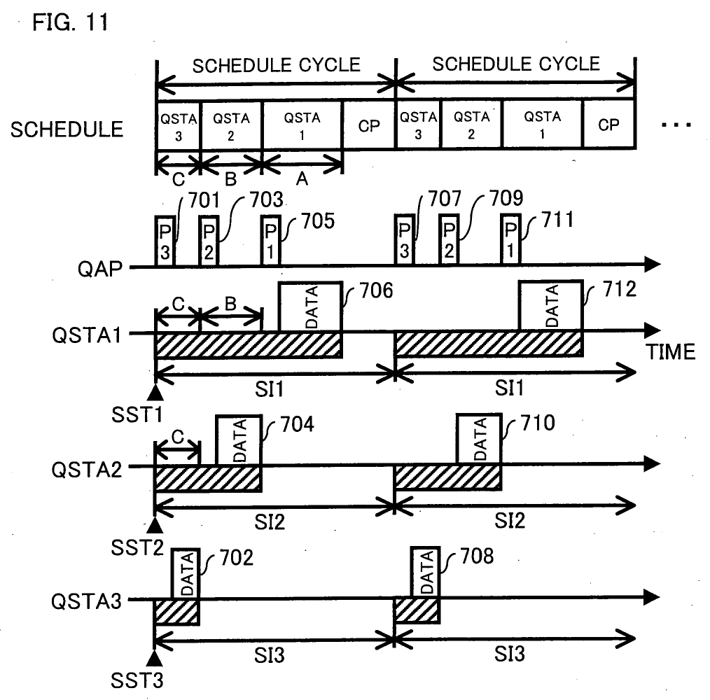

In the present embodiment, a timing at which each QSTA shifts into the awake mode is set so as to correspond to the beginning point of the schedule cycle. In this case, for higher power save efficiency of each QSTA (for higher power save efficiency in the entire network), the schedule setting section 18 sets the preset schedule in which polled TXOPs of QSTAs are allocated so that a shorter polled TXOP is positioned more previously. With reference to FIG. 10 and FIG. 11, this arrangement is specifically described as follows.

FIG. 10 illustrates an example in which polled TXOPs are allocated in such order that a shorter polled TXOP is positioned later. This is an example of inefficient allocation of polled TXOPs. FIG. 11 illustrates an example in which polled TXOPs are allocated in such order that a longer polled TXOP is positioned later. This is an example of efficient allocation of polled TXOPs. Note that, how to illustrate the diagram and abbreviated names are the same as in FIG. 1.

The spectrum allocation in FIG. 10 and the spectrum allocation in FIG. 11 are the same, and longest spectrums are allocated to the QSTA1 and shortest spectrums are allocated to the QSTA3. That is, at every schedule cycle, a polled TXOP which is about 40% of each schedule cycle is given to the QSTA1, a polled TXOP which is about 30% of each schedule cycle is given to the QSTA2, and a polled TXOP which is about 20% of each schedule cycle is given to the QSTA3.

In these figures, power save efficiencies are compared with each other in view of the entire QSTAs. The QSTAs are compared with each other in terms of a total of lengths of periods in which each QSTA is in the awake mode. The smaller the total is, the higher the power save efficiency is.

A length of the polled TXOP given to the QSTA1 in a single schedule cycle, that is, a time period from a time when the QSTA1 receives a QoS CF-Poll frame to a time when a TXOP limit period indicated by the QoS CF-Poll frame passes is defined as “A”. FIG. 10 and FIG. 11 are identical to each other in this length. Likewise, a length of a polled TXOP given to the QSTA2 is defined as “B”. A length of a polled TXOP given to the QSTA3 is defined as “C”.

In FIG. 10, in a single schedule cycle, a time period in which the QSTA1 is in the awake mode is “A”, and a time period in which the QSTA2 is in the awake mode is “A+B”, and a time period in which the QSTA3 is in the awake mode is “A+B+C”. If a total thereof is T1, T1=3A+2B+C.

In FIG. 11, in a single schedule cycle, a time period in which the QSTA1 is in the awake mode is “C+B+A”, and a time period in which the QSTA2 is in the awake mode is “C+B”, and a time period in which the QSTA3 is in the awake mode is “C”. If a total thereof is T2, T2=3C+2B+A.

As described above, A>C results in T1>T2. Thus, the condition illustrated in FIG. 11 gives higher power save efficiency as the entire network.

In other words, if a longer polled TXOP is previously disposed, all the QSTAs waiting for the end of the polled TXOP have to standby in the awake mode, so that a period in which the entire QSTAs are in the awake mode increases. As a result, the power save efficiency drops. That is, in case of allocating polled TXOPs whose lengths are different from each other, shorter polled TXOPs are provided earlier, thereby increasing the power save efficiency.

(4-1-2.) Case of Making Power Save Efficiencies of the QSTAs Even

In case of allocating polled TXOPs in such order that a shorter polled TXOP is provided earlier, the power save efficiency of the entire network is improved, but a QSTA to which a polled TXOP is given at an earlier stage of the schedule cycle has higher power save efficiency, and a QSTA to which a polled TXOP is given at a later stage has lower power save efficiency.

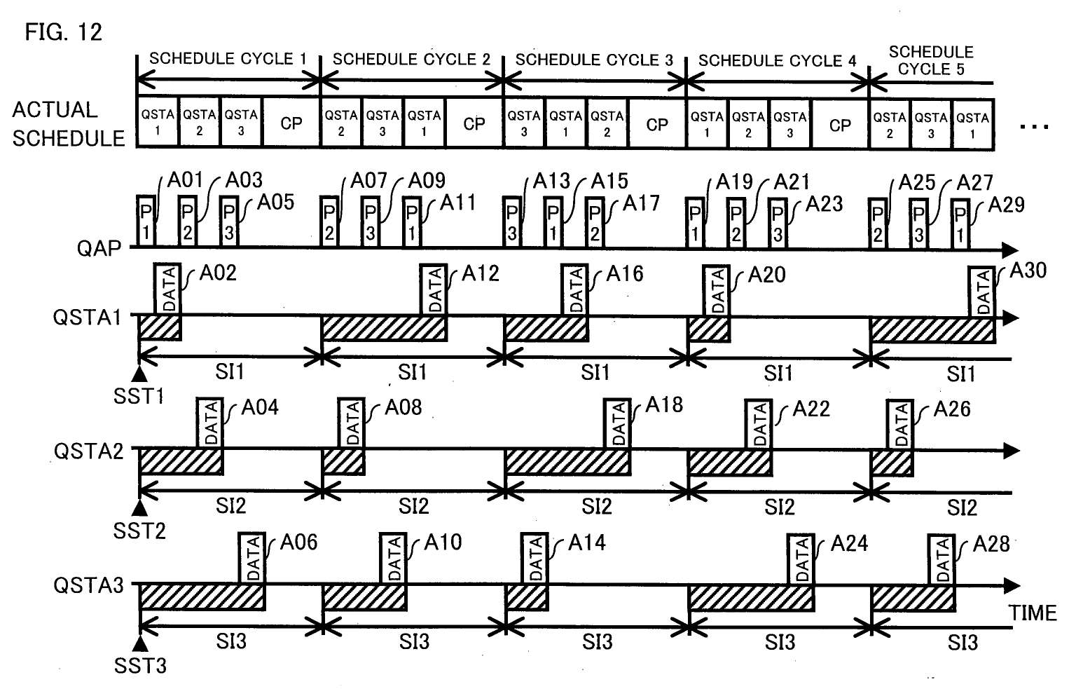

Thus, in case of making power save efficiencies of the QSTAs even, it may be so arranged that the schedule setting section 18 sets a preset schedule obtained by cyclically changing an order in which QoS CF-Poll frames are transmitted to the QSTAs. FIG. 12 is an example of a timing chart in this case. Note that, how to illustrate the diagram and abbreviated names are the same as in FIG. 1. Note that, operations of other QSTAs are not illustrated in FIG. 12.

In an example illustrated in FIG. 12, a polled TXOP which is about 20% of each schedule cycle is given to each of the QSTA1, the QSTA2, and the QSTA3, at every schedule cycle. Further, each of SIs of the QSTA1, the QSTA2, and the QSTA3 is as long as the schedule cycle (SI1, S12, S13). Further, as in FIG. 9, each of SSTs of the QSTA1, the QSTA2, and the QSTA3 is a time corresponding to the beginning point of the schedule cycle (SST1, SST2, SST3).

However, as illustrated in FIG. 12, an order in which QoS CF-Poll frames are transmitted in each schedule cycle is cyclically changed. That is, in the schedule cycle 1, QoS CF-Poll frames are transmitted to the QSTAs in an order of the QSTA1, the QSTA2, and the QSTA3; in the schedule cycle 2, QoS CF-Poll frames are transmitted to the QSTAs in an order of the QSTA2, the QSTA3, and the QSTA1; in the schedule cycle 3, QoS CF-Poll frames are transmitted to the QSTAs in an order of the QSTA3, the QSTA1, and the QSTA2; in the schedule cycle 4, QoS CF-Poll frames are transmitted to the QSTAs in an order of the QSTA1, the QSTA2, and the QSTA3. Thereafter, this operation is repeated.

Herein, the QSTA1 is focused on. In the schedule cycle 1, a QoS CF-Poll frame A01 is transmitted from the QAP 10 to the QSTA1, and the QSTA1 having received the QoS CF-Poll frame A01 transmits a data frame A02. Under this condition, the QSTA1 has only to be in the awake mode during a period from the beginning point of the schedule cycle to an end of its subsequent polled TXOP.

In the schedule cycle 2, the QAP 10 transmits a QoS CF-Poll frame A11 to the QSTA1 after transmitting QoS CF-Poll frames A07 and A09 to the QSTA2 and the QSTA3 respectively. That is, the QSTA1 is in the awake mode during a period from the beginning point of the schedule cycle to a time when polled TXOPs of the QSTA2 and the QSTA3 come to an end and its subsequent polled TXOP comes to an end. This means that the QSTA1 has to be in the awake mode for a period three times as long as the schedule cycle 1.

In the schedule cycle 3, the QAP 10 transmits a QoS CF-Poll frame A15 after transmitting a QoS CF-Poll frame A13 to the QSTA3. That is, the QSTA1 has to be in the awake mode during a period from the beginning point of the schedule cycle to a time when a polled TXOP of the QSTA3 comes to an end and its subsequent polled TXOP comes to an end. This means that the QSTA1 has to be in the awake mode for a period twice as long as the schedule cycle 1.

In the example illustrated in FIG. 12, all the QSTAs are the same in a length of the polled TXOP. Thus, if a length of a polled TXOP is defined as “T”, the QSTA1 is in the awake mode in T at the schedule cycle 1, 3T at the schedule cycle 2, and 2T at the schedule cycle 3. Thus, a total of periods in which the QSTA1 is in the awake mode at the schedule cycles 1 to 3 is 6T.

The QSTA2 is in the awake mode in 2T at the schedule cycle 1, T at the schedule cycle 2, and 3T at the schedule cycle 3. Thus, a total of periods in which the QSTA2 is in the awake mode at the schedule cycles 1 to 3 is 6T.

The QSTA3 is in the awake mode in 3T at the schedule cycle 1, 2T at the schedule cycle 2, and T at the schedule cycle 3. Thus, a total of periods in which the QSTA3 is in the awake mode at the schedule cycles 1 to 3 is 6T.

In view of the total in the schedule cycles 1 to 3 which is calculated in this manner, the QSTAs 1 to 3 are equal to one another in a period in which the QSTA is in the awake mode. This means that the power save efficiencies of the QSTAs 1 to 3 are even. Note that, the same schedule is repeated in the schedule cycle 4 and subsequent schedule cycles, so that the power save efficiencies of the QSTAs are even also in the long view.

As described above, according to the present embodiment, the Service Start Time is set so that polled TXOPs can be sequentially given, thereby preventing the power save efficiency of the QSTA from dropping also in case where the polled TXOPs are provided. In such case, according to the conventional technique, the CP is provided between the polled TXOP and a next polled TXOP, and the CP is extended, so that transmission of a subsequent QoS CF-Poll delays, which results in lower power save efficiency. Further, by cyclically changing an order in which QoS CF-Poll frames are transmitted to the QSTAs respectively, it is possible to make the power save efficiencies of the QSTAs even.

That is, it is possible to prevent such disadvantage that a certain QSTA has high power save efficiency but other QSTA has low power save efficiency. For example, in case where each QSTA operates with a buttery, if the power save efficiencies of the QSTAs are uneven, a QSTA whose power save efficiency is lower may become in an inoperative state earlier than other QSTAs. For example, when a QSTA connected to a server in which data is stored becomes in an inoperative state, even if the QSTA can be accessed by a QSTA serving as a client since a buttery of this QSTA does not completely run out, the data cannot be received, so that the QSTA serving as a client is useless. Thus, in such case, the power save efficiencies of the QSTAs are made even as described above, so that it is possible to avoid such state that only the client is operative. As a result, a time period in which the server is operative increases accordingly, so that advantage as the entire network is improved.

(4-1-3.) Another Example of Allocation of Polled TXOPs

The foregoing description explained the example where polled TXOPs are provided simply in such order that shorter QSTAs are provided earlier and the example where an order in which QoS CF-Poll frames are transmitted to the QSTAs respectively is cyclically changed, but the present invention is not limited to them. The order in which the polled TXOPs are allocated may be determined in accordance with other condition.

For example, allocation (order) of the polled TXOPs concerning each QSTA may be set in accordance with importance of the power save efficiency in each QSTA. That is, it may be so arranged that a QSTA whose power save efficiency is more important is positioned earlier in the schedule cycle.

For example, it may be so arranged that the QAP 10 inquires each QSTA about a remaining amount of its buttery and the QSTAs are disposed in such order that a QSTA having the buttery whose remaining amount is smaller is positioned earlier. Further, it may be so arranged that importance is set in accordance with a type or the like of data to be transmitted from each QSTA and the QSTAs are disposed in such order that a QSTA having higher importance is positioned earlier.

Further, it may be so arranged that a QSTA which is free from the power save mode is disposed later. The QSTA which is free from the power save mode is always in the awake mode, so that the CF-Poll frame may be transmitted to the QSTA at any timing.

For example, let us consider a case where the QSTA1 is a wireless IP mobile phone and the QSTA2 is a stationary TV (device which can receive an image via a wireless LAN). The wireless IP mobile phone is operated with a buttery, but the stationary TV is driven with it connected to a power line. That is, the power save efficiency is more important in the QSTA1 than in the QSTA2. Thus, the Polled TXOP for the QSTA1 is provided at the beginning point of the schedule cycle, and a Polled TXOP for the QSTA2 is provided thereafter. Further, the QSTA1 transmits sound data, but the QSTA2 transmits video data. A data amount of the sound data for each hour is smaller than a data amount of the video data, that is, also a single Polled TXOP becomes shorter. Thus, it is possible to improve the entire power save efficiency by providing the Polled TXOP for the QSTA1 earlier than the QSTA2. Thus, also in this view point, the above-described scheduling method is efficient.

(4-2.) Determination on Whether it is Appropriate to Adopt the Present Embodiment or not

In the example illustrated in FIG. 9, the SST for the QSTA2 is positioned at the beginning point of the schedule cycle, so that the QSTA2 has to be unnecessarily in the awake mode at every schedule cycle. Thus, the power save efficiency accordingly drops. As the polled TXOP disposed earlier at the schedule cycle is shorter, a QSTA to which a subsequent polled TXOP is given is unnecessarily in the awake mode for a shorter time, so that the present embodiment is effective in case where the polled TXOP disposed earlier at the schedule cycle is short. That is, the drop of the power save efficiency which is caused by insertion of the CP is compared with the drop of the power save efficiency which is caused in the present embodiment, and if the latter is more significant than the former, it is preferable not to adopt the present embodiment.

Thus, it may be so arranged that the QAP 10 (schedule setting section 18) determines, in accordance with allocation of streams determined by ADDTS or in accordance with a similar condition, whether to set the conventional power save schedule despite of extension of the CP or to set the power save schedule adopting the present embodiment.

Herein, the following is an example of a method in which the QAP 10 (schedule setting section 18) determines whether it is appropriate to adopt the present embodiment or not.

Whether it is more efficient to set the conventional power save schedule or it is more efficient to set the power save schedule by adopting the present embodiment varies depending on allocation of streams determined by ADDTS or a purpose of use as the entire system. Thus, the determination method cannot be determined in a simple manner, but it is possible to adopt the present embodiment, for example, in case where a length of a polled TXOP given in a single schedule cycle is shorter than a predetermined period (in case where the length is less than a predetermined period).

In this case, the QAP 10 determines a length or the like of a polled TXOP given to a QSTA in accordance with the TSPEC informed as the ADDTS request frame. At this time, when the length of the polled TXOP given to the QSTA in a single schedule cycle is shorter than the predetermined period, the schedule setting method of the present embodiment is adopted, and an SST and an SI thereof are determined so that the QSTA shifts in the awake mode at the beginning point of the schedule cycle, and the SST and the SI are informed to the QSTA as the ADDTS response frame. Further, when the length of the polled TXOP given to the QSTA in a single schedule cycle is longer than the predetermined period (the length is equal to or longer than the predetermined period), the schedule setting method of the present embodiment is not adopted and the SST and the SI thereof are determined so that the QSTA shifts into the awake mode at a scheduled time to transmit a QoS CF-Poll frame, and the SST and the SI are informed to the QSTA as the ADDTS response frame.

Note that, the predetermined period is set by the QAP 10 (schedule setting section 18) in accordance with allocation of streams determined by ADDTS or in accordance with a purpose of use as the entire system.

According to the determination method, it is possible to determine whether or not to adopt the present embodiment with a simple procedure.

Note that, if the present embodiment is not adopted, it is preferable to provide a polled TXOP of a QSTA which is less likely to return the polled TXOP in the middle of the process so that the polled TXOP is earlier at the schedule cycle. As a result, the CP is less likely to occur, so that the spectrum allocation schedule is less likely to deviate.

That is, in case where the CP is extended at an earlier stage of the schedule cycle, transmission timings of all subsequent QoS CF-Poll frames respectively deviate, so that QSTAs to which the QoS CF-Poll frames are respectively transmitted are in the awake mode unnecessarily for a longer time. Thus, the power save efficiency can be made higher as the extension of the CP occurs at a later stage of the schedule cycle.

Further, even if a polled TXOP provided at the last of the schedule cycle comes to an end earlier than scheduled, a subsequent CP starts ahead of schedule, so that this arrangement is free from any problem. For example, compared with a QSTA transmitting VBR (variable bit rate) contents as a stream transmitted in the polled TXOP, a QSTA transmitting CBR (constant bit rate) contents is less likely to return the polled TXOP in the middle of the process. In the MPEG, it is possible to select either the CBR format in which video or sound is compressed with a constant bit rate or the VBR format in which video or sound is compressed with a bit rate varied depending on a data amount of each scene. In the VBR format, a bit rate is increased at a greatly variable point and is decreased at a monotonous point, so that an image quality or a sound quality for each bit rate can be enhanced compared with the CBR format, but its decoding process is more complicate than the CBR format. Thus, Either the VBR format or the CBR format can be used depending on a purpose of use. In case of transmitting CBR contents, data whose amount is constant is always transmitted, so that this arrangement is free from such condition that a given polled TXOP remains and there is no data to be transmitted. While, in case of transmitting VBR contents, an amount of data which should be transmitted becomes small in a relatively monotonous scene. A QSTA informs an average bit rate in the entire contents as an ADDTS request frame, and the QAP 10 gives a polled TXOP enough to carry out the bit rate transmission requested by the ADDTS request frame, so that the QSTA has no data which should be transmitted in the middle of the polled TXOP while transmitting data of a monotonous scene. This may cause the polled TXOP to be returned. Thus, a polled TXOP for a QSTA transmitting VBR contents is disposed earlier at the schedule cycle, so that it is possible to improve the power save efficiency as the entire network.

(4-3.) Modification Example of Second and Further QSTAs which are in the Awake Mode

Further, in the present embodiment, all the QSTAs shift into the awake mode at the beginning point of the schedule cycle, but the present invention is not limited to this, and it may be so arranged that a QoS CF-Poll for each of the second and further QSTAs is transmitted little bit later than the beginning of the schedule cycle. For example, let us consider a case where a QoS CF-Poll is transmitted to the QSTA1 at each schedule cycle as in FIG. 9. No matter what length a polled TXOP given by the QoS CF-Poll frame has (even if the polled TXOP is 0), the QSTA2 does not receive a frame during transmission of the QoS CF-Poll frame. Thus, a minimum length of the QoS CF-Poll frame is determined, so that the SST and the SI may be determined so that the QSTA2 shifts into the awake mode from a time delayed from the beginning point of the schedule cycle so as to correspond to a time period taken to transmit the QoS CF-Poll frame having the minimum length.

Further, if there are two QoS CF-Polls transmitted at each schedule cycle, a QSTA to which the third QoS CF-Poll is transmitted is brought into the awake mode at a time delayed so as to correspond to a time period taken to transmit two QoS CF-Polls. In this manner, the above-described technique can be repetitively used. Further, in case where an ACK frame is transmitted so as to confirm transmission of the QoS CF-Poll frame, a time at which the QSTA2 shifts into the awake mode may be delayed so as to correspond to a time period taken to transmit the ACK frame. Note that, the ACK frame normally has a constant length, so that a time period required in transmitting the ACK frame can be calculated. Further, in case where a minimum interval required as a frame interval is defined by protocol, the time may be delayed so as to correspond to a length of the interval. Further, in case where data is transmitted from the QAP 10 at the beginning point of every schedule cycle, the time at which each of all the QSTAs shifts into the awake mode may be delayed so as to correspond to a time period taken to transmit the data.

Further, in the present embodiment, the QSTA1 and the QSTA2 are identical to each other in the SI for simplification of descriptions, but the present invention is not limited to this, and the SI of the QSTA1 and the SI of the QSTA2 may be different from each other. Further, the spectrums respectively allocated to the QSTA1 and the QSTA2 are the same, but the spectrums respectively allocated to the QSTA1 and the QSTA2 may be different from each other. Further, in the present embodiment, the spectrums are respectively allocated to the two QSTAs, but the present invention is not limited to this as long as spectrum(s) are allocated to one or more QSTAs.

### Embodiment 5

Further another embodiment of the present invention is described as follows. Note that, for convenience in descriptions, the same reference signs are given to members having the same arrangements and functions as those of the QAP 10 according to Embodiments 1 to 3, and descriptions thereof are omitted.

An arrangement of a QAP 10 according to the present embodiment is substantially the same as in Embodiments 1 to 4. Further, as in Embodiments 1 to 4, the QAP 10 according to the present embodiment is used in a network which allows communications on the basis of IEEE 802.11e standard. However, the schedule setting section 18 sets an SST so that polled TXOPs are sequentially given in the schedule cycle in case where there are streams which are different from each other in an SI, thereby preventing occurrence of the CP between two polled TXOPs.

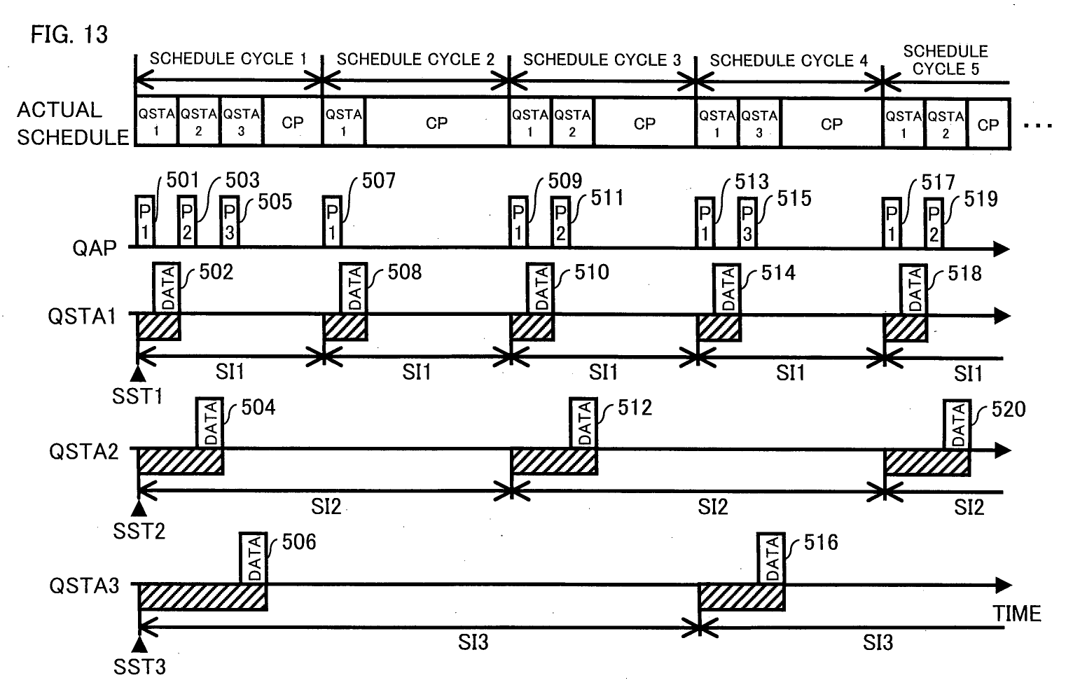

FIG. 13 is an example of a timing chart in the network managed by the QAP 10 according to the present embodiment. How to illustrate the diagram and abbreviated names are substantially the same as in FIG. 1. Note that, descriptions on operations of other QSTAs are omitted.

In an example illustrated in FIG. 13, a spectrum allocation schedule in the QAP 10 is such that a polled TXOP which is about 20% of each schedule cycle is given to the QSTA1 at every schedule cycle, and a polled TXOP which is about 20% of each schedule cycle is given to the QSTA2 at every two schedule cycles, and a polled TXOP which is about 20% of each schedule cycle is given to the QSTA3 at every three schedule cycles.

Further, an SI (SI1) of the QSTA1 is as long as the schedule cycle, and an SI (SI2) of the QSTA2 is twice as long as the schedule cycle, and an SI (SI3) of the QSTA3 is three times as long as the schedule cycle.

A polled TXOP for the QSTA1 is positioned at the beginning point of the schedule cycle, and an SST of the QSTA1 is a time corresponding to the beginning point of the schedule cycle (SST1). A polled TXOP for the QSTA2 is positioned after the polled TXOP for the QSTA1, so that the SST conventionally begins at a time calculated by adding, to the beginning point of the schedule cycle, a length of a period for transmitting a QoS CF-Poll frame to the QSTA1 and the length of the polled TXOP. However, the present embodiment is characterized in that the SST of the QSTA2 begins at a time corresponding to the beginning point of the schedule cycle (SST2). Likewise, a polled TXOP for the QSTA3 is positioned after the polled TXOP for the QSTA2, so that the SST conventionally begins at a time calculated by adding, to the beginning point of the schedule cycle, a length of a period for transmitting a QoS CF-Poll frame to the QSTA1, the length of the polled TXOP, a length of a period for transmitting a QoS CF-Poll frame to the QSTA2, and the length of the polled TXOP. However, the present embodiment is characterized in that the SST of the QSTA3 begins at a time corresponding to the beginning point of the schedule cycle (SST3).

In the schedule cycle 1, the QAP 10 transmits a QoS CF-Poll frame 501 to the QSTA1. In response to the QoS CF-Poll frame 501, the QSTA1 transmits a data frame 502. Next, the QAP 10 transmits a QoS CF-Poll frame 503 to the QSTA2. In response to the QoS CF-Poll frame 503, the QSTA2 transmits a data frame 504. Further, the QAP 10 transmits a QoS CF-Poll frame 505 to the QSTA3. In response to the QoS CF-Poll frame 505, the QSTA3 transmits a data frame 506. Thereafter, a CP period is provided until the schedule cycle comes to an end, so that the QAP does not transmit any data.

In this case, at the schedule cycle 1, the QSTA1 is in the awake mode during a period from the beginning point of the schedule cycle to a time when transmission of the data frame 502 is completed. The SST of the QSTA2 is positioned at the beginning point of the schedule cycle, so that the QSTA2 is in the awake mode during a period from the beginning point of the schedule cycle to a time when transmission of the data frame 504 is completed.

The SST of the QSTA3 is positioned at the beginning point of the schedule cycle, so that the QSTA3 is in the awake mode during a period from the beginning point of the schedule cycle to a time when transmission of the data frame 506 is completed.

At the schedule cycle 2, a polled TXOP is given only to the QSTA1. Thus, the QSTA1 is in the awake mode during a period from the beginning point of the schedule cycle to a time when transmission of the data frame 508 is completed. The QSTA2 and the QSTA3 are in the power save mode at this schedule cycle.

At the schedule cycle 3, polled TXOPs are respectively given to the QSTA1 and the QSTA2. Thus, the QSTA1 is in the awake mode during a period from the beginning point of the schedule cycle to a time when transmission of the data frame 510 is completed. The QSTA2 is in the awake mode during a period from the beginning point of the schedule cycle to a time when transmission of the data frame 512 is completed. The QSTA3 is in the power save mode at this schedule cycle.

At the schedule cycle 4, polled TXOPs are respectively given to the QSTA1 and the QSTA3. The QAP 10 transmits a QoS CF-Poll frame 513 to the QSTA1. In response to the data frame 513, the QSTA1 transmits a data frame 514. According to the conventional technique, the SST of the QSTA3 begins at a time calculated by adding, to beginning point of the schedule cycle, a length of a period for transmitting the polled TXOP to the QSTA1 and a period for transmitting the polled TXOP to the QSTA2. Thus, at the schedule cycle 4, the QSTA3 is not in the awake mode at a time when the polled TXOP of the QSTA1 comes to an end. Thus, the QAP 10 provides a CP at a time when the polled TXOP of the QSTA1 comes to an end.

However, in the present embodiment, the SST of the QSTA3 corresponds to the beginning point of the schedule cycle. Thus, also at the schedule cycle 4, the QSTA3 is in the awake mode from the beginning point of the schedule cycle, and the QAP 10 transmits a QoS CF-Poll frame 519 to the QSTA3 at a time when the polled TXOP of the QSTA1 comes to an end. Thus, the CP is not provided between the polled TXOP of the QSTA1 and the polled TXOP of the QSTA3. Note that, in response to a QoS CF-Poll 515, the QSTA3 transmits a data frame 516 and then shifts into the power save mode.

As described above, according to the present embodiment, in case where there are streams whose SIs are different from each other, the QAP 10 (schedule setting section 18) sets a preset schedule so that each QSTA giving a polled TXOP at each schedule cycle becomes into the awake mode at the beginning point of the schedule cycle. Further, within each schedule cycle, the QAP 10 sequentially transmits polled TXOPs to QSTAs for allocating polled TXOPs in the schedule cycle.

As a result, at each schedule cycle, the CP is not provided between the polled TXOPs of the QSTAs different from each other. Thus, this arrangement can prevent such condition that the CP between the polled TXOPs of the QSTAs different from each other is extended and then transmission of the QoS CF-Poll frame delays which results in drop of the power save efficiency in each QSTA.

Note that, an order in which polled TXOPs are provided in each schedule cycle (order in which polled TXOPs are given to the QSTAs respectively) is suitably determined in consideration for the power save efficiency of the entire network, the power save efficiency in each QSTA, and a similar condition. It may be so arranged that the schedule setting section 18 sets the order in accordance with various kinds of conditions.

Further, in the present embodiment, each of the SST of the QSTA2 and the SST of the QSTA3 corresponds to the beginning point of the schedule cycle, so that the QSTA2 and the QSTA3 unnecessarily become into the awake mode at every schedule cycle at which the polled TXOP is given. Thus, the power save efficiency accordingly drops. In this case, at a certain schedule cycle, as the polled TXOP disposed earlier at the schedule cycle is shorter, a QSTA to which a subsequent polled TXOP is given is unnecessarily in the awake mode for a shorter time, so that the present embodiment is effective in this case.

It may be so arranged that the QAP 10 (schedule setting section 18) determines, in accordance with allocation of streams determined by ADDTS or in accordance with a similar condition, whether to set the conventional power save schedule despite of extension of the CP or to set the power save schedule adopting the present embodiment.

Further, in the present embodiment, all the QSTAs to which polled TXOP are given at each schedule cycle are shifted into the awake mode at the beginning point of the schedule cycle, but the present invention is not limited to this. As in Embodiment 4, a QoS CF-Poll for each of the second and further QSTAs may be transmitted little bit later than the beginning of the schedule cycle.

Further, in the present embodiment, the QSTA1 and the QSTA2 are identical to each other in an SI, but the present invention is not limited to this, and the SI of the QSTA1 and the SI of the QSTA2 may be different from each other. Further, the spectrums respectively allocated to the QSTA1 and the QSTA2 are the same, but the spectrums respectively allocated to the QSTA1 and the QSTA2 may be different from each other. Further, in the present embodiment, the spectrums are respectively allocated to the two QSTAs, but the present invention is not limited to this as long as spectrum(s) are allocated to one or more QSTAs.

(In Case where Streams are Deleted)

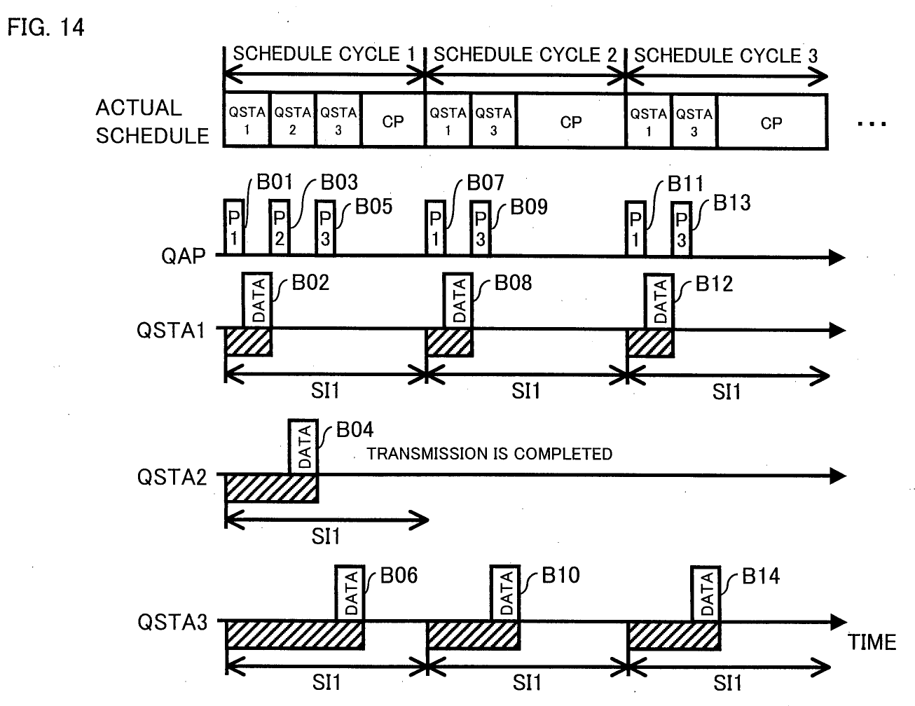

The schedule setting method according to the present embodiment is as follows: In case where polled TXOPs are given to a plurality of QSTAs respectively in the schedule cycle, there is solved a problem raised under such condition that there is no polled TXOP disposed previous to the schedule cycle or the polled TXOP disposed previous to the schedule cycle is shortened. However, also in other case, i.e., also in case where the streams are deleted, the same condition can occur. With reference to FIG. 14, this case will be detailed as follows. How to illustrate the diagram and abbreviated names are the same as in FIG. 1. Note that, descriptions on operations of other QSTAs are omitted.

In an example illustrated in FIG. 14, polled TXOPs each of which is about 20% of each schedule cycle are respectively given to the QSTA1 to the QSTA3 at every schedule cycle.

Further, as in FIG. 13, each of all the QSTAs to which polled TXOPs are respectively given at a schedule cycle is set so as to be in the awake mode at the beginning point of the schedule cycle.

At the schedule cycle 1, polled TXOP are given to all the QSTAs respectively as usual.

In the example illustrated in FIG. 14, the QSTA2 completes transmission of all data of the stream in the polled TXOP of the schedule cycle 1, and subsequent polled TXOPs are unnecessary. In this case, the QSTA2 transmits a DELTS request frame to the QAP10 (this operation is not shown). In response to the DELTS request frame, the QAP 10 recognizes that it is thereafter unnecessary to give a polled TXOP to the QSTA2 and transmits a DELTS response frame to the QSTA2 as a response (this operation is not shown).

In this case, at the schedule cycle 2, a polled TXOP of the QSTA2 originally scheduled to be provided after the polled TXOP of the QSTA1 is not provided, and a polled TXOP of the QSTA3 is provided. This is the same as in the schedule cycle 4 of FIG. 13.

According to the conventional technique, the QSTA3 is not in the awake mode at a time when the QSTA1 completes transmission of a data frame B08. Thus, the QAP 10 provides a CP here.

While, in the present embodiment, the QSTA3 is set so as to be in the awake mode from the beginning point of the schedule cycle, and the QAP 10 transmits a QoS CF-Poll frame B09 to the QSTA3 at a time when transmission of a QoS CF-Poll frame B08 from the QSTA1 is completed. Further, in response to the QoS CF-Poll frame B09, the QSTA3 transmits a data frame B10 and then shifts into the power save mode.

Thus, in the present embodiment, the CP is not provided between the polled TXOP of the QSTA1 and the polled TXOP of the QSTA3. Thus, this arrangement can prevent such condition that the CP between the polled TXOPs of the QSTAs different from each other is extended and then transmission of the QoS CF-Poll frame delays which results in drop of the power save efficiency in each QSTA.

### Embodiment 6

Still further another embodiment of the present invention will be described as follows. Note that, for convenience in descriptions, the same reference signs are given to members having the same arrangements and functions as those of the QAP 10 according to Embodiments 1 to 3, and descriptions thereof are omitted.

An arrangement of a QAP 10 according to the present embodiment is substantially the same as in Embodiments 1 to 5. Further, as in Embodiments 1 to 5, the QAP 10 according to the present embodiment is used in a network which allows communications on the basis of IEEE 802.11e standard. However, in the present embodiment, the QAP 10 (timing control section 20) transmits a frame so as not to shift into the CP in case where a polled TXOP is returned earlier than scheduled. Note that, in the present embodiment, the SST and the SI are set so as not to cause the QSTA2 to be in the awake mode at the beginning point of the schedule cycle but so as to cause the QSTA2 to be in the awake mode when a time period corresponding to the length of the polled TXOP for the QSTA1 passes from the beginning point of the schedule cycle as usual.

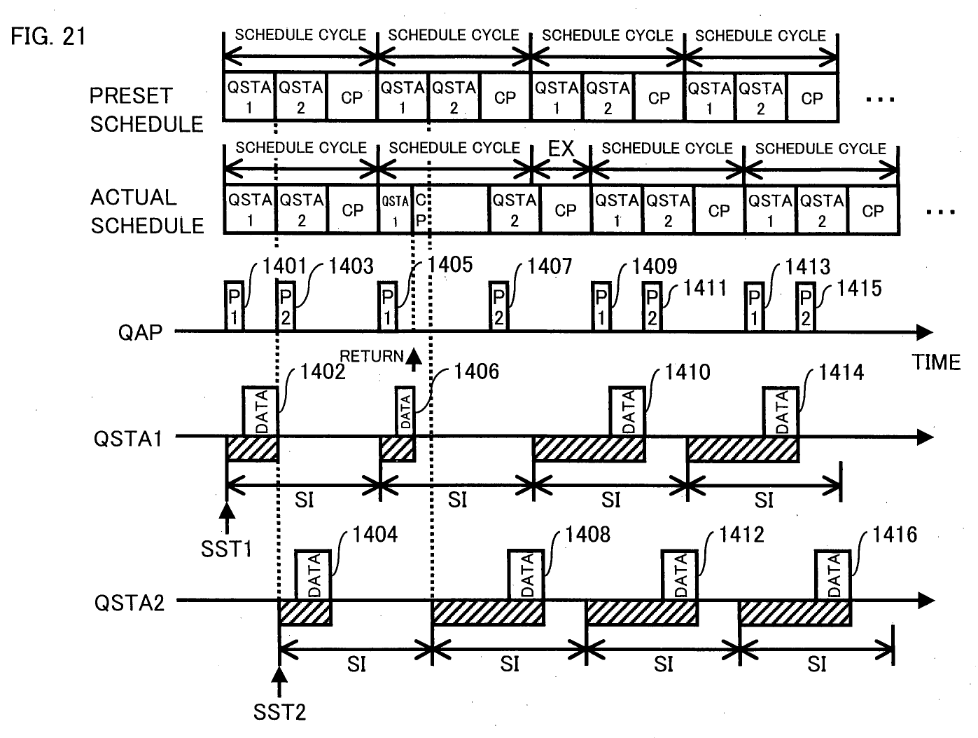

In case where the polled TXOP for the QSTA1 is returned earlier than scheduled as in the schedule cycle 2 of FIG. 21 for example, the QAP 10 (timing control section 20) continues to transmit any frames at intervals less than DIFS until the QSTA2 becomes into the awake mode so as not to shift to the CP. That is, the QSTA1 transmits a data frame 406, and then the QAP 10 continues to transmit any frame until the QSTA2 becomes into the awake mode so as not to generate DIFS intervals and transmits a QoS CF-Poll frame 407 to the QSTA2 at a scheduled time for the QSTA2 to become in the awake mode comes. Thus, a QSTA which is to transmit a frame in the DCF format cannot transmit any frame during a period from an end of the polled TXOP of the QSTA1 to the beginning point of the polled TXOP of the QSTA2. Thus, no CP occurs, so that the CP is not extended, thereby preventing subsequent spectrum allocation schedule from delaying.

Herein, as the frame the QAP 10 continues to transmit, any frame may be used as long as the frame does not have influence on the spectrum allocation schedule or the power save schedule. For example, the QAP 10 may continue to transmit a QoS CF-Poll frame addressed to the QSTA1. In this case, even though the QAP 10 transmits the QoS CF-Poll frame, the QSTA1 has already shifted into the power save mode, so that the QSTA1 does not receive the frame. As a result, the QoS CF-Poll frame is ignored.

Further, the QAP 10 may continue to transmit a QoS CF-Poll frame addressed to the QSTA2. In this case, the QSTA2 is in the power save mode at first, so that the QSTA2 does not receive the QoS CF-Poll frame and the QoS CF-Poll frame is ignored. If the QAP 10 continues to transmit the QoS CF-Poll frame, the QoS CF-Poll frame is received at a time when the QSTA2 shifts into the awake mode.

Further, it may be so arranged that the QAP 10 transmits a data frame. For example, in case where it is scheduled to transmit a frame to a QSTA, other than the QSTA1 and the QSTA2, which is not in the power save mode, a data frame thereof is transmitted. If there is no data frame which should be transmitted, a blank data frame is transmitted. The data frame may be addressed to a QSTA which is in the power save mode as in the QSTA1 and the QSTA2 or may be addressed to a QSTA which is not in the power save mode. When the data frame is transmitted to the QSTA which is in the power save mode, the data frame is not received. When data frame is transmitted to the QSTA which is not in the power save mode, the data frame is received but the data frame is blank, so that the data frame is abandoned at the receiving side.

Further, it may be so arranged that: the QAP 10 does not continue to transmit the frame but transmits a QOS CF-Poll frame to a QSTA, other than the QSTA1 and the QSTA2, which is not in the power save mode, and the QAP 10 causes the QSTA to transmit the frame. Whether or not to use S-APSD for each stream can be set, so that there may be a QSTA which is always in the awake mode and can receive a QoS CF-Poll frame. If a QoS CF-Poll frame indicative of a TXOP limit which comes to an end at a scheduled time to start transmission of the polled TXOP to the QSTA2 is transmitted when transmission of the polled TXOP to the QSTA1 is finished, the QSTA transmits a data frame for the specified time period, so that a QSTA which is to carry out transmission in the DCF format cannot start frame transmission. As a result, the CP does not occur between the polled TXOP of the QSTA1 and the polled TXOP of the QSTA2, so that there is no extension of the CP, thereby preventing the spectrum allocation schedule from deviating.

Further, it may be so arranged that the transmission right is not returned in the middle of the polled TXOP when the QSTA uses S-APSD. In this case, the QSTA having requested for use of S-APSD by the ADDTS request frame continues to transmit a frame without transmitting a transmission right return frame, in response to a QoS CF-Poll thereafter, even when there is no frame which should be transmitted before a time period indicated by TXOP limit passes. In case where there is no data which should be transmitted, the QSTA continues to transmit a frame which does not have any influence on the spectrum allocation schedule or the power save schedule. For example, the QSTA may continue to transmit a blank data frame or may continue to transmit other frame.

(As to Combination of the Embodiments)

The above described embodiments can be used in combination.

Each of Embodiments 1 to 3 is an example of a first solution and is characterized by synchronizing the spectrum allocation schedule with the power save schedule in case where the CP is extended. Embodiment 2 can cover the case where the CP is extended longer than that of Embodiment 1, but provision of a long CP causes the spectrum allocated to the polled TXOP to decrease. Further, Embodiment 3 can cover the case where the CP is extended much longer than that of Embodiment 2, but it is necessary to transmit a Schedule frame which is not required to be transmitted in Embodiments 1 and 2. In this way, each of these methods has both advantage and disadvantage, so that it is preferable to select each of these methods depending on conditions. For example, it may be so arranged that all the methods are prepared so as to be selectively used.

Each of Embodiments 4 to 6 is an example of a second solution and is characterized by allowing less CPs to occur. As described above, such setting that no CP is provided cannot be realized in view of management of a network, so that the CP may be extended even if Embodiment 4 and/or Embodiment 5 is applied. Thus, Embodiment 4 and/or Embodiment 5 may be combined with one or more of Embodiments 1 to 3.

A communication device of the present invention serves as an access point provided on a network adopting (a) a first communication method for managing a period in which the access point gives transmission rights to stations and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method subsequently to transmission of a signal from the access point to the station to which the transmission right is to be given, (ii) an SST indicative of a time to start the SP, and (iii) an SI indicative of an interval at which the SP and another SP are provided, said communication device informing the station, to which the transmission right is to be given by the first communication method, of the SST and the SI in accordance with the schedule and said communication device carrying out spectrum management in accordance with the schedule, said communication device being characterized by comprising: delay detection means for detecting that a start time to give the transmission right to the station delays from the schedule; and timing control means for controlling the timing to give the transmission right to the station so that the period for executing the second communication method is shortened or omitted when the delay detection means detects the delay in the timing to give the transmission right to the station.

Further, the communication device of the present invention is arranged so that the schedule setting means determines schedule cycles each of which is a period having a certain length, and sets the schedule so as to periodically repeat a group of the schedule cycles which sequentially appear, and provides an adjustment period which has a length calculated by multiplying each of the schedule cycles with an integer in the schedule and which corresponds to the period for executing the second communication method, and the timing control means controls the timing to give the transmission right to the station so that the adjustment period is shortened or omitted when the delay detection means detects the delay in the timing to give the transmission right to the station.

Further, the communication device of the present invention is arranged so that the timing control means informs, during the adjustment period, the station that the transmission right is not given to the station in the adjustment period.

Further, a communication device of the present invention serves as an access point provided on a network adopting (a) a first communication method for managing a period in which the access point gives transmission rights to stations and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method subsequently to transmission of a signal from the access point to the station to which the transmission right is to be given, (ii) an SST indicative of a time to start the SP, and (iii) an SI indicative of an interval at which the SP and another SP are provided, said communication device informing the station, to which the transmission right is to be given by the first communication method, of the SST and the SI in accordance with the schedule and said communication device carrying out spectrum management in accordance with the schedule, said communication device being characterized by comprising delay detection means for detecting that a start time to give the transmission right to the station delays from the schedule, wherein the schedule setting means resets the schedule when the delay detection means detects the delay, and the schedule setting means resets the schedule and informs an SST and an SI, which are based on the schedule having been reset, to a station when the delay detection means detects that a timing for giving the transmission right delays.

Further, a communication device of the present invention serves as an access point provided on a network adopting (a) a first communication method for managing a period in which the access point gives transmission rights to stations and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method subsequently to transmission of a signal from the access point to the station to which the transmission right is to be given, (ii) an SST indicative of a time to start the SP, and (iii) an SI indicative of an interval at which the SP and another SP are provided, said communication device informing the station, to which the transmission right is to be given by the first communication method, of the SST and the SI in accordance with the schedule and said communication device carrying out spectrum management in accordance with the schedule, said communication device being characterized in that: the schedule setting means specifies schedule cycles each of which has a certain length, and sets the schedule so as to periodically repeat a group of the schedule cycles which are provided in a sequential manner, and the schedule setting means informs all stations, to which the transmission rights are to be given respectively during each of the schedule cycle, of a period from a start time of the schedule cycle to a time when transmission of a first transmission right giving signal in the schedule cycle is completed, and in case where the transmission right is returned from any one of the stations earlier than a finish time of the SP in the schedule, the schedule setting means controls a start time to give the transmission right, which start time comes after detecting that the transmission right in the schedule cycle is returned, so as to make the start time earlier than scheduled in the schedule.

Further, a communication device of the present invention serves as an access point provided on a network adopting (a) a first communication method for managing a period in which the access point gives transmission rights to stations and (b) a second communication method for allowing each of the stations to acquire each of the transmission rights, said network allows the station to execute the second communication method in case where it is detected that a signal has not been transmitted from the access point or other stations for a period equal to or longer than a predetermined period, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method subsequently to transmission of a signal from the access point to the station to which the transmission right is to be given, (ii) an SST indicative of a time to start the SP, and (iii) an SI indicative of an interval at which the SP and another SP are provided, said communication device informing the station, to which the transmission right is to be given by the first communication method, of the SST and the SI in accordance with the schedule and said communication device carrying out spectrum management in accordance with the schedule, said communication device being characterized by comprising shift forbidding means for forbidding a station from shifting to the period for executing the second communication method during a period from a time when the transmission right is returned from any one of the stations to a scheduled time to subsequently give a transmission right, said any one of the stations returning the transmission right earlier than a finish time of the SP in the schedule.

A communication method of the present invention is applied to a communication device serving as an access point provided on a network adopting (a) a first communication method for managing a period in which the access point gives transmission rights to stations and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method subsequently to transmission of a signal from the access point to the station to which the transmission right is to be given, (ii) an SST indicative of a time to start the SP, and (iii) an SI indicative of an interval at which the SP and another SP are provided, said communication device informing the station, to which the transmission right is to be given by the first communication method, of the SST and the SI in accordance with the schedule and said communication device carrying out spectrum management in accordance with the schedule, said communication method comprising the steps of: (i) detecting that a start time to give the transmission right to the station delays from the schedule; and (ii) controlling the timing to give the transmission right to the station so that the period for executing the second communication method is made shorter than a predetermined period or is omitted when the delay detection means detects the delay in the timing to give the transmission right to the station.

Further, the communication method of the present invention is arranged so that in the step of setting the schedule, schedule cycles each of which has a certain length are specified, and the schedule is set so as to periodically repeat a group of the schedule cycles which are provided in a sequential manner, and there is provided an adjustment period which has a length calculated by multiplying each of the schedule cycles with an integer in the schedule and which corresponds to the period for executing the second communication method, and in the step (ii), the timing to give the transmission right to the station is controlled so that the adjustment period is made shorter than a predetermined period or is omitted in the step (ii).

Further, a communication method of the present invention is applied to a communication device serving as an access point provided on a network adopting (a) a first communication method for managing a period in which the access point gives transmission rights to stations and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method subsequently to transmission of a signal from the access point to the station to which the transmission right is to be given, (ii) an SST indicative of a time to start the SP, and (iii) an SI indicative of an interval at which the SP and another SP are provided, said communication device informing the station, to which the transmission right is to be given by the first communication method, of the SST and the SI in accordance with the schedule and said communication device carrying out spectrum management in accordance with the schedule, said communication method comprising the step (i) of detecting that a timing to give the transmission right to the station delays from the schedule, wherein the schedule is reset when the delay in the timing for giving the transmission right is detected in the step (i), and an SST and an SI, which are based on the schedule having been reset, are informed to a station.

Further, a communication method of the present invention is applied to a communication device serving as an access point provided on a network adopting (a) a first communication method for managing a period in which the access point gives transmission rights to stations and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method subsequently to transmission of a signal from the access point to the station to which the transmission right is to be given, (ii) an SST indicative of a time to start the SP, and (iii) an SI indicative of an interval at which the SP and another SP are provided, said communication device informing the station, to which the transmission right is to be given by the first communication method, of the SST and the SI in accordance with the schedule and said communication device carrying out spectrum management in accordance with the schedule, said communication method comprising the steps of: specifying schedule cycles each of which has a certain length and setting the schedule so as to periodically repeat a group of the schedule cycles which are provided in a sequential manner; informing all stations, to which transmission rights are to be given respectively during each of the schedule cycle, of a period from a start time of the schedule cycle to a time when transmission of a first transmission right giving signal in the schedule cycle is completed; in case where the transmission right is returned from any one of the stations earlier than a finish time of the SP in the schedule, controlling a start time to give the transmission right, which start time comes after detecting that the transmission right in the schedule cycle is returned, so as to make the start time earlier than scheduled in the schedule.

Further, a communication method of the present invention is applied to a communication device serving as an access point provided on a network adopting (a) a first communication method for managing a period in which the access point gives transmission rights to stations and (b) a second communication method for allowing each of the stations to acquire each of the transmission rights, said network allows the station to execute the second communication method in case where it is detected that a signal has not been transmitted from the access point or other stations for a period equal to or longer than a predetermined period, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method subsequently to transmission of a signal from the access point to the station to which the transmission right is to be given, (ii) an SST indicative of a time to start the SP, and (iii) an SI indicative of an interval at which the SP and another SP are provided, said communication device informing the station of the SST and the SI in accordance with the schedule, said communication method comprising the step of transmitting a signal for forbidding a station from shifting into the period for executing the second communication method during a period from a time when the transmission right is returned from any one of the stations to a scheduled time to subsequently give a transmission right, said any one of the stations returning the transmission right earlier than a finish time of the SP in the schedule.

(Example of a Program)

Each of blocks included in the QAP 10 according to each embodiment, particularly, the protocol control section 12 and each of blocks included therein may be constituted of hardware logic or may be realized by software by using a CPU as follows.

That is, the QAP 10 includes: a CPU (central processing unit) which executes a control program realizing the functions; a ROM (read only memory) in which the program is stored; a RAM (random access memory) which develops the program; a storage device (storage medium) such as a memory in which the program and various kinds of data are stored; and the like. Further, the object of the present invention can be achieved as follows: a storage medium for computer-readably storing a program code (an execute form program, intermediate code program, or source program) of the control program of the QAP10 which is software for implementing the aforementioned functions is provided to the QAP 10, and a computer (or CPU and MPU) reads out the program code stored in the storage medium so as to implement the program, thereby achieving the object of the present invention.

Examples of the storage medium which satisfies these conditions include: tapes, such as magnetic tape and cassette tape; disks including magnetic disks, such as floppy disks (registered trademark) and hard disk, and optical disks, such as CD-ROMs, magnetic optical disks (MOs), mini disks (MDs), digital video disks (DVDs), and CD-Rs; cards, such as IC card (including memory cards) and optical cards; and semiconductor memories, such as mask ROMs, EPROMs, EEPROMs, and flash ROMs.

Further, it may be so arranged that: the QAP 10 is made connectable to communication networks, and the program code is supplied via the communication networks. The communication networks are not limited to a specific means. Specific examples of the communication network include Internet, intranet, extranet, LAN, ISDN, VAN, a CATV communication network, a virtual private network, a telephone line network, a mobile communication network, a satellite communication network, and the like. Further, a transmission medium constituting the communication network is not particularly limited. Specifically, it is possible to use a wired line such as a line in compliance with IEEE1394 standard, a USB line, a power line, a cable TV line, a telephone line, an ADSL line, and the like, as the transmission medium. Further, it is possible to use (i) a wireless line utilizing an infrared ray used in IrDA and a remote controller, (ii) a wireless line which is in compliance with Bluetooth standard (registered trademark) or IEEE802.11 wireless standard, and (iii) a wireless line utilizing HDR, a mobile phone network, a satellite line, a ground wave digital network, and the like, as the transmission medium. Note that, the present invention can be realized by a computer data signal which is realized by electronic transmission of the program code and which is embedded in a carrier wave.

In each of Embodiments, the arrangement in which communications are carried out based on IEEE 802.11e standard is described, but the present invention is not limited to this. The present invention is applicable as long as an access point and one or more stations constitute a network and the access point sets a preset schedule including (i) a first period in which the access point manages a transmission right giving period of each station and (ii) a second period in which the station itself acquires a transmission right.

As described above, the communication device and the communication method of the present invention is arranged so that the start time to give the transmission right to the station is controlled so that the period for executing the second communication method is made shorter than a period having been set in the schedule or is omitted when it is detected that the start time to give the transmission right delays.

Therefore, even in case where the period for executing the second communication method is extended longer than the period having been set in the preset schedule, it is possible to suppress the drop of the power save efficiency in the station.

Further, the communication device and the communication method of the present invention are arranged so that the schedule is reset when the delay in the start time to give the transmission right is detected, and an SST and an SI, which are based on the schedule having been reset, are informed to a station which delays from the schedule in the start time to give the transmission right.

Therefore, even in case where the period for executing the second communication method is extended longer than the period having been set in the original schedule, it is possible to suppress the drop of the power save efficiency in the station.

Further, the communication device and the communication method of the present invention are arranged so that in case where the transmission right is returned from any one of the stations earlier than a finish time of the SP in the schedule, the schedule setting means controls a start time to give the transmission right, which start time comes after detecting that the transmission right in the schedule cycle is returned, so as to make the start time earlier than scheduled in the schedule.

Therefore, the period for executing the second communication method is not set at an unscheduled time, so that the period having been set in the original schedule is extended, thereby preventing such condition that the timing for giving the transmission right in or after detecting that the transmission right is returned delays from the schedule. That is, it is possible to prevent the drop of the power save efficiency which is caused by extension of the period for executing the second communication method.

Further, the communication device and the communication method of the present invention are arranged so as to forbid a station from shifting into the period for executing the second communication method during a period from a time when the transmission right is returned to the access point from any one of the stations to a scheduled time to subsequently give a transmission right to the station to which the transmission right is to be given, said any one of the stations returning the transmission right earlier than a finish time of the SP in the schedule.

Therefore, the period for executing the second communication method is not provided at an unscheduled time, so that the period having been set in the original schedule is extended, thereby preventing such condition that the spectrum allocation schedule in or after detecting that the transmission right is returned delays. That is, it is possible to prevent the drop of the power save efficiency which is caused by extension of the period for executing the second communication method.

Note that, in case of transmitting real-time data of a moving image, sound, or the like, a data packet has an acceptable limit in a transmission delay time. In other words, transmission of the packet has to be completed by a scheduled time for the receiving side to reproduce the packet. If the transmission of the packet exceeds the acceptable limit, a disorder or a delay occurs in the moving image or the sound. A delay of the spectrum allocation causes a transmission delay, so that the transmission delay time exceeds the acceptable limit if the delay in the allocation schedule is accumulated without being corrected. In the present invention, the spectrum allocation schedule is corrected, so that also a problem concerning the transmission delay can be solved.

A communication device of the present invention serves as an access point provided on a network adopting (a) a first communication method for managing a period in which the access point gives a transmission right to the access point itself or gives transmission rights to stations respectively and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided, said communication device informing the station of the SST and the SI in accordance with the schedule, said communication device being characterized by comprising: delay detection means for detecting that a start time to give the transmission right to the access point itself or the station delays from the schedule; and timing control means for controlling the period for executing the second communication method so that the period for executing the second communication method is shortened or omitted when the delay detection means detects the delay.

The communication device of the present invention may be arranged so that the schedule setting means determines schedule cycles each of which has a certain length, and sets the schedule so as to periodically repeat a group of the schedule cycles which sequentially appear, and provides an adjustment period which has a length calculated by multiplying each of the schedule cycles with an integer in the schedule and which corresponds to the period for executing the second communication method, and the timing control means controls the adjustment period so that the adjustment period is shortened or omitted when the delay detection means detects the delay.

According to the arrangement, when the start time to give the transmission right to the station delays from the schedule, a control is carried out so that the adjustment period (the period for executing the second communication method) is shortened or omitted. As a result, the start time to give the transmission right to the station can be synchronized with or can be made nearer to the schedule. Thus, for example, in case of carrying out the power save in accordance with the SST and the SI informed from the access point to the station, the start time to give the transmission right to the station can be synchronized with or can be made nearer to the schedule of the power save carried out in the station. Thus, also in case where the period for executing the second communication method is extended longer than the period having been set in the schedule, it is possible to suppress the drop of the power save efficiency in the station.

Further, the communication device of the present invention may be arranged so that the timing control means informs, during the adjustment period, the station that the transmission right is not given to the station in the adjustment period.

According to the arrangement, the station can recognize that the transmission right is not given to the station itself during the adjustment period. Thus, the station informed that the transmission right is not given thereto can shift into the power save mode during the adjustment period. As a result, it is possible to further improve the power save efficiency.

Further, a communication device of the present invention serves as an access point provided on a network adopting (a) a first communication method for managing a period in which the access point gives a transmission right to the access point itself or gives transmission rights to stations respectively and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided, said communication device informing the station of the SST and the SI in accordance with the schedule, said communication device being characterized in that: the schedule setting means specifies schedule cycles each of which has a certain length, and sets the schedule so as to periodically repeat a group of the schedule cycles which are provided in a sequential manner, and the schedule setting means informs all stations, to which the transmission rights are to be given respectively during each of the schedule cycle, of a period from a start time of the schedule cycle to a time when transmission of a first transmission right giving signal in the schedule cycle is completed, and in case where the transmission right is returned from any one of the stations earlier than a finish time of the SP in the schedule, the schedule setting means controls a start time to give the transmission right, which start time comes after detecting that the transmission right in the schedule cycle is returned, so as to make the start time earlier than scheduled in the schedule.

Note that, in this case, the communication device of the present invention may be arranged so that the schedule setting means sets the schedule so that an order in which the transmission rights are given to the stations respectively in the schedule cycle is such that a shorter period for giving the transmission right is positioned earlier.

According to the arrangement, for example, in case of carrying out the power save in accordance with the SST and the SI informed from the access point to the station, a total time period in which each station is in the awake mode can be shortened. Thus, it is possible to enhance the power save efficiency in the entire network.

Alternatively, the communication device of the present invention may be arranged so that the schedule setting means sets the schedule so as to cyclically change, for each schedule cycle, an order in which the transmission rights are given to the stations respectively in the schedule cycle.

According to the arrangement, for each schedule cycle, an order in which the transmission rights are given to the stations respectively in the schedule cycle is cyclically changed. For example, in case of giving transmission rights to a first station, a second station, and a third station respectively, the transmission rights are respectively given in an order of the first station, the second station, and the third station at a first schedule cycle, and the transmission rights are respectively given in an order of the second station, the third station, and the first station at a next schedule cycle, and the transmission rights are respectively given in an order of the third station, the first station, and the second station at a subsequent schedule cycle. Thereafter, the step returns to the first schedule cycle, and a series of these operations is repeated.

As a result, for example, in case of carrying out the power save in accordance with the SST and the SI informed from the access point to the station, awake periods of the stations can be made substantially even.

Note that, according to the arrangement, in case of carrying out the power save in accordance with the SST and the SI informed from the access point to the station, each station is released from the power save mode and shifts into the awake mode at the start time of the schedule cycle for giving the transmission right or slightly later. Thus, a station to which a spectrum is secondarily allocated in each schedule cycle is in the awake mode for a certain period even though the transmission right is not given by the access point. Thus, there is a case where the power save efficiency can be made higher by informing the station after changing the SST in the foregoing manner and there is a case where the power save efficiency can be made higher by informing the station without changing the preset schedule, so that it is preferable to selectively adopt both the case.

Thus, the communication device of the present invention may be arranged so that the schedule setting means informs the station of the SST, which has not been changed, in case where all stations to which transmission rights are given respectively in accordance with the first communication method have periods, each of which is longer than a predetermined period, as the period for giving the transmission right. Note that, the predetermined period is suitably changed by the schedule setting means, for example, in accordance with a condition of spectrum allocation with respect to each station or a purpose of use etc. as the entire system (network).

According to the arrangement, it is possible to determine, with a relatively easy procedure, whether it is preferable to inform the SST to the station after changing the SST in the foregoing manner or it is preferable to inform the SST to the station without changing the SST.

A communication method of the present invention is applied to a communication device serving as an access point provided on a network adopting (a) a first communication method for managing a period in which the access point gives a transmission right to the access point itself or gives transmission rights to stations respectively and (b) a second communication method for allowing each of the stations to acquire each of the transmission rights, said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided, said communication device informing the station of the SST and the SI in accordance with the schedule, said communication method comprising the steps of: (i) detecting that a start time to give the transmission right to the access point itself or the station delays from the schedule; and (ii) controlling the period for executing the second communication method so that the period for executing the second communication method is shortened or omitted when the delay detection means detects the delay.

Further, the communication method of the present invention may be arranged so that in the step of setting the schedule, schedule cycles each of which has a certain length are specified, and the schedule is set so as to periodically repeat a group of the schedule cycles which are provided in a sequential manner, and there is provided an adjustment period which has a length calculated by multiplying each of the schedule cycles with an integer in the schedule and which corresponds to the period for executing the second communication method, and in the step (ii), the adjustment period is controlled so that the adjustment period is shortened or omitted when the delay detection means detects the delay.

According to the foregoing method, when the start time to give the transmission right to the station delays from the schedule, a control is carried out so that the adjustment period (period for executing the second communication method) is shortened or omitted. As a result, the start time to give the transmission right to the station can be synchronized with or can be made nearer to the schedule. Thus, for example, in case of carrying out the power save in accordance with the SST and the SI informed from the access point to the station, the start time to give the transmission right to the station can be synchronized with or can be made nearer to the schedule of the power save carried out in the station. Thus, also in case where the period for executing the second communication method is extended longer than the period having been set in the schedule, it is possible to suppress the drop of the power save efficiency in the station.

Note that, the communication device may be realized by a computer. In this case, the present invention also includes (i) a communication program which causes the computer to function as the foregoing means so as to realize the communication device by the computer and (ii) a computer-readable storage medium in which the communication program is stored.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable as long as an access point and one or more stations constitute a network and the access point sets a preset schedule including (i) a first period in which the access point manages a transmission right giving period of each station and (ii) a second period in which the station itself acquires a transmission right.

1-16. (canceled)

17. A communication device, serving as an access point provided on a network adopting (a) a first communication method for managing a period in which the access point gives a transmission right to the access point itself or gives transmission rights to stations respectively and (b) a second communication method for allowing each of the stations to acquire each of the transmission rights,
said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided,
said communication device informing the station of the SST and the SI in accordance with the schedule,
said communication device being characterized by comprising:
delay detection means for detecting that a start time to give the transmission right to the access point itself or the station delays from the schedule; and
timing control means for controlling the period for executing the second communication method so that the period for executing the second communication method is shortened or omitted when the delay detection means detects the delay.

18. The communication device as set forth in claim 17, wherein:
the schedule setting means determines schedule cycles each of which has a certain length, and sets the schedule so as to periodically repeat a group of the schedule cycles which sequentially appear, and provides an adjustment period which has a length calculated by multiplying each of the schedule cycles with an integer in the schedule and which corresponds to the period for executing the second communication method, and
the timing control means controls the adjustment period so that the adjustment period is shortened or omitted when the delay detection means detects the delay.

19. The communication device as set forth in claim 18, wherein:
the timing control means informs, during the adjustment period, the station that the transmission right is not given to the station in the adjustment period.

20. A communication device, serving as an access point provided on a network adopting (a) a first communication method for managing a period in which the access point gives a transmission right to the access point itself or gives transmission rights to stations respectively and (b) a second communication method for allowing each of the stations to acquire each of the transmission rights,
said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided,
said communication device informing the station of the SST and the SI in accordance with the schedule,
said communication device being characterized by comprising delay detection means for detecting that a start time to give the transmission right to the access point itself or the station delays from the schedule, wherein
the schedule setting means resets the schedule when the delay detection means detects the delay, and the schedule setting means informs an SST and an SI, which are based on the schedule having been reset, to a station which delays from the schedule in the start time to give the transmission right.

21. A communication device, serving as an access point provided on a network adopting (a) a first communication method for managing a period in which the access point gives a transmission right to the access point itself or gives transmission rights to stations respectively and (b) a second communication method for allowing each of the stations to acquire each of the transmission rights,
said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided,
said communication device informing the station of the SST and the SI in accordance with the schedule,
said communication device being characterized in that:
the schedule setting means specifies schedule cycles each of which has a certain length, and sets the schedule so as to periodically repeat a group of the schedule cycles which are provided in a sequential manner, and
the schedule setting means informs all stations, to which the transmission rights are to be given respectively during each of the schedule cycle, of a period from a start time of the schedule cycle to a time when transmission of a first transmission right giving signal in the schedule cycle is completed, and
in case where the transmission right is returned from any one of the stations earlier than a finish time of the SP in the schedule, the schedule setting means controls a start time to give the transmission right, which start time comes after detecting that the transmission right in the schedule cycle is returned, so as to make the start time earlier than scheduled in the schedule.

22. The communication device as set forth in claim 21, wherein:
the schedule setting means sets the schedule so that an order in which the transmission rights are given to the stations respectively in the schedule cycle is such that a shorter period for giving the transmission right is positioned earlier.

23. The communication device as set forth in claim 21, wherein:
the schedule setting means sets the schedule so as to cyclically change, for each schedule cycle, an order in which the transmission rights are given to the stations respectively in the schedule cycle.

24. The communication device as set forth in claim 21, wherein:
the schedule setting means informs the station of the SST, which has not been changed, in case where all stations to which transmission rights are given respectively in accordance with the first communication method have periods, each of which is longer than a predetermined period, as the period for giving the transmission right.

25. A communication device, serving as an access point provided on a network adopting (a) a first communication method for managing a period in which the access point gives a transmission right to the access point itself or gives transmission rights to stations respectively and (b) a second communication method for allowing each of the stations to acquire each of the transmission rights, said network allows the station to begin to execute the second communication method in case where it is detected that a signal has not been transmitted from the access point or other stations for a period equal to or longer than a predetermined period,
said communication device comprising schedule setting means for setting a schedule specifying (i) an SP indicative of a period in which there are a period for executing the first communication method and a period for executing the second communication method so that these periods are not superposed each other and in which the transmission right is given to the station in accordance with the first communication method, (ii) an SST indicative of a time to start the SP, and (iii) an SI indicative of an interval at which the SP and another SP are provided,
said communication device informing the station of the SST and the SI in accordance with the schedule,
said communication device being characterized by comprising means for forbidding all the stations from executing the second communication method during a period from a time when the transmission right is returned from any one of the stations to a scheduled time to subsequently give a transmission right, said any one of the stations returning the transmission right earlier than a finish time of the SP in the schedule.

26. A communication program, causing the communication device as set forth in claim 17 to operate, said communication program causing a computer to function as the means of the communication device.

27. A computer-readable storage medium, in which the communication program as set forth in claim 26 is stored.

28. The communication device as set forth in claim 22, wherein:
the schedule setting means informs the station of the SST, which has not been changed, in case where all stations to which transmission rights are given respectively in accordance with the first communication method have periods, each of which is longer than a predetermined period, as the period for giving the transmission right.

29. The communication device as set forth in claim 23, wherein:
the schedule setting means informs the station of the SST, which has not been changed, in case where all stations to which transmission rights are given respectively in accordance with the first communication method have periods, each of which is longer than a predetermined period, as the period for giving the transmission right.
